(19) United States
(12) Patent Application Publication
(10) Pub. No.: US 2021/0108142 A1
(43) Pub. Date: Apr. 15, 2021

(54) POLARIZED LUMINESCENT FILM

(71) Applicant: DIC Corporation, Tokyo (JP)

(72) Inventors: Koichi Endou, Kitaadachi-gun (JP); Yasuhiro Kuwana, Kitaadachi-gun (JP); Hidehiko Yamaguchi, Kitaadachi-gun (JP); Shinji Ogawa, Kitaadachi-gun (JP)

(73) Assignee: DIC Corporation, Tokyo (JP)

(21) Appl. No.: 16/464,409

(22) PCT Filed: Dec. 12, 2017
(86) PCT No.: PCT/JP2017/044505

§ 371 Date: May 28, 2019

(30) Foreign Application Priority Data
Dec. 12, 2016 (JP) 2016-240298

(51) Int. Cl. C09K 19/04; C09K 19/52; C09K 11/56; G02B 5/30; C09K 19/02; C09K 11/88

(52) U.S. Cl. CPC C09K 19/04; C09K 19/52; C09K 11/565; B82Y 30/00; C09K 19/02; C09K 11/883; G02B 5/305

(57) ABSTRACT

To provide a polarized luminescent film obtained by applying, to a substrate material, a polymerizable composition including a rod-like luminescent nanocrystal and a polymerizable liquid crystal compound, and radiating an active energy ray, and to provide a film having good polarization characteristics. The present invention provides a polarized luminescent film and a polarized luminescent multilayered body formed from a polymerizable composition containing a rod-like luminescent nanocrystal and a polymerizable liquid crystal compound. The present invention also provides a backlight and a display device including a polarized luminescent multilayered body according to the present invention.

### TECHNICAL FIELD

The present invention relates to a polymerizable liquid crystal composition containing a rod-like luminescent nanocrystal, and a polarized luminescent film, a polarized luminescent multilayered body, a liquid crystal display device, and an organic luminescent display device that are formed from the composition.

### BACKGROUND ART

Display devices such as liquid crystal display devices and organic luminescent display devices include organic luminescent substances such as liquid crystal materials, organic light-emitting diodes, and quantum dots. In such a display device, unpolarized light emitted from a backlight source is turned with a polarizer into linearly polarized light and then used. However, such use of a polarizer to obtain the specific polarized light causes energy loss that is generally 50% of incident light. This problem is particularly serious in backlight systems for liquid crystal displays in which energy conservation is important, and is particularly serious in mobile devices (such as smartphones, tablets, notebook computers, and cameras) because the problem affects the life of batteries.

In these years, in order to address this problem, use of rod-like luminescent nanocrystals has been proposed. The rod-like luminescent nanocrystals are rod-like nanoparticles having polarized luminescence properties (semiconductor nanocrystals). The nanocrystals are rod-like and hence have directivity, and can emit polarized light.

For example, Patent Literature 1 discloses that an optically active structure including quantum rods aligned in one direction is irradiated with pumping light to obtain polarized light, and this is useful for the backlight systems of display devices. Patent Literature 1 states that, in an example, a polymer film in which quantum rods are dispersed is mechanically stretched to align the quantum rods.

In addition, Patent Literature 2 discloses a nanorod composition for a liquid crystal display, the nanorod composition including nematic liquid crystal, and zinc sulfide or zinc oxide nanorods having a domain structure in which nanorods within domains align substantially parallel to each other. In this composition, characteristics of nematic liquid crystal are used to control alignment of nanorods; specifically, nanorods having very small dimensions are used: an inner diameter of 1.2 nm and a length of 4.0 nm.

In addition, Patent Literature 3 states that quantum rods having predetermined dimensions and a polymerizable liquid crystal compound are used in combination, to thereby provide a wavelength conversion film having good polarized luminescence properties in which degradation of the polarized luminescence properties are suppressed even under high-temperature and high-humidity environments.

### CITATION LIST

### Patent Literature

PTL 1: Japanese Unexamined Patent Application Publication (Translation of PCT Application) No. 2014-502503
PTL 2: Japanese Unexamined Patent Application Publication No. 2010-144032
PTL 3: Japanese Unexamined Patent Application Publication No. 2016-29149

### SUMMARY OF INVENTION

### Technical Problem

On the other hand, the treatment of aligning quantum rods by the treatment of stretching the polymer film in PTL 1 does not sufficiently provide alignment of the quantum rods, and the polarized luminescence properties are not satisfactory. In addition, the stretching treatment is not necessarily highly productive, and it is difficult to achieve a reduction in the thickness of the resultant film.

The composition described in PTL 2 and including a liquid crystal compound and nanorods having small dimensions also does not have satisfactory polarized luminescence properties. In addition, since the liquid crystal compound is aligned with an external electric field, termination of application of the external electric field tends to result in loss of alignment of nanorods. In particular, this is serious under high-temperature and high-humidity environments.

The formation of a polymer film from a polymerizable liquid crystal compound in PTL 3 is performed in the nematic temperature region. Thus, the polymerizable liquid crystal molecules immediately before polymerization do not have a high degree of alignment order. With this, nanorods do not have a high degree of alignment. Thus, the film obtained by curing does not have perfect polarized luminescence properties.

An object of the present invention is to provide a polarized luminescent film having good polarized luminescence properties in which degradation of the polarized luminescence properties are reduced even under high-temperature and high-humidity environments. Another object of the present invention is to provide a polarized luminescent multilayered body, a backlight unit, a liquid crystal display device, and an organic luminescent display device.

### Solution to Problem

In order to achieve the above-described objects, thorough studies were performed with focus on use of a polymerizable liquid crystal compound and a rod-like luminescent nanocrystal. As a result, the present invention has been provided.

Specifically, the present invention provides a polarized luminescent film formed from a polymerizable liquid crystal composition containing a rod-like luminescent nanocrystal. The present invention also provides a polarized luminescent multilayered body, a liquid crystal display device, and an organic luminescent display device that include polarized luminescent films according to the present invention.

### Advantageous Effects of Invention

Use of a polarized luminescent film formed from a polymerizable liquid crystal composition containing a rod-like luminescent nanocrystal according to the present invention provides good polarized luminescence properties, and hence the film is useful for backlight units of display devices.

### DESCRIPTION OF EMBODIMENTS

Hereinafter, best modes of a polarized luminescent film formed from a polymerizable liquid crystal composition containing a rod-like luminescent nanocrystal according to the present invention will be described. In the present invention, the “liquid crystal” of a polymerizable liquid crystal compound means that a single polymerizable liquid crystal compound used alone exhibits liquid crystallinity, or a mixture of a polymerizable liquid crystal compound and another liquid crystal compound exhibits liquid crystallinity. Incidentally, the polymerizable liquid crystal composition containing a rod-like luminescent nanocrystal can be polymerized (turned into a film) by polymerization treatment achieved by irradiation with light such as ultraviolet light or heating, or both of the irradiation and heating.

A first aspect of the present invention is a polarized luminescent film including a cured product of a polymerizable liquid crystal compound and a rod-like luminescent nanocrystal that absorbs and converts ultraviolet or visible light to emit light of at least one color of red (R), green (G), and blue (B), wherein the alignment order parameter S of the cured product of the polymerizable liquid crystal compound is represented by the following mathematical formula (1) and is 0.55 or more.

$$\begin{matrix}[ Math . 1 ] & \\ S = \frac{A \vert \vert - A ⊥}{A \vert \vert + 2 A ⊥} & Mathematical formula ( 1 )\end{matrix}$$

(In the mathematical formula (1), A∥ represents, in the cured product, an absorption coefficient in a direction parallel to the alignment vector of polymerizable liquid crystal compound molecules, and A⊥ represents, in the cured product, an absorption coefficient in a direction perpendicular to the alignment vector of polymerizable liquid crystal compound molecules.)

In the present invention, rod-like luminescent nanocrystals are affected by the alignment order parameter of the polymerizable liquid crystal compound, so that the rod-like luminescent nanocrystals tend to be aligned in a specific direction. As a result, a polarized luminescent film is provided that has good polarized luminescence properties in which degradation of the polarized luminescence properties are reduced even under high-temperature and high-humidity environments.

### (Alignment Order Parameter)

A cured product of a polymerizable liquid crystal compound according to the present invention preferably forms an optically anisotropic layer having optical anisotropy such as refractive index anisotropy. The optically anisotropic layer is a layer in which the alignment direction of a (polymerizable) liquid crystal compound is fixed, and that includes a compound having optical anisotropy such as refractive index anisotropy: for example, a layer in which the alignment direction of liquid crystal molecules of the liquid crystal compound is controlled to a specific direction by an alignment layer adjacent to the (polymerizable) liquid crystal compound, and the liquid crystal molecules are fixed in the alignment state by temperature or a chemical reaction. Thus, in the present invention, the liquid crystal compound contained in the polarized luminescent film that is an optically anisotropic layer is preferably aligned horizontally.

The liquid crystal compound included in the polarized luminescent film according to the present invention has a polymerizable group; and the liquid crystal compound is polymerized and the resultant liquid crystal compound (that is, the cured product of the liquid crystal compound) preferably has an alignment order parameter of 0.55 or more. Hereafter, the alignment order parameter will be described. In order to provide optical anisotropy, optical elements need to be aligned. These optical elements are optical elements that provide refractive index anisotropy, and examples include disc-like or rod-like liquid crystal molecules that exhibit a liquid crystal phase in a predetermined temperature range, and polymers that are aligned by, for example, stretching treatment. The inherent birefringence of a single optical element and the statistical degree of alignment of the optical element govern the birefringence of the bulk of the optical material. For example, the magnitude of optical anisotropy of an optically anisotropic layer formed of a liquid crystal compound is governed by the inherent birefringence of the liquid crystal compound that is a main optical element providing optical anisotropy, and the statistical degree of alignment of the liquid crystal compound. As a parameter representing the degree of alignment, an alignment order parameter S is known. The alignment order parameter becomes 1 in the case of no variations such as crystals, while it becomes 0 in the case of totally random variations such as a liquid state. For example, the nematic liquid crystal is said to have an alignment order parameter of about 0.6 in general. The alignment order parameter S is specifically described in, for example, “Physical Properties of Liquid Crystalline Materials” written by DE JEU, W. H. (Kyoritsu Shuppan Co., Ltd., 1991, page 11), and represented by the following mathematical formula (I).

[Math. 2]

S=½<3 cos²θ−1>

(In the mathematical formula (I), θ represents the angle formed between the average alignment direction of aligned elements and the axis of each aligned element.)

In general, as the method of measuring the alignment order parameter, there are known examples including a polarized Raman method, an IR method, an X-ray method, a fluorescent method, and a sound velocity method.

The alignment order parameter (value S) can be determined on the basis of spectroscopic measurement and using the following equation described in the above-described “Liquid Crystal Device Handbook” edited by 142nd Committee of Japan Society for the Promotion of Science.

S=(A∥−A⊥)/(2A⊥+A∥)

where “A∥” and “A⊥” respectively represent absorbances for light polarized parallel to or perpendicular to the alignment direction of liquid crystal. The value S theoretically falls in the range of 0 to 1. As the value nears 1, the contrast of the liquid crystal device increases. The above-described equation is based on measurement of absorption of polarized light; thus, in the case of a liquid crystal compound having dichroism or a liquid crystal layer stained with a dichroic pigment, the value is relatively easily obtained. The alignment order parameter of the cured product of the polymerizable compound is preferably 0.55 or more, more preferably 0.6 or more, still more preferably 0.65 or more. The upper limit is not particularly defined, but may be 1.0 or less, for example.

In a polarized luminescent film according to the present invention, when the cured product of a polymerizable liquid crystal compound in the film has an alignment order parameter of 0.55 or more, the liquid crystal molecules of the polymerizable liquid crystal compound that align rod-like luminescent nanocrystals form an alignment state called a smectic phase, to exhibit a high degree of alignment order in a long distance. Probably for this reason, the rod-like luminescent nanocrystals are aligned in a specific direction and with a high degree of order.

A polarized luminescent film that is an optically anisotropic layer in the present invention is formed from a liquid crystal composition including a liquid crystal compound. Examples of the liquid crystal compound used for forming the optically anisotropic layer include rod-like liquid crystal compounds and discotic liquid crystal compounds. The rod-like liquid crystal compounds and the discotic liquid crystal compounds may be high-molecular-weight liquid crystals or low-molecular-weight liquid crystals, and further encompass compounds formed of crosslinked low-molecular-weight liquid crystals that no longer exhibit liquid crystallinity.

In the polarized luminescent film that is an optically anisotropic layer in the present invention, in order for the cured film to have an alignment order parameter of 0.55 or more, the film preferably includes at least one of polymerizable liquid crystal compounds represented by the following general formula (II). (Polymerizable liquid crystal compound)

Such a polymerizable liquid crystal compound used in the present invention is not particularly limited and may be selected from publicly known and commonly used compounds as long as the compound alone or in a composition also including another compound exhibits liquid crystallinity, and the compound has at least one polymerizable functional group.

Examples include, as described in Handbook of Liquid Crystals (edited by D. Demus, J. W. Goodby, G. W. Gray, H. W. Spiess, and V. Vill, published by Wiley-VCH Verlag GmbH & Co. KGaA, 1998), Kikan kagaku sosetsu No. 22, CHEMISTRY OF LIQUID CRYSTAL (edited by The Chemical Society of Japan, 1994), Japanese Unexamined Patent Application Publication Nos. 7-294735, 8-3111, 8-29618, 11-80090, 11-116538, and 11-148079, rod-like polymerizable liquid crystal compounds including a rigid region that is constituted by a chain of a plurality of structures such as a 1,4-phenylene group or a 1,4-cyclohexylene group and that is referred to as mesogen, and a polymerizable functional group such as a vinyl group, an acryloyl group, or a (meth)acryloyl group; and, as described in Japanese Unexamined Patent Application Publication Nos. 2004-2373 and 2004-99446, rod-like polymerizable liquid crystal compounds having a maleimide group. In particular, preferred are rod-like liquid crystal compounds having a polymerizable group because such compounds are easily provided so as to have a liquid crystal temperature range in low temperatures at or about room temperature.

Specific preferred examples of the polymerizable liquid crystal compound include compounds represented by the following general formula (II).

[Chem. 1]

P²¹-(Sp²¹−X²¹)_{q21}-MG-R²¹ (II)

In the general formula (II), P²¹ represents a polymerizable functional group,

in the general formula (II), Sp²¹ represents an alkylene group having 1 to 18 carbon atoms (hydrogen atoms in the alkylene group may be substituted with at least one halogen atom, CN group, or group having a polymerizable functional group; in the alkylene group, a single CH₂ group or two or more non-adjacent CH₂ groups may each be independently substituted with —O—, —COO—, —COO—, or —OCO—O—),

in the general formula (II), X²¹ represents —O—, —S—, —OCH₂—, —CH₂O—, —CO—, —COO—, —COO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF=CF—, —C≡C—, or a single bond (provided that P²¹-Sp²¹ and Sp²¹-X²¹ do not include —O—O—, —O—NH—, —S—S—, or —O—S— groups),

in the general formula (II), q21 represents 0 or 1,

in the general formula (II), MG represents a mesogenic group,

in the general formula (II), R²¹ represents a hydrogen atom, a halogen atom, a cyano group, or a linear or branched alkyl group having 1 to 12 carbon atoms; the alkyl group may be linear or branched; in the alkyl group, a single —CH₂— or two or more non-adjacent —CH₂— may each be independently substituted with —O—, —S—, —CO—, —COO—, —COO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF=CF—, or —C≡C—; or R²¹ is represented by a general formula (II-a),

[Chem. 2]

—(X²²-Sp²²)_{q22}-P²² (II-a)

(in the general formula (II-a), P²² represents a polymerizable functional group, Sp²² represents the same as that defined in Sp²¹, X²² represents the same as that defined in X²¹ (provided that P²²-Sp²² and Sp²²-X²² do not include —O—O—, —O—NH—, —S—S—, or —O—S— groups), q22 represents 0 or 1), and the mesogenic group represented by MG is represented by a general formula (II-b),

[Chem. 3]

—(B1-Z1)ᵣ₁-B2-Z2-B3- (II-b)

(in the general formula (II-b), B1, B2, and B3 each independently represent a 1,4-phenylene group, a 1,4-cyclohexylene group, a 1,4-cyclohexenyl group, a tetrahydropyran-2,5-diyl group, a 1,3-dioxane-2,5-diyl group, a tetrahydrothiopyran-2,5-diyl group, a 1,4-bicyclo(2,2,2)octylene group, a decahydronaphthalene-2,6-diyl group, a pyridine-2,5-diyl group, a pyrimidine-2,5-diyl group, a pyrazine-2,5-diyl group, a thiophene-2,5-diyl group-, a 1,2,3,4-tetrahydronaphthalene-2,6-diyl group, a 2,6-naphthylene group, a phenanthrene-2,7-diyl group, a 9,10-dihydrophenanthrene-2,7-diyl group, a 1,2,3,4,4a,9,10a-octahydrophenanthrene-2,7-diyl group, a 1,4-naphthylene group, a benzo[1,2-b:4,5-b′]dithiophene-2,6-diyl group, a benzo[1,2-b:4,5-b′]diselenophene-2,6-diyl group, a [1]benzothieno[3,2-b]thiophene-2,7-diyl group, a [1]benzoselenopheno[3,2-b]selenophene-2,7-diyl group, or a fluorene-2,7-diyl group; and may have, as a substituent, at least one F, Cl, CF₃, OCF₃, CN group, alkyl group having 1 to 8 carbon atoms (in the alkyl group, hydrogen atoms may be substituted with at least one phenyl group; a single CH₂ group or two or more non-adjacent CH₂ groups in the group may each be independently substituted with —O—, —COO—, —COO—, or —OCO—O—), alkoxy group having 1 to 8 carbon atoms, alkanoyl group having 1 to 8 carbon atoms, alkanoyloxy group having 1 to 8 carbon atoms, alkoxycarbonyl group having 1 to 8 carbon atoms, alkenyl group having 2 to 8 carbon atoms, alkenyloxy group having 2 to 8 carbon atoms, alkenoyl group having 2 to 8 carbon atoms, alkenoyloxy group having 2 to 8 carbon atoms, and/or general formula (II-c),

[Chem. 4]

—(X²³)_{q24}-(Sp²³)_{q23}-P²³ (II-c)

(in the formula (II-c), P²³ represents a polymerizable functional group,

Sp²³ represents the same as that defined in Sp²¹ above,

X²³ represents —O—, —COO—, —OCO—, —OCH₂—, —CH₂O—, —CH₂CH₂OCO—, —COOCH₂CH₂—, —OCOCH₂CH₂—, or a single bond; q23 represents 0 or 1; and q24 represents 0 or 1 (provided that P²³-Sp²³ and Sp²³-X²³ do not include —O—O—, —O—NH—, —S—S—, or —O—S— groups)),

in the general formula (II-b), Z1 and Z2 each independently represent —COO—, —COO—, —CH₂CH₂—, —OCH₂—, —CH₂O—, —CH═CH—, —C≡C—, —CH═CHCOO—, —OCOCH═CH—, —CH₂CH₂COO—, —CH₂CH₂OCO—, —COOCH₂CH₂—, —OCOCH₂CH₂—, —C═N—, —N═C—, —CONH—, —NHCO—, —C(CF₃)₂⁻, an alkyl group that has 2 to 10 carbon atoms and that may have a halogen atom, or a single bond; when Z1 or Z2 represents a single bond, among B1, B2, and B3 above, two adjacent ring structures may form, through their substituents bonded together, a cyclic group; r1 represents 0, 1, 2, or 3; when a plurality of B1's and Z1's are present, B1's may be the same or different and Z1's may be the same or different).

As described above, in the general formula (II), Sp²¹ represents an alkylene group having 1 to 18 carbon atoms; in the alkylene group, a hydrogen atom may be substituted with a group having a polymerizable functional group. This group having a polymerizable functional group is preferably a group represented by the above-described general formula (II-c).

Preferably, P²¹, P²², and P²³ above each independently represent a substituent selected from polymerizable groups represented by the following formula (P-2-1) to formula (P-2-20).

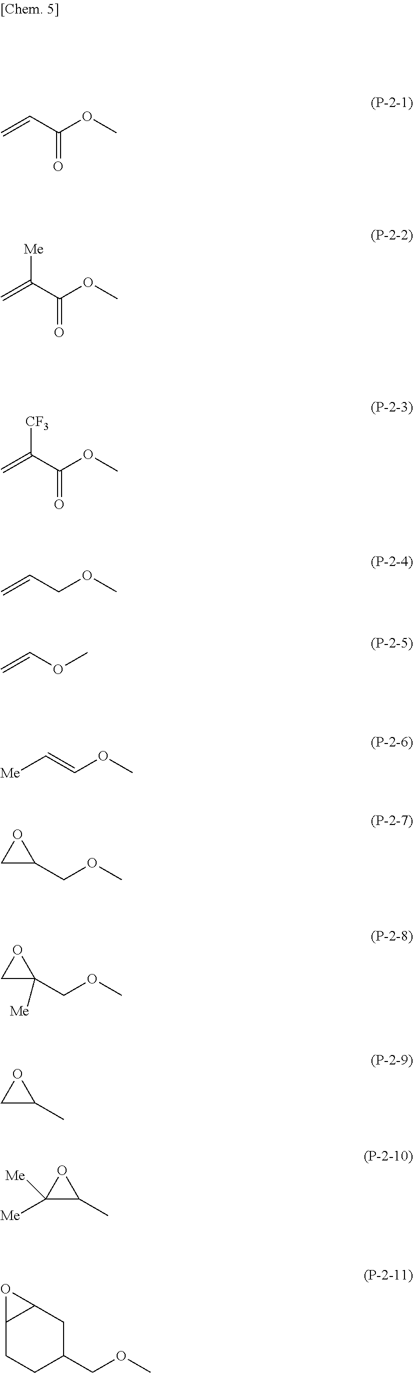

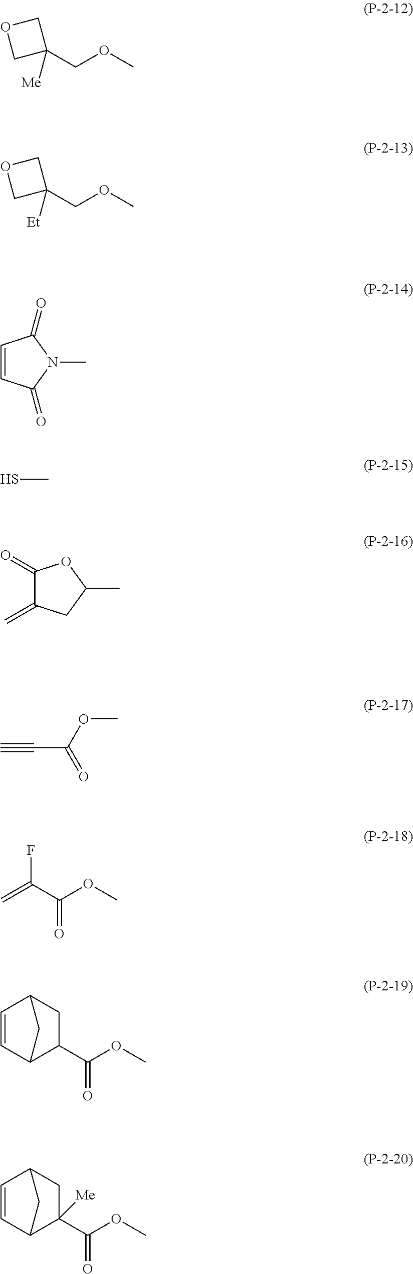

Among these polymerizable functional groups, from the viewpoint of improving polymerizability, preferred are formulas (P-2-1), (P-2-2), (P-2-7), (P-2-12), and (P-2-13), more preferred are formulas (P-2-1), (P-2-2), and (P-2-7).

In the general formula (II-b), preferably B1, B2, and B3 each independently represent a 1,4-phenylene group, a 1,4-cyclohexylene group, or a 2,6-naphthylene group that may have the above-described substituent;

preferably, Z1 and Z2 each independently represent —COO—, —COO—, —CH₂O—, —CH═CH—, —C≡C—, —CH₂CH₂COO—, —CH₂CH₂OCO—, —COOCH₂CH₂—, —OCOCH₂CH₂—, —C═N—, —N═C—, or a single bond; and r1 preferably represents 0 or 1.

(Monofunctional Polymerizable Liquid Crystal Compound)

Among compounds represented by the above-described general formula (II), a preferred monofunctional polymerizable liquid crystal compound intramolecularly having a single polymerizable functional group is a compound represented by the following general formula (II-1).

[Chem. 6]

P²¹¹-(Sp²¹¹-X²¹¹)_{q211}-MG¹-R²¹¹ (II-1)

In the general formula (II-1), P²¹¹, X²¹¹, and q211 respectively represent the same as those defined as P²¹, X²¹, and q21 in the general formula (II),

in the general formula (II-1), R²¹¹ represents a hydrogen atom, a halogen atom, a cyano group, or a linear or branched alkyl group having 1 to 12 carbon atoms or linear or branched alkenyl group having 1 to 12 carbon atoms in which a single —CH₂— or two or more non-adjacent —CH₂— may each be independently substituted with —O—, —S—, —CO—, —COO—, —OCO—, —CO—S—, —S—CO—, —O—CO—O—, —CO—NH—, —NH—CO—, —NH—, —N(CH₃)—, —CH═CH—COO—, —CH═CH—OCO—, —COO—CH═CH—, —OCO—CH═CH—, —CH═CH—, —CF=CF—, or —C≡C—; one or two or more hydrogen atoms of the alkyl group or alkenyl group may be substituted with halogen atoms or cyano groups; when a plurality of hydrogen atoms are substituted, the substituents may be the same or different,

in the general formula (II-1), Sp²¹¹ represents an alkylene group having 1 to 18 carbon atoms (in the alkylene group, hydrogen atoms may be substituted with at least one halogen atom or CN group; a single CH₂ group or two or more non-adjacent CH₂ groups in the group may each be independently substituted with —O—, —COO—, —COO—, or —OCO—O—),

in the general formula (II-1), MG¹ represents a mesogenic group, the mesogenic group is represented by a general formula (II-1-b),

[Chem. 7]

—(B11-Z11)ᵣ₁₁-B21-Z21-B31- (II-1-b)

(in the general formula (II-1-b), B11, B21, and B31 each independently represent a 1,4-phenylene group, a 1,4-cyclohexylene group, a 1,4-cyclohexenyl group, a tetrahydropyran-2,5-diyl group, a 1,3-dioxane-2,5-diyl group, a tetrahydrothiopyran-2,5-diyl group, a 1,4-bicyclo(2,2,2)octylene group, a decahydronaphthalene-2,6-diyl group, a pyridine-2,5-diyl group, a pyrimidine-2,5-diyl group, a pyrazine-2,5-diyl group, a thiophene-2,5-diyl group-, a 1,2,3,4-tetrahydronaphthalene-2,6-diyl group, a 2,6-naphthylene group, a phenanthrene-2,7-diyl group, a 9,10-dihydrophenanthrene-2,7-diyl group, a 1,2,3,4,4a,9,10a-octahydrophenanthrene-2,7-diyl group, a 1,4-naphthylene group, a benzo[1,2-b:4,5-b′]dithiophene-2,6-diyl group, a benzo[1,2-b:4,5-b′]diselenophene-2,6-diyl group, a [1]benzothieno[3,2-b]thiophene-2,7-diyl group, a [1]benzoselenopheno[3,2-b]selenophene-2,7-diyl group, or a fluorene-2,7-diyl group; and may have, as a substituent, at least one F, Cl, CF₃, OCF₃, CN group, alkyl group having 1 to 8 carbon atoms (in the alkyl group, hydrogen atoms may be substituted with at least one phenyl group; a single CH₂ group or two or more non-adjacent CH₂ groups in the group may each be independently substituted with —O—, —COO—, —COO—, or —OCO—O—), alkoxy group having 1 to 8 carbon atoms, alkanoyl group having 1 to 8 carbon atoms, alkanoyloxy group having 1 to 8 carbon atoms, alkoxycarbonyl group having 1 to 8 carbon atoms, alkenyl group having 2 to 8 carbon atoms, alkenyloxy group having 2 to 8 carbon atoms, and/or alkenoyl group having 2 to 8 carbon atoms,

in the general formula (II-1-b), Z11 and Z21 each independently represent —COO—, —COO—, —CH₂CH₂—, —OCH₂—, —CH₂O—, —CH═CH—, —C≡C—, —CH═CHCOO—, —OCOCH═CH—, —CH₂CH₂COO—, —CH₂CH₂OCO—, —COOCH₂CH₂—, —OCOCH₂CH₂—, —C═N—, —N═C—, —CONH—, —NHCO—, —C(CF₃)₂—, an alkyl group that has 2 to 10 carbon atoms and that may have a halogen atom, or a single bond; r11 represents 0, 1, 2, or 3; when a plurality of B11's and Z11's are present, B11's may be the same or different and Z11's may be the same or different); when Z11 or Z21 represents a single bond, among B11, B21, and B31 above, two adjacent ring structures may form, through their substituents bonded together, a cyclic group, and

in the general formula (II-1), as P²¹¹, from the viewpoint of improving polymerizability, preferred are the above-described formulas (P-2-1), (P-2-2), (P-2-7), (P-2-12), and (P-2-13), more preferred are the formulas (P-2-1), (P-2-2), and (P-2-7).

In the general formula (II-1-b), preferably B11, B21, and B31 each independently represent a 1,4-phenylene group, a 1,4-cyclohexylene group, or a 2,6-naphthylene group that may have the above-described substituent; preferably Z11 and Z21 each independently represent —COO—, —COO—, —CH₂CH₂—, —OCH₂—, —CH₂O—, —CH═CH—, —C≡C—, —C═N—, —N═C—, or a single bond, and r11 preferably represents 0 or 1.

Examples of the general formula (II-1) include

compounds represented by the following general formulas (II-1-1) to (II-1-4), but are not limited to the following general formulas.

[Chem. 8]

P²¹¹-(Sp²¹¹-X²¹¹)_{q211}-B21-Z21-B31-R²¹¹ (II-1-1)

P²¹¹-(Sp²¹¹-X²¹¹)_{q211}-B111-Z111-B21-Z21-B31-R²¹¹ (II-1-2)

P²¹¹-(Sp²¹¹-X²¹¹)_{q211}-B111-Z111-B112-Z112-B21-Z21-B31-R211 (II-1-3)

P²¹¹-(Sp²¹¹-X²¹¹)_{q211}-B111-Z111-B112-Z112-B113-Z113-B21-Z21-B31-R²¹¹ (II-1-4)

In the general formulas (II-1-1) to (II-1-4), P²¹¹, Sp²¹¹, X²¹¹, and q211 each represent the same as that defined in the general formula (II-1),

in the general formulas (II-1-1) to (II-1-4), B111, B112, B113, B21, and B31 represent the same as those defined as B11 to B31 in the general formula (II-1-b); preferred groups are also the same as those defined for B11 to B31; B111, B112, B113, B21, and B31 may be the same or different,

in the general formulas (II-1-1) to (II-1-4), Z111, Z112, 2113, and Z21 represent the same as those defined as Z11 to Z21 in the general formula (II-1-b); preferred groups are also the same as those defined for Z11 to Z21; 2111, Z112, 2113, and Z21 may be the same or different,

in the general formulas (II-1-1) to (II-1-4), R²¹¹ represents a hydrogen atom, a halogen atom, a cyano group, or a linear or branched alkyl group having 1 to 12 carbon atoms or linear or branched alkenyl group having 1 to 12 carbon atoms in which a single —CH₂— or two or more non-adjacent —CH₂— may each be independently substituted with —O—, —S—, —CO—, —COO—, —COO—, —CO—S—, —S—CO—, —O—CO—O—, —CO—NH—, —NH—CO—, —NH—, —N(CH₃)—, —CH═CH—COO—, —CH═CH—OCO—, —COO—CH═CH—, —OCO—CH═CH—, —CH═CH—, —CF=CF—, or —C≡C—; one or two or more hydrogen atoms in the alkyl group or alkenyl group may be substituted with halogen atoms or cyano groups; when a plurality of hydrogen atoms are substituted, the substituents may be the same or different.

Among the general formulas (II-1-1) to (II-1-4), from the viewpoint of alignment after polymerization, preferred are compounds represented by the general formula (II-1-1) to the general formula (II-1-2).

Examples of the compounds represented by the general formulas (II-1-1) to (II-1-4) include compounds represented by the following formula (II-1-1-1) to formula (II-1-1-26), but are not limited to these.

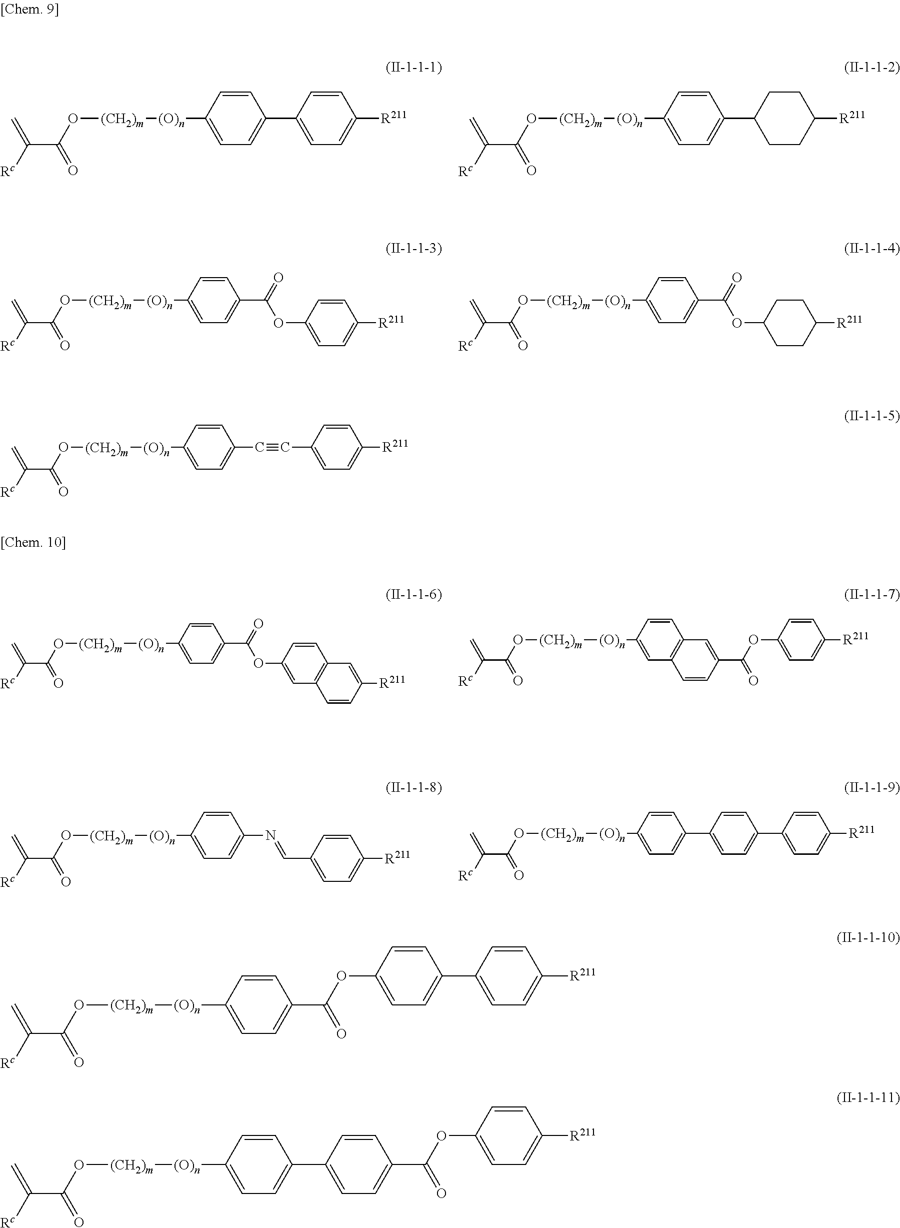

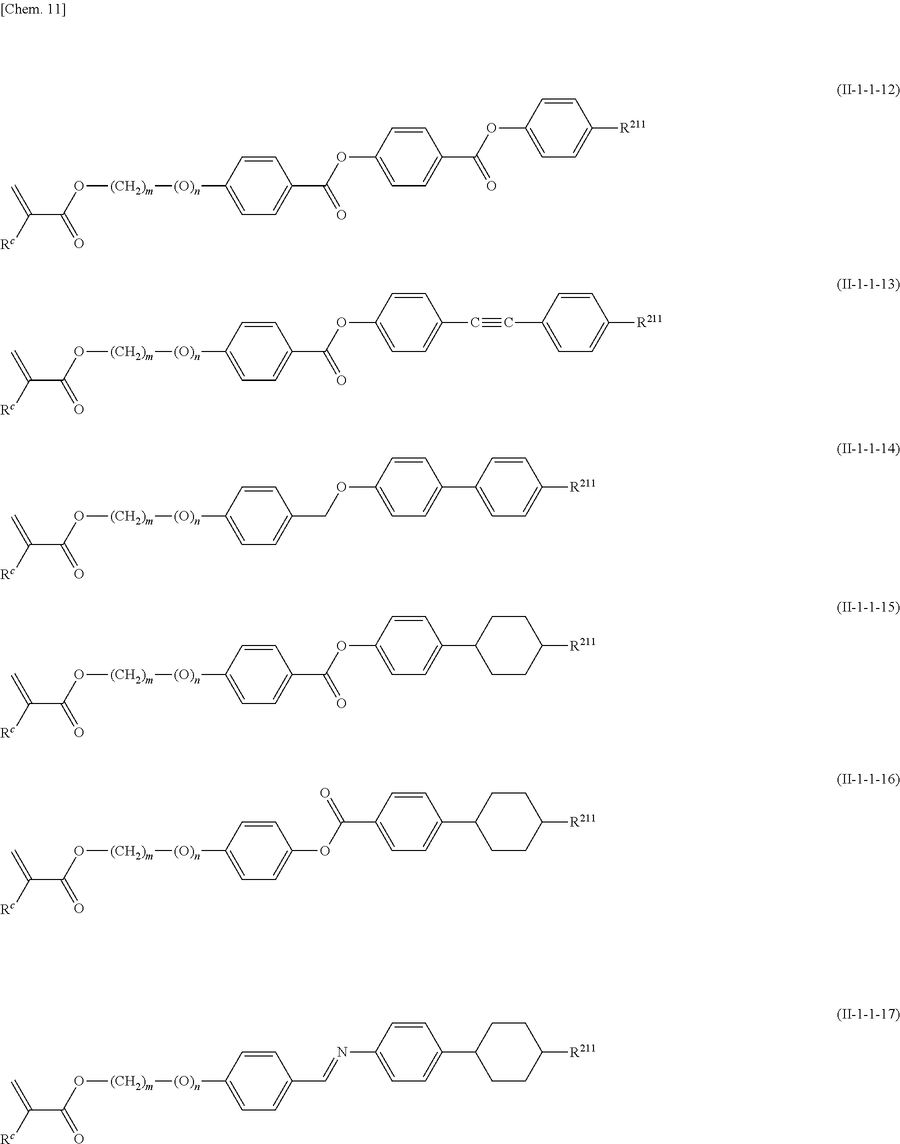

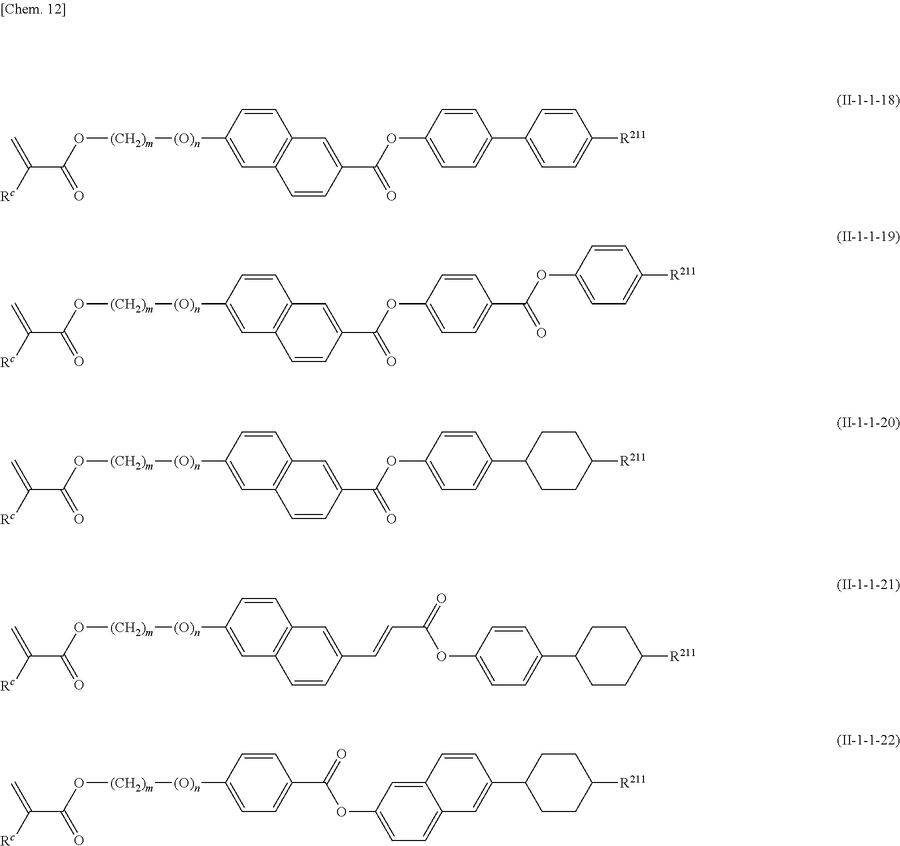

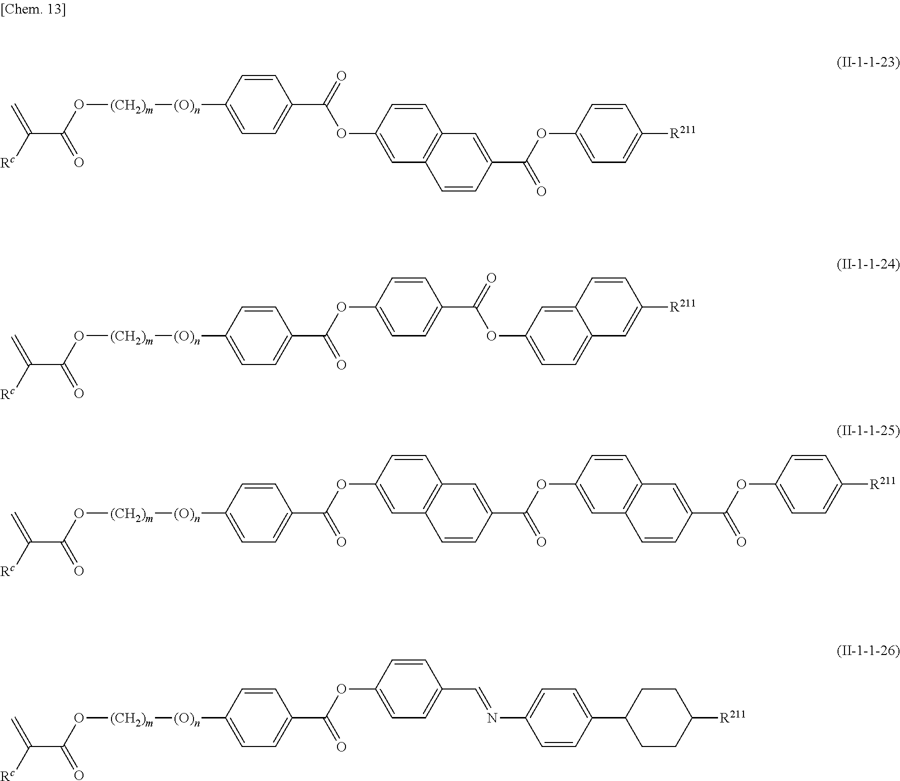

In the formulas, R^{c} represents a hydrogen atom or a methyl group; m represents an integer of 0 to 18; n represents 0 or 1; R²¹¹ represents the same as that defined in the general formulas (II-1-1) to (II-1-4); R²¹¹ preferably represents a hydrogen atom, a halogen atom, a cyano group, or a linear alkyl group having 1 to 6 carbon atoms or linear alkenyl group having 1 to 6 carbon atoms in which a single —CH₂— may be substituted with —O—, —CO—, —COO—, or —OCO—, and the cyclic groups may have, as a substituent, at least one F, Cl, CF₃, OCF₃, CN group, alkyl group having 1 to 8 carbon atoms, alkoxy group having 1 to 8 carbon atoms, alkanoyl group having 1 to 8 carbon atoms, alkanoyloxy group having 1 to 8 carbon atoms, alkoxycarbonyl group having 1 to 8 carbon atoms, alkenyl group having 2 to 8 carbon atoms, alkenyloxy group having 2 to 8 carbon atoms, alkenoyl group having 2 to 8 carbon atoms, or alkenoyloxy group having 2 to 8 carbon atoms.

More specific examples of the compounds represented by the general formula (II-1-1-1) to the general formula (II-1-1-26) include compounds represented by the following general formula (II-1-2-1) to general formula (II-1-2-36), but are not limited to these.

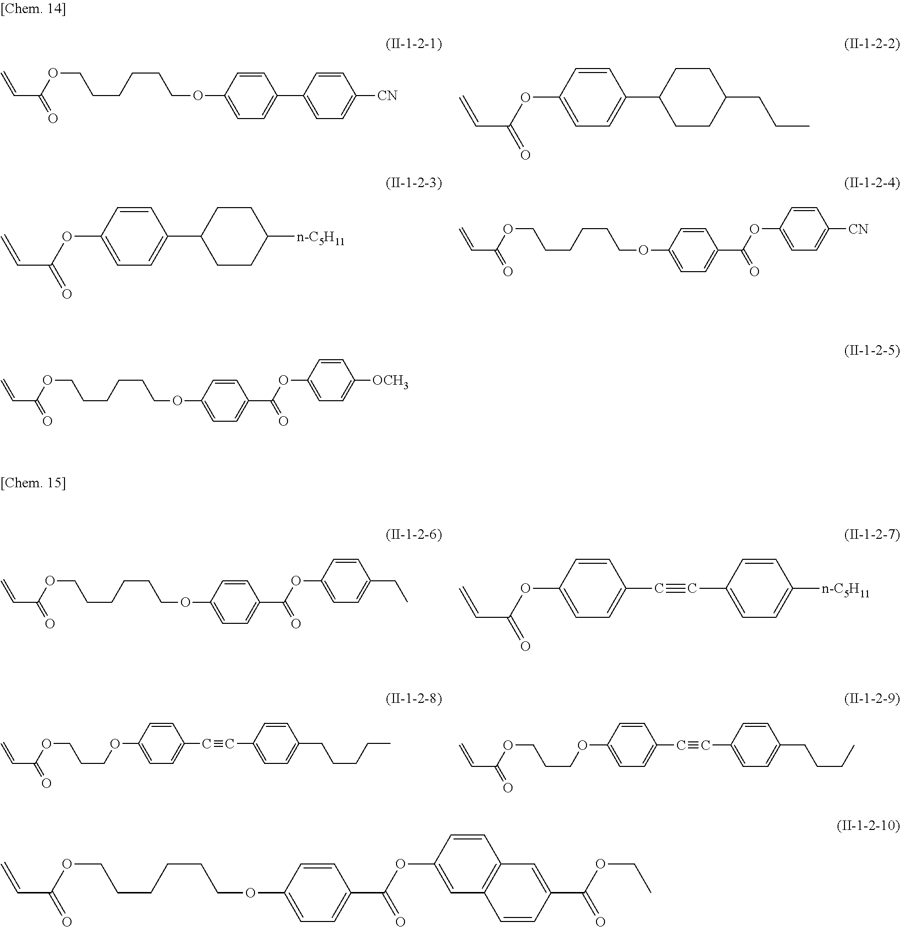

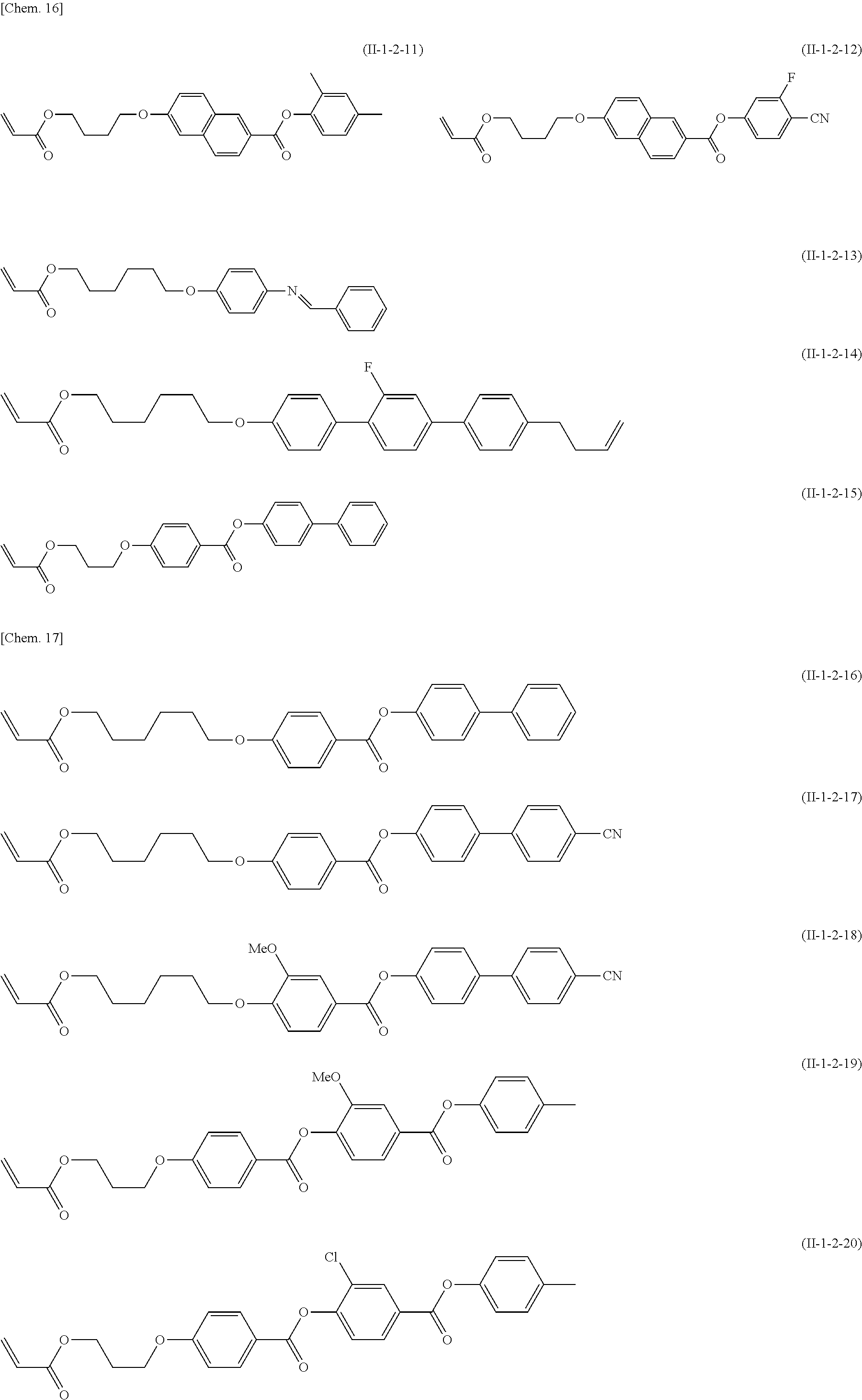

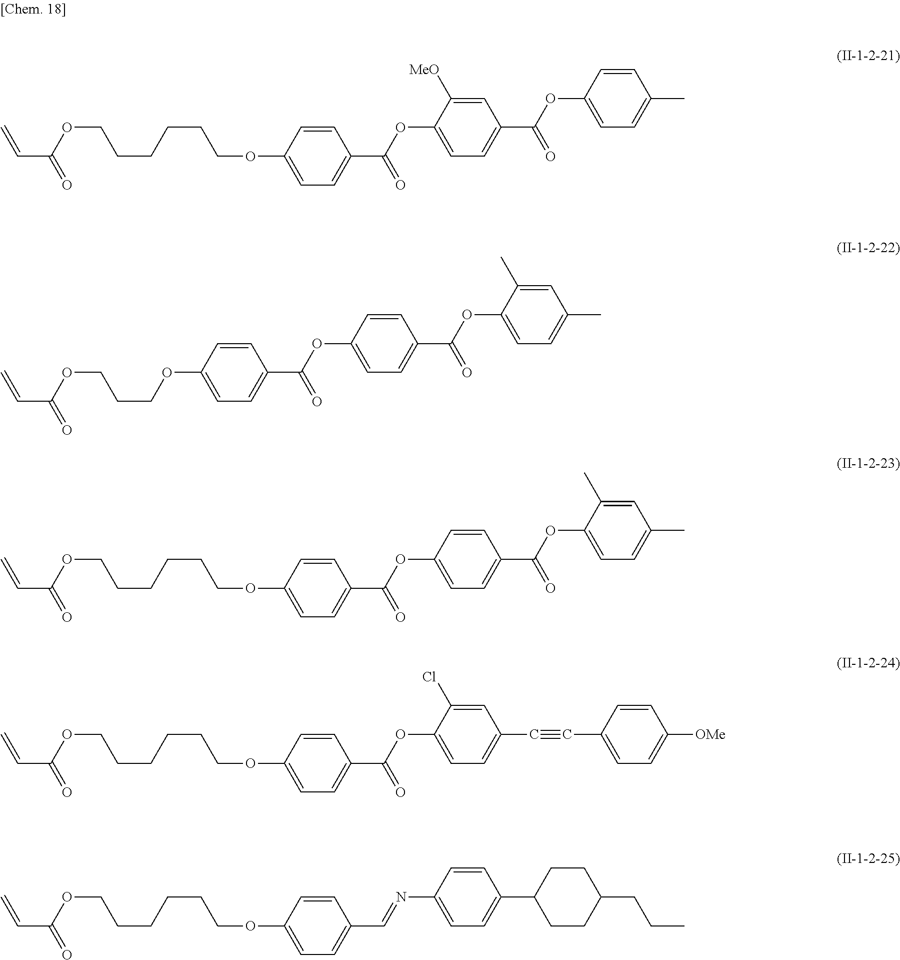

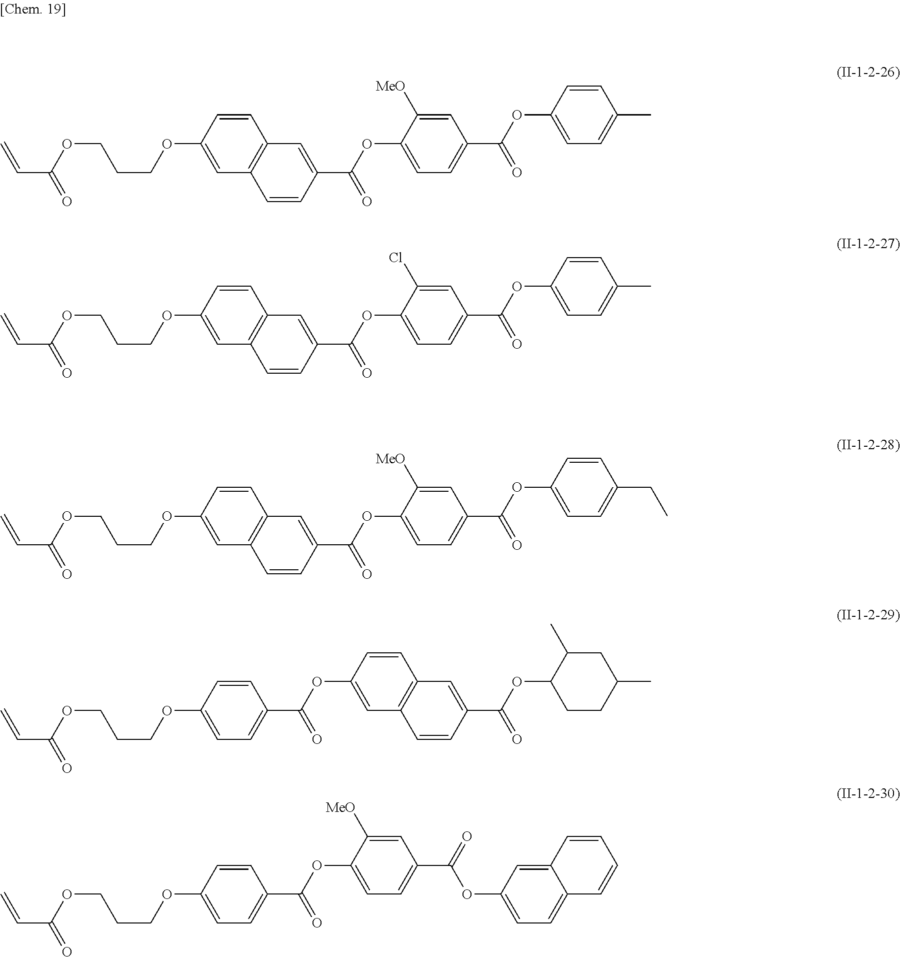

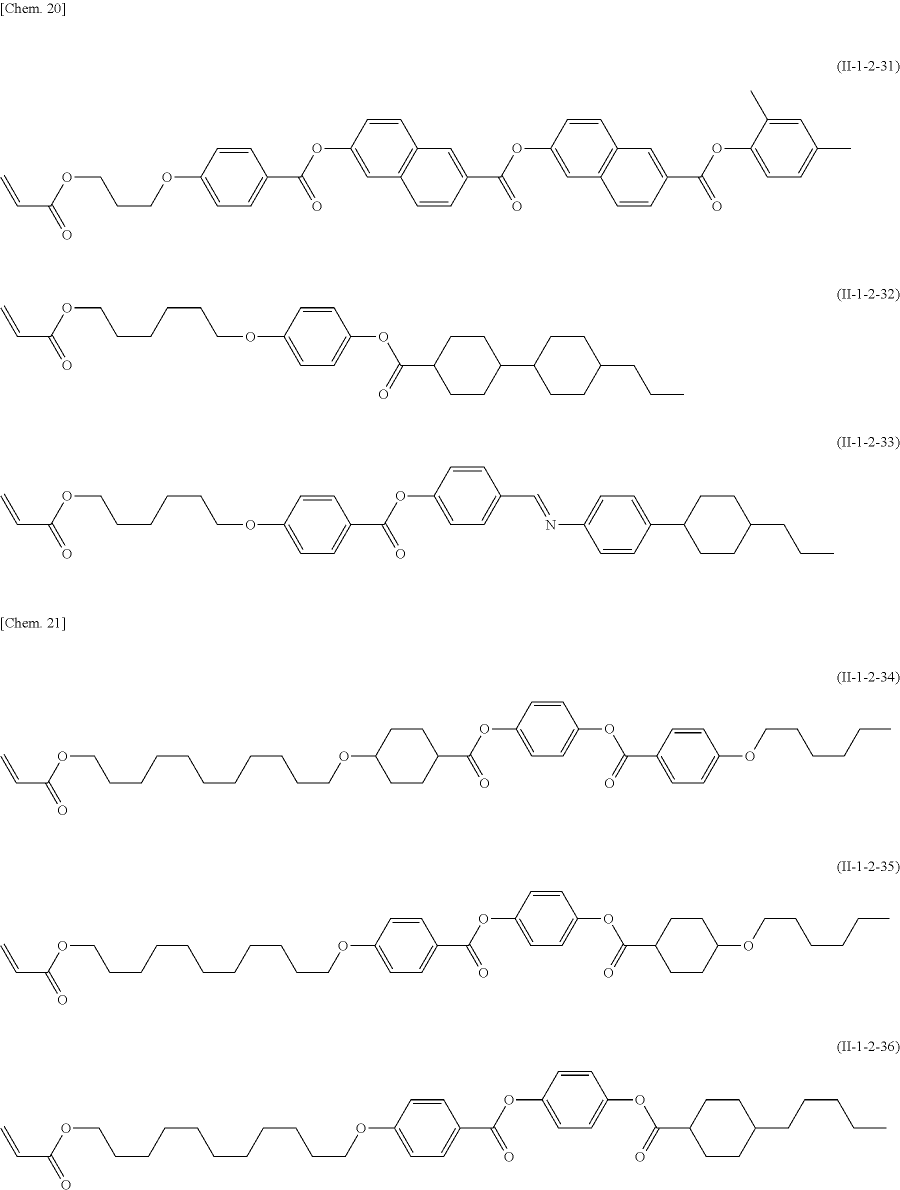

The total content of the monofunctional polymerizable liquid crystal compound intramolecularly having a single polymerizable functional group and represented by the general formula (II-1), the general formula (II-1-1) to the general formula (II-1-4), the general formula (II-1-1-1) to the general formula (II-1-1-26), or the general formula (II-1-2-1) to the general formula (II-1-2-36), relative to the total amount of polymerizable liquid crystal compound used for the polarized-luminescent-film-formable polymerizable composition that is an optically anisotropic body, is preferably 0 to 90 mass %, more preferably 0 to 85 mass %, particularly preferably 0 to 80 mass %. When the alignment of the optically anisotropic body is a priority, the lower limit is preferably set to 5 mass % or more, more preferably set to 10 mass % or more; when the hardness of the coating film is a priority, the upper limit is preferably set to 75 mass % or less, more preferably set to 70 mass % or less.

(Bifunctional Polymerizable Liquid Crystal Compound)

Among the compounds represented by the general formula (II), the bifunctional polymerizable liquid crystal compound intramolecularly having two polymerizable functional groups is preferably a compound represented by the following general formula (II-2).

[Chem. 22]

P²²¹—(SP²²¹-X²²¹)_{q221}-MG²-(X²²²-Sp²²²)_{q222}P²²² (II-2)

In the formula, P²²¹, X²¹¹, q221, X²²², q222, and P²²² respectively represent the same as those defined as P²¹, X²¹, q21, X²², q22, and P²² in the general formula (II) and the general formula (II-a),

in the general formula (II-2), Sp²²¹ and Sp²²² each independently represent an alkylene group having 1 to 18 carbon atoms (in the alkylene group, hydrogen atoms may be substituted with at least one halogen atom or CN group; in the group, a single CH₂ group or two or more non-adjacent CH₂ groups may each be independently substituted with —O—, —COO—, —OCO—, or —OCO—O—),

in the general formula (II-2), MG² represents a mesogenic group, the mesogenic group is preferably represented by a general formula (II-2-b),

[Chem. 23]

—(B11-Z11)ᵣ₁₁-B21-Z21-B31- (II-2-b)

(in the general formula (II-2-b), B11, B21, and B31 each independently represent a 1,4-phenylene group, a 1,4-cyclohexylene group, a 1,4-cyclohexenyl group, a tetrahydropyran-2,5-diyl group, a 1,3-dioxane-2,5-diyl group, a tetrahydrothiopyran-2,5-diyl group, a 1,4-bicyclo(2,2,2)octylene group, a decahydronaphthalene-2,6-diyl group, a pyridine-2,5-diyl group, a pyrimidine-2,5-diyl group, a pyrazine-2,5-diyl group, a thiophene-2,5-diyl group-, a 1,2,3,4-tetrahydronaphthalene-2,6-diyl group, a 2,6-naphthylene group, a phenanthrene-2,7-diyl group, a 9,10-dihydrophenanthrene-2,7-diyl group, a 1,2,3,4,4a,9,10a-octahydrophenanthrene-2,7-diyl group, a 1,4-naphthylene group, a benzo[1,2-b:4,5-b′]dithiophene-2,6-diyl group, a benzo[1,2-b:4,5-b′]diselenophene-2,6-diyl group, a [1]benzothieno[3,2-b]thiophene-2,7-diyl group, a [1]benzoselenopheno[3,2-b]selenophene-2,7-diyl group, or a fluorene-2,7-diyl group; and may have, as a substituent, at least one F, Cl, CF₃, OCF₃, CN group, alkyl group having 1 to 8 carbon atoms (in the alkyl group, hydrogen atoms may be substituted with at least one phenyl group; in the group, a single CH₂ group or two or more non-adjacent CH₂ groups may each be independently substituted with —O—, —COO—, —COO—, or —OCO—O—), alkoxy group having 1 to 8 carbon atoms, alkanoyl group having 1 to 8 carbon atoms, alkanoyloxy group having 1 to 8 carbon atoms, alkoxycarbonyl group having 1 to 8 carbon atoms, alkenyl group having 2 to 8 carbon atoms, alkenyloxy group having 2 to 8 carbon atoms, and/or alkenoyl group having 2 to 8 carbon atoms,

in the general formula (II-2-b), Z11 and Z21 each independently represent —COO—, —COO—, —CH₂CH₂—, —OCH₂—, —CH₂O—, —CH═CH—, —C≡C—, —CH═CHCOO—, —OCOCH═CH—, —CH₂CH₂COO—, —CH₂CH₂OCO—, —COOCH₂CH₂—, —OCOCH₂CH₂—, —C═N—, —N═C—, —CONH—, —NHCO—, —C(CF₃)₂—, an alkyl group that has 2 to 10 carbon atoms and that may have a halogen atom, or a single bond; r11 represents 0, 1, 2, or 3; when a plurality of B11's and Z11's are present, B11's may be the same or different and Z11's may be the same or different; when Z11 or Z21 represents a single bond, among B11, B21, and B31 above, two adjacent ring structures may form, through their substituents bonded together, a cyclic group).

In the general formula (II-2), from the viewpoint of improving polymerizability, P²²¹ and P²²² are each independently preferably the above-described formula (P-2-1), (P-2-2), (P-2-7), (P-2-12), or (P-2-13), more preferably the formula (P-2-1) or (P-2-2).

In the general formula (II-2), from the viewpoint of improving smectic alignment, Sp²²¹ and Sp²²² each independently represent preferably an alkylene group having 3 to 14 carbon atoms; in the alkylene group, a single CH₂ group or two or more non-adjacent CH₂ groups may each be independently substituted with —O—, —COO— or —OCO—. More preferably, Sp²²¹ and Sp²²² each independently represent an alkylene group having 3 to 12 carbon atoms; in the alkylene group, a single CH₂ group or two or more non-adjacent CH₂ groups may be substituted with —O—.

In the general formula (II-2), X²²¹ and X²²² each independently represent preferably —O—, —OCH₂—, —CH₂O—, —CO—, —COO—, —OCO—, —O—CO—O—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —C≡C—, or a single bond, more preferably —O—, —COO—, —OCO—, or a single bond (provided that P²²¹-Sp²²¹, Sp²²¹-X²²¹, P²²²-Sp²²², and Sp²²²-X²²² do not include —O—O—, —O—NH—, —S—S—, or —O—S— groups).

In the general formula (II-2-b), preferably B11, B21, and B31 each independently represent a 1,4-phenylene group, a 1,4-cyclohexylene group, or a 2,6-naphthylene group that may have the above-described substituent; Z11 and Z21 each independently represent preferably —COO—, —COO—, —CH₂CH₂—, —OCH₂—, —CH₂O—, —CH═CH—, —C≡C—, —C═N—, —N═C—, —COO—CH₂CH₂—, —OCO—CH₂CH₂—, —CH₂CH₂—COO—, —CH₂CH₂—OCO—, or a single bond; and r11 preferably represents 0 or 1.

Examples of the general formula (II-2) include compounds represented by the following general formulas (II-2-1) to (II-2-4), but are not limited to the following general formulas.

[Chem. 24]

P²¹¹-(Sp²¹¹-X²¹¹)_{q211}-B21-Z21-B31-(X²²²-Sp²²²)_{q222}-P²²² (II-2-1)

P²¹¹-(Sp²¹¹-X²¹¹)_{q211}-B111-Z111-B21-Z21-B31-(X²²²-Sp²²²)_{q222}-P²²² (II-2-2)

P²¹¹-(Sp²¹¹-X²¹¹)_{q211}-B111-Z111-B112-Z112-B21-Z21-B31-(X²²²-Sp²²²)_{q222}-P²²² (II-2-3)

P²¹¹-(Sp²¹¹-X²¹¹)_{q211}-B111-Z111-B112-Z112-B113-Z113-B21-Z21-B31-(X²²²-Sp²²²)_{q222}-P²²² (II-2-4)

In the general formulas (II-2-1) to (II-2-4), P²²¹, Sp²²¹, X²²¹, q221, X²²², Sp²²², q222, and P²²² represent the same as those defined in the general formula (II-2),

in the general formulas (II-2-1) to (II-2-4), B111, B112, B113, B21, and B31 represent the same as those defined as B11 to B31 in the general formula (II-2-b); preferred groups are also the same as those defined for B11 to B31; B111, B112, B113, B21, and B31 may be the same or different,

in the general formulas (II-2-1) to (II-2-4), Z111, Z112, Z113, and Z21 represent the same as those defined as Z11 to Z21 in the general formula (II-2-b); preferred groups are also the same as those defined for Z11 to Z21; and Z111, Z112, Z113, and Z21 may be the same or different.

Among the compounds represented by the general formulas (II-2-1) to (II-2-4), the compounds represented by the general formulas (II-2-2) to (II-2-4) and having three or more ring structures in such a compound are preferably used because the resultant films have good alignment and good curability; the compound represented by the general formula (II-2-2) and having three ring structures in the compound is particularly preferably used.

Examples of the compounds represented by the general formulas (II-2-1) to (II-2-4) include compounds represented by the following general formula (II-2-1-1) to general formula (II-2-1-25), but are not limited to these.

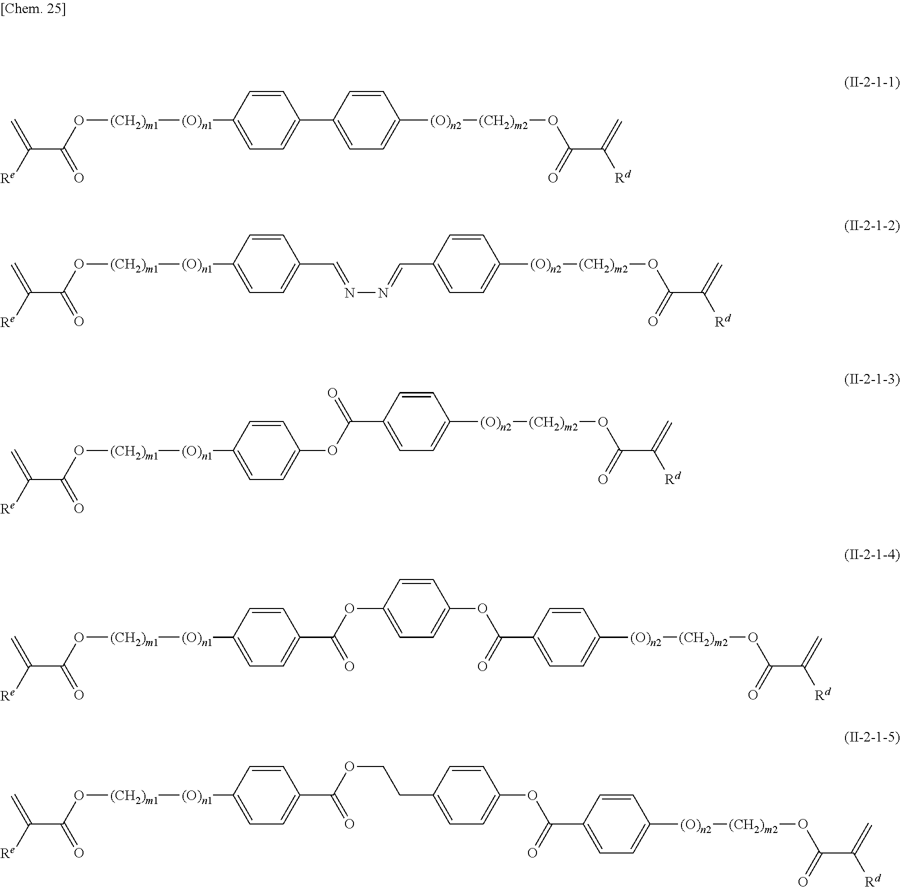

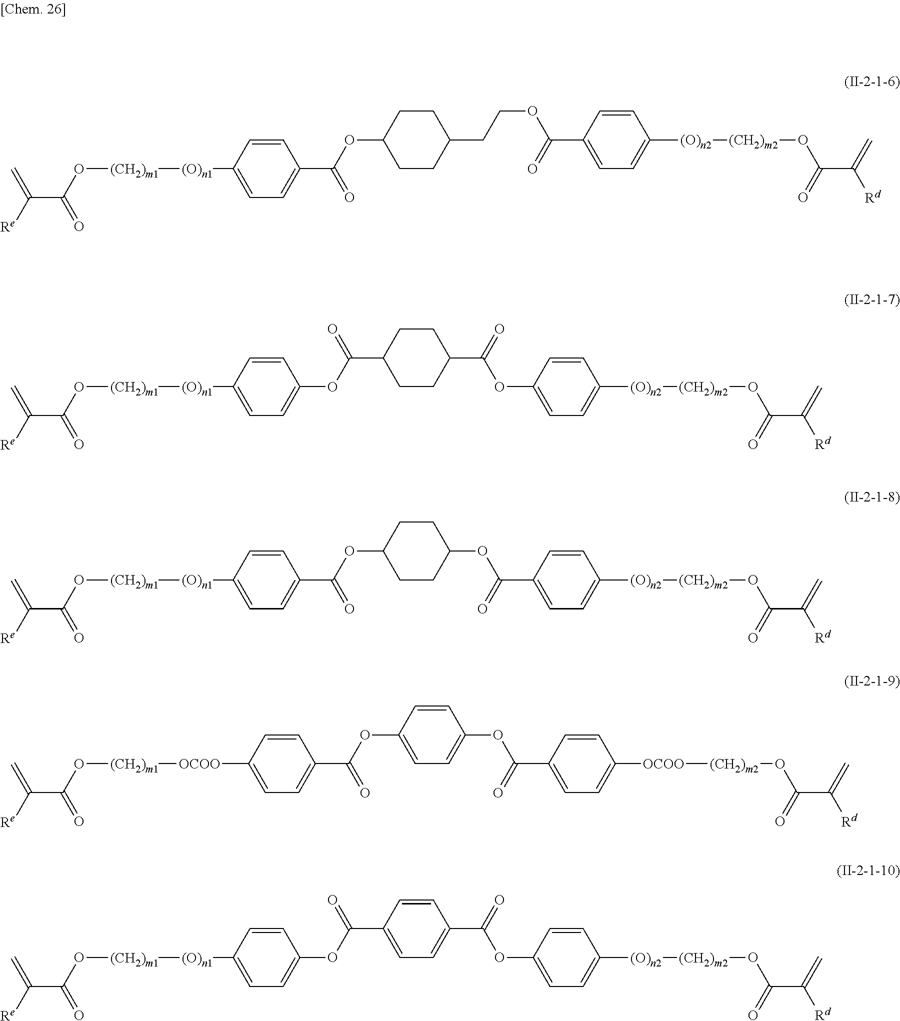

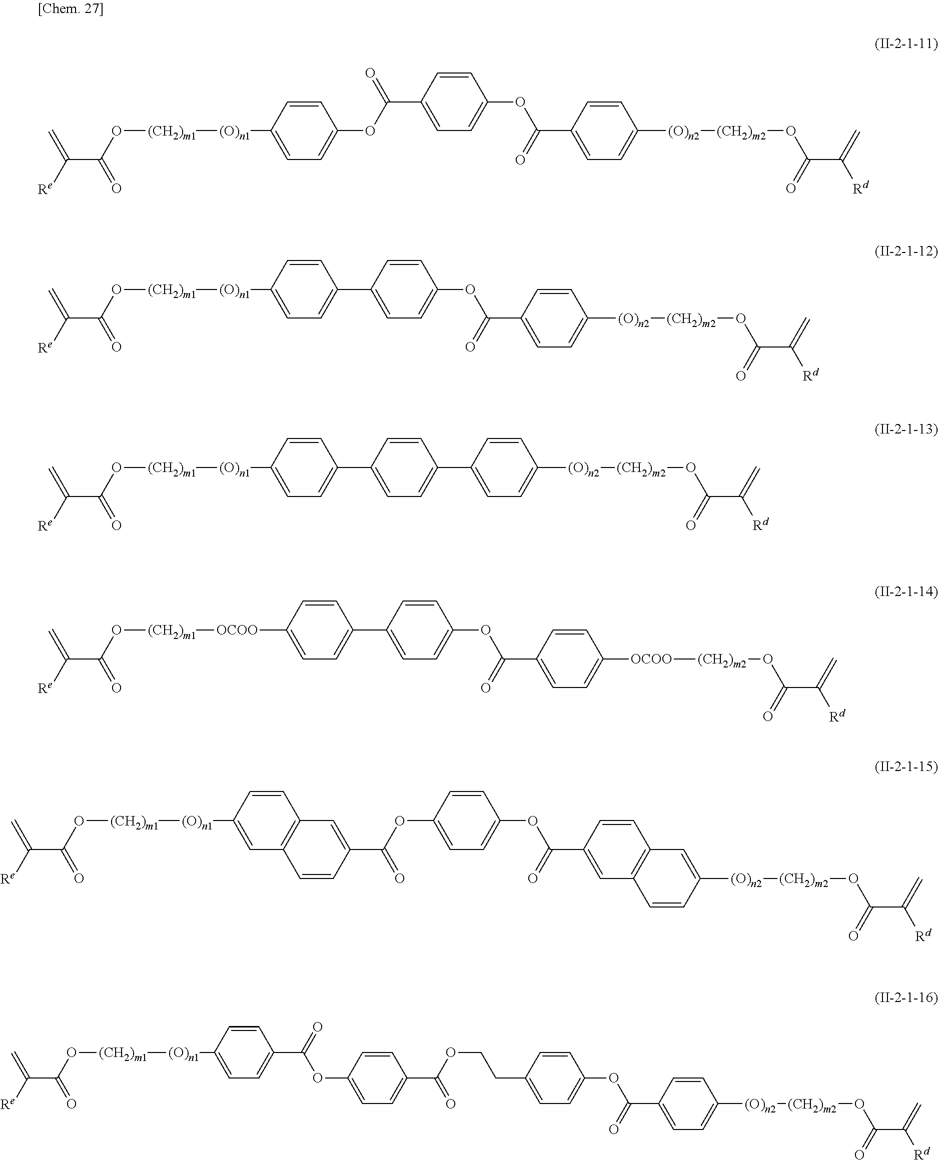

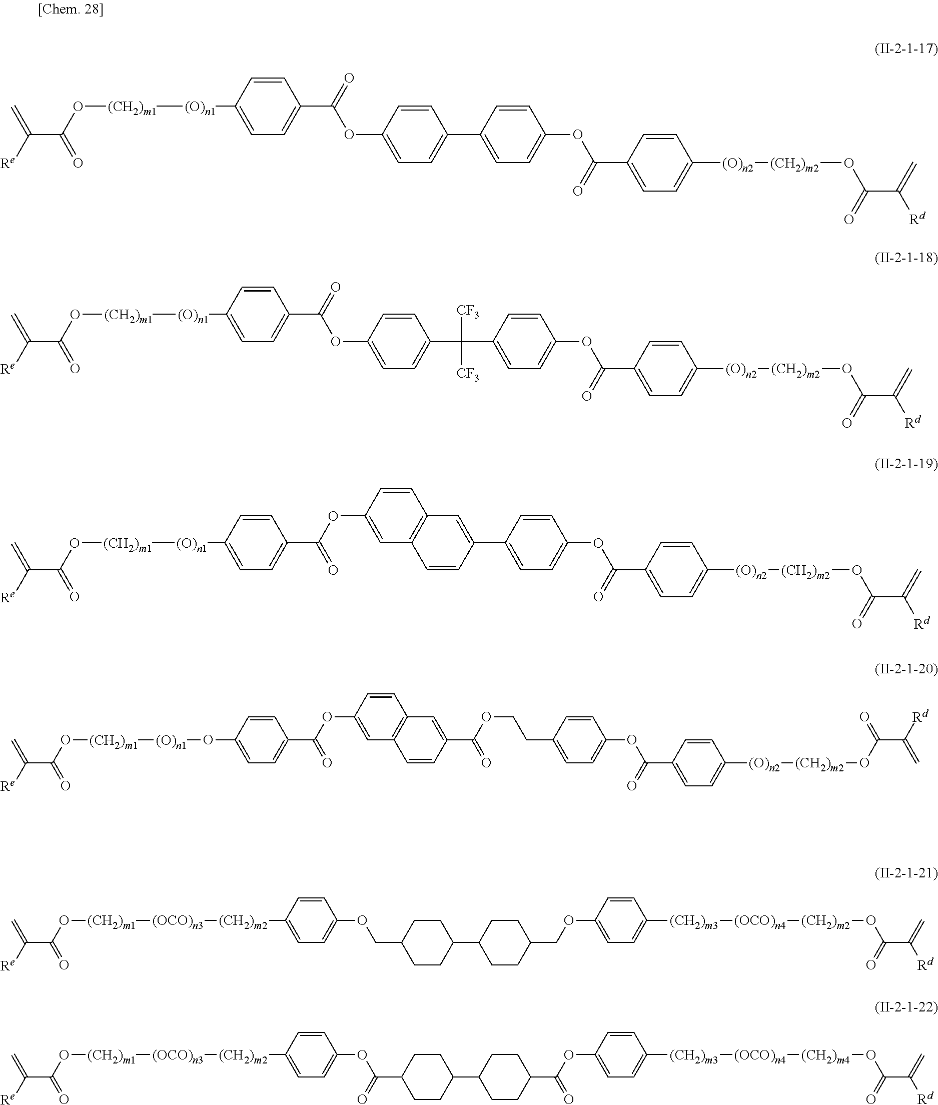

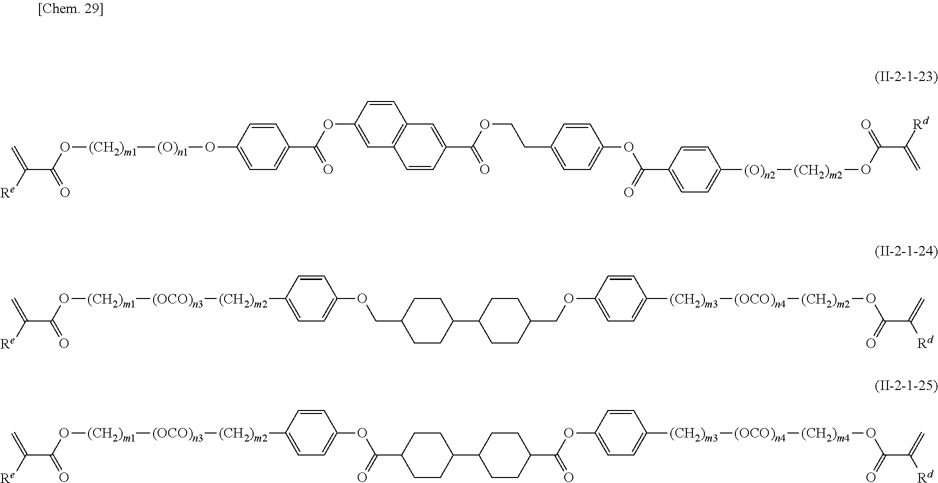

In the formulas, R^{d} and R^{e} each independently represent a hydrogen atom or a methyl group, and the cyclic groups may have, as a substituent, at least one F, Cl, CF₃, OCF₃, CN group, alkyl group having 1 to 8 carbon atoms, alkoxy group having 1 to 8 carbon atoms, alkanoyl group having 1 to 8 carbon atoms, alkanoyloxy group having 1 to 8 carbon atoms, alkoxycarbonyl group having 1 to 8 carbon atoms, alkenyl group having 2 to 8 carbon atoms, alkenyloxy group having 2 to 8 carbon atoms, alkenoyl group having 2 to 8 carbon atoms, or alkenoyloxy group having 2 to 8 carbon atoms.

m1, m2, m3, and m4 each independently represent an integer of 0 to 8; n1, n2, n3, and n4 each independently represent 0 or 1.

More specific examples of the compounds represented by the general formula (II-2-1-1) to general formula (II-2-1-21) include compounds represented by the following general formula (II-2-2-1) to general formula (II-2-2-35), but are not limited to these.

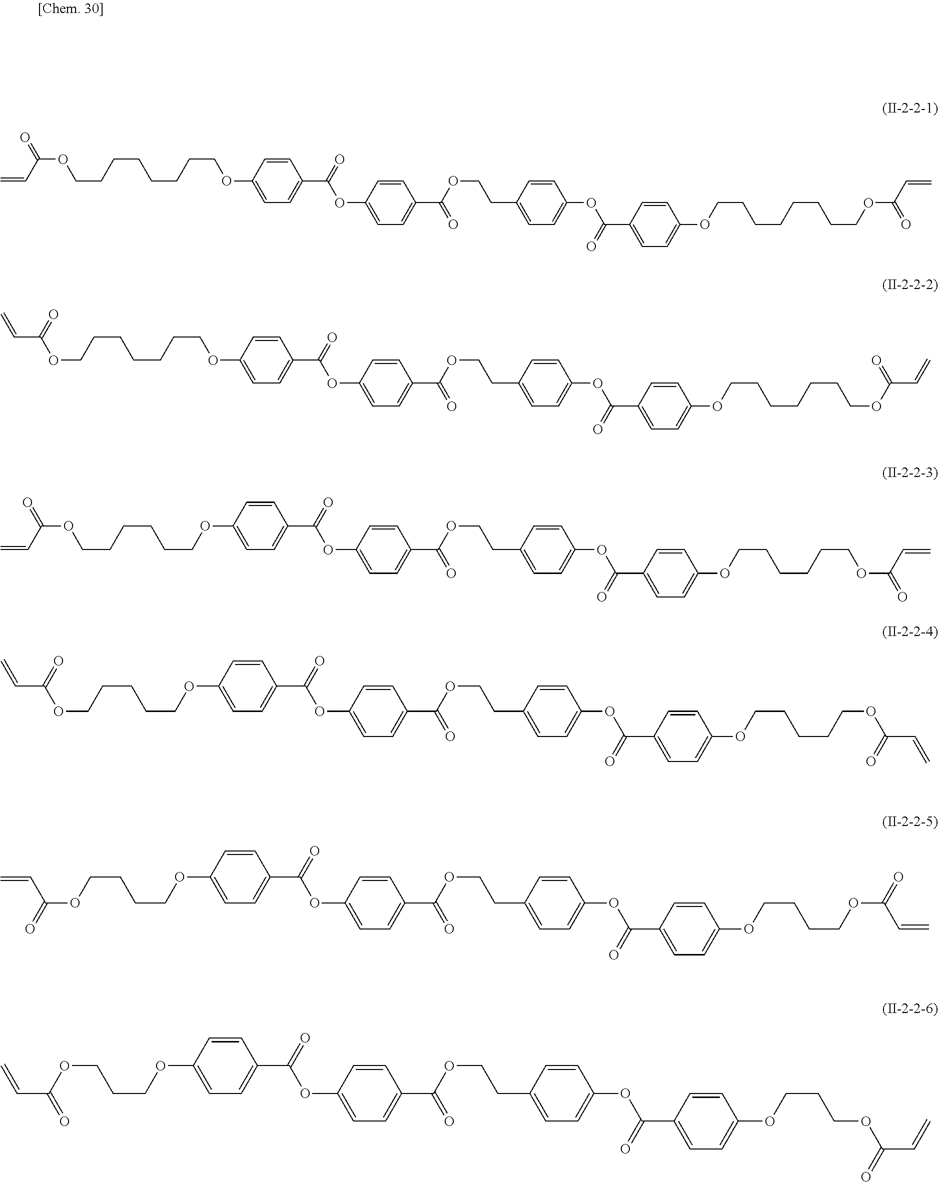

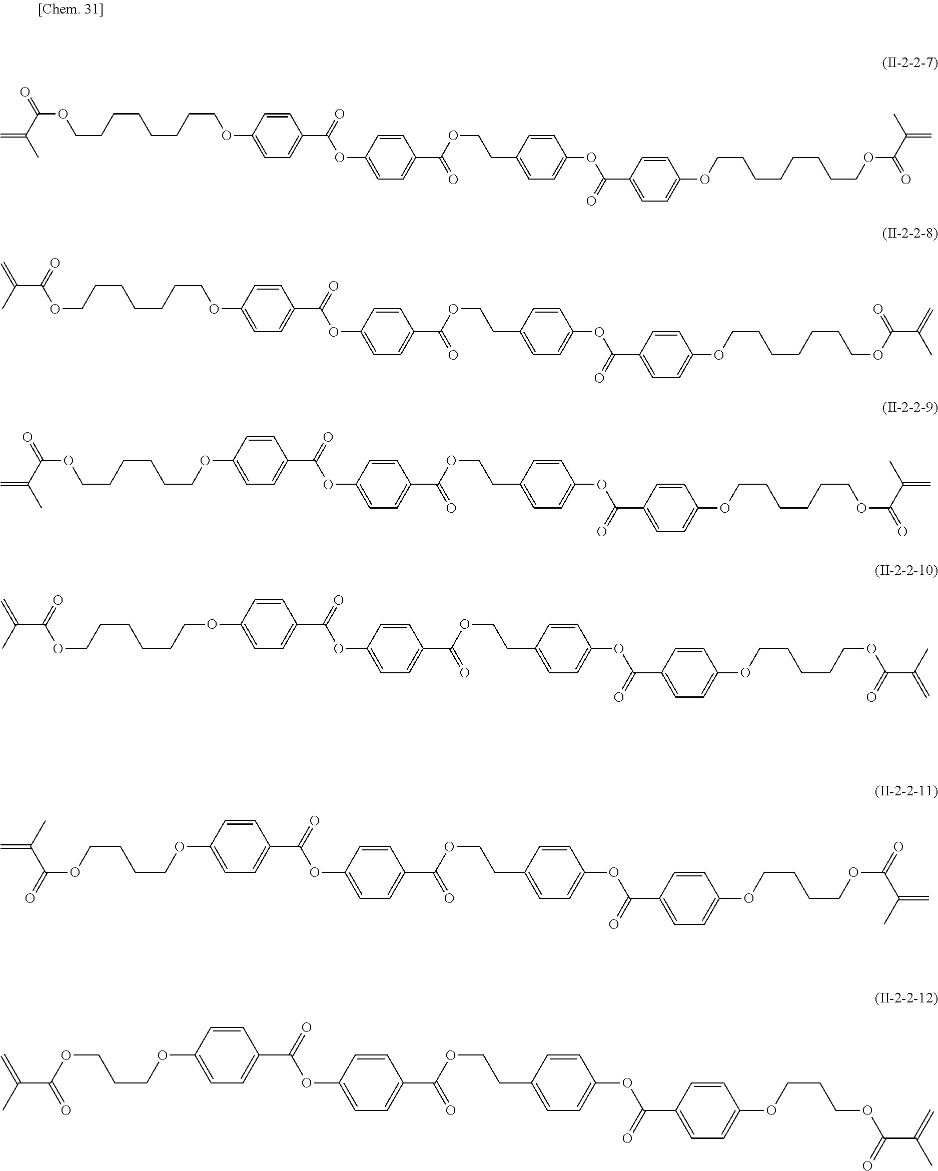

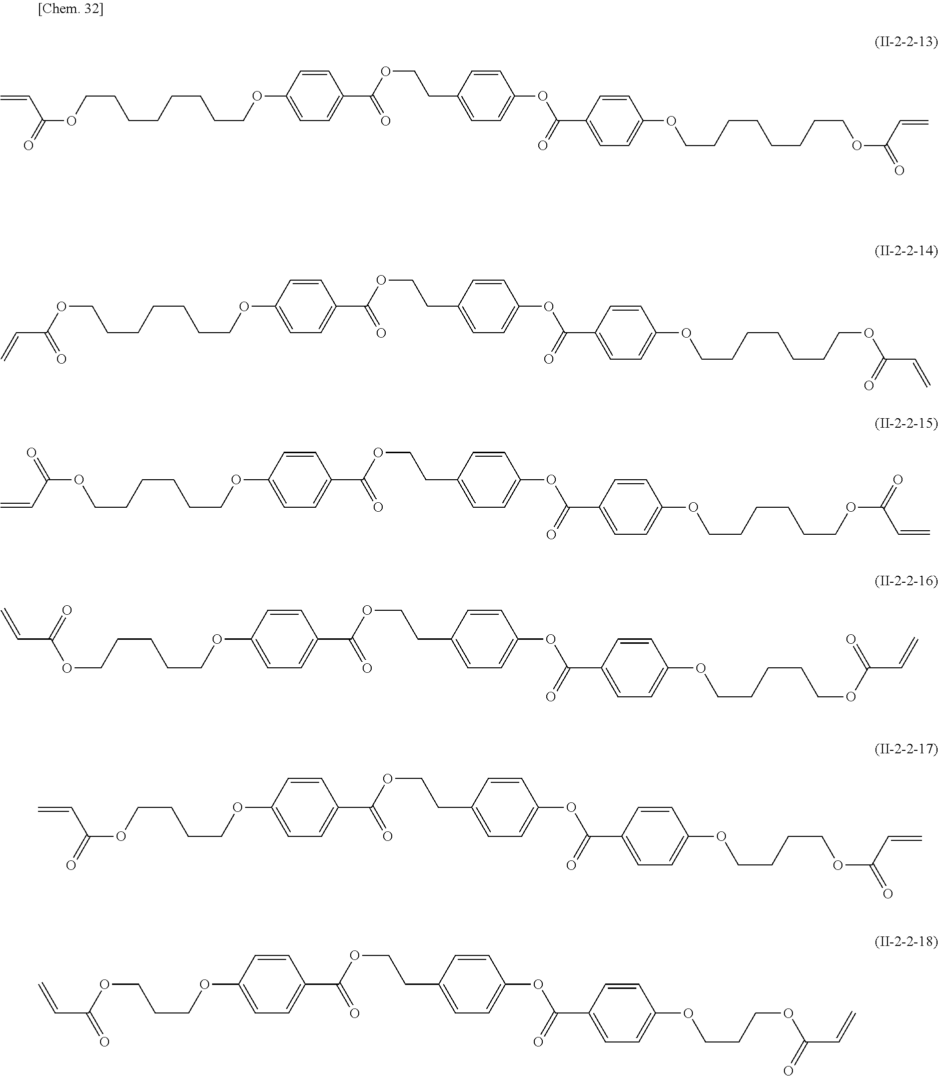

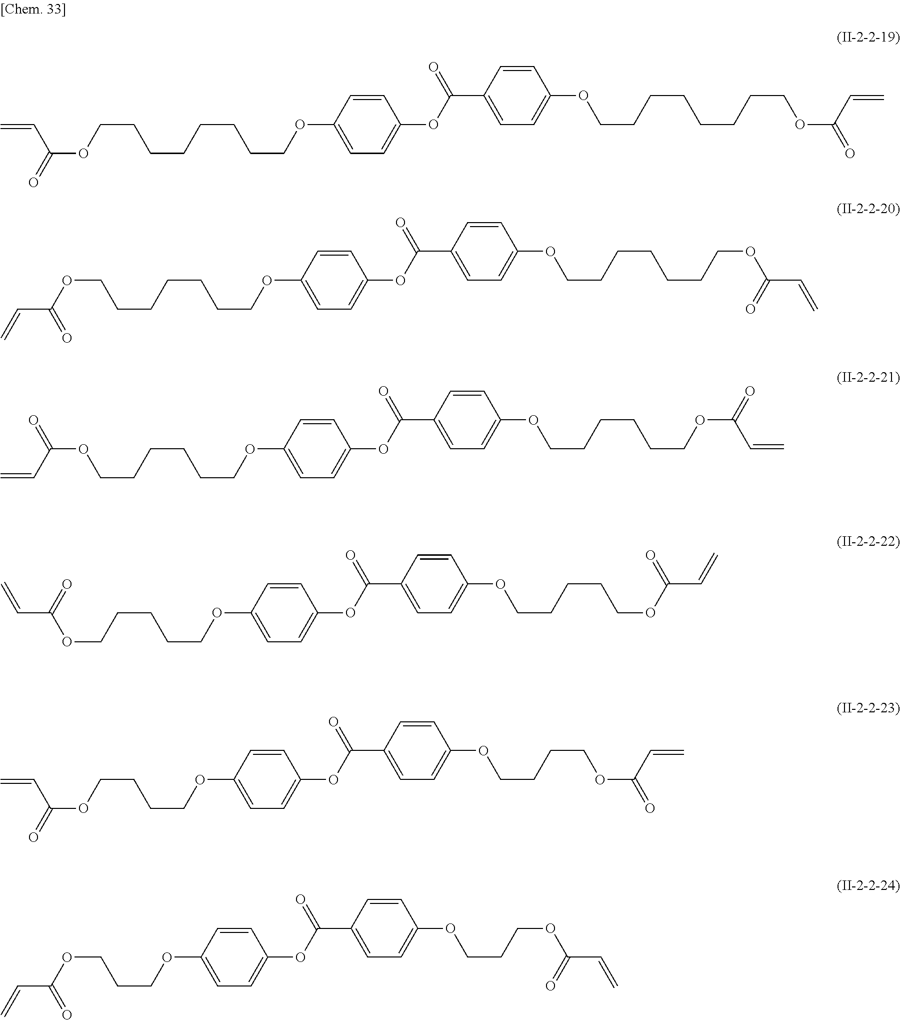

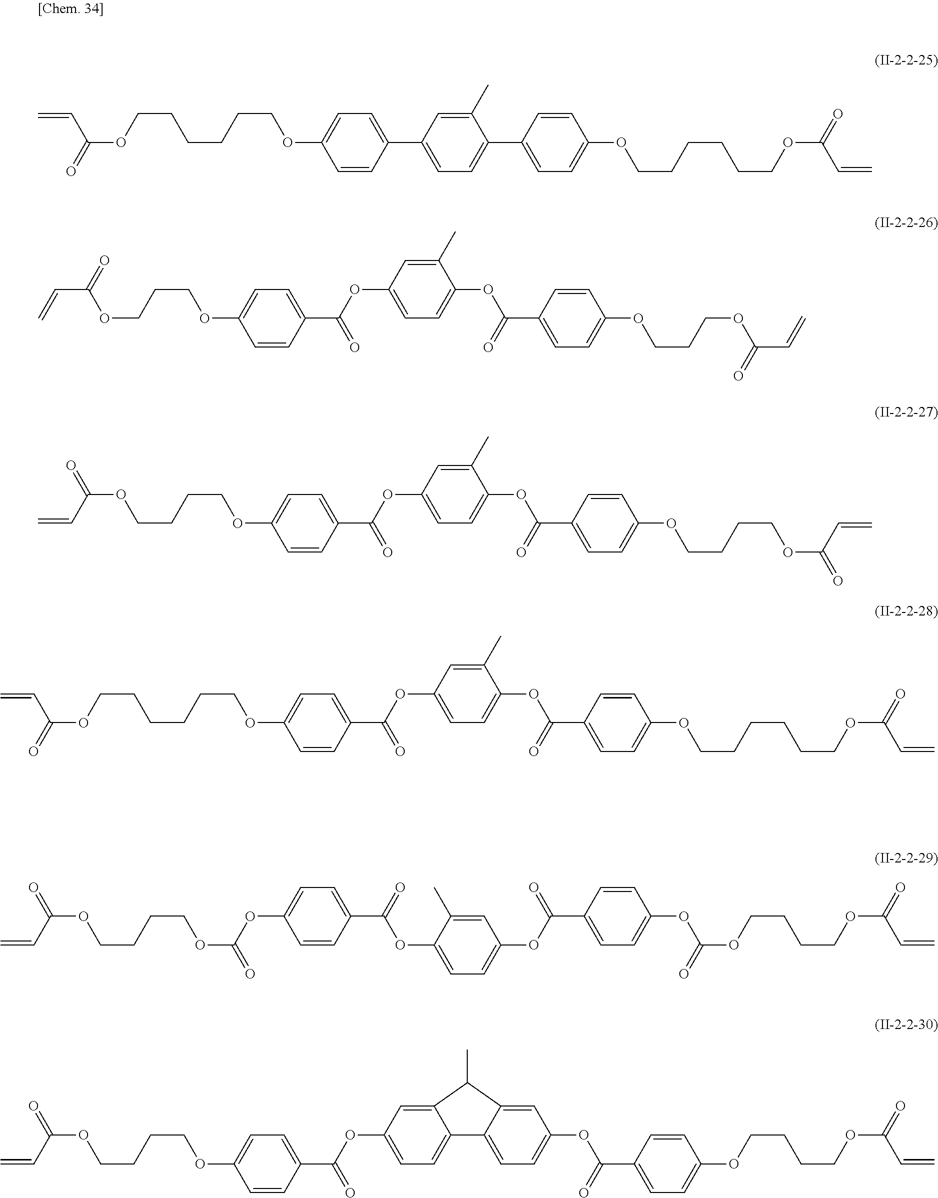

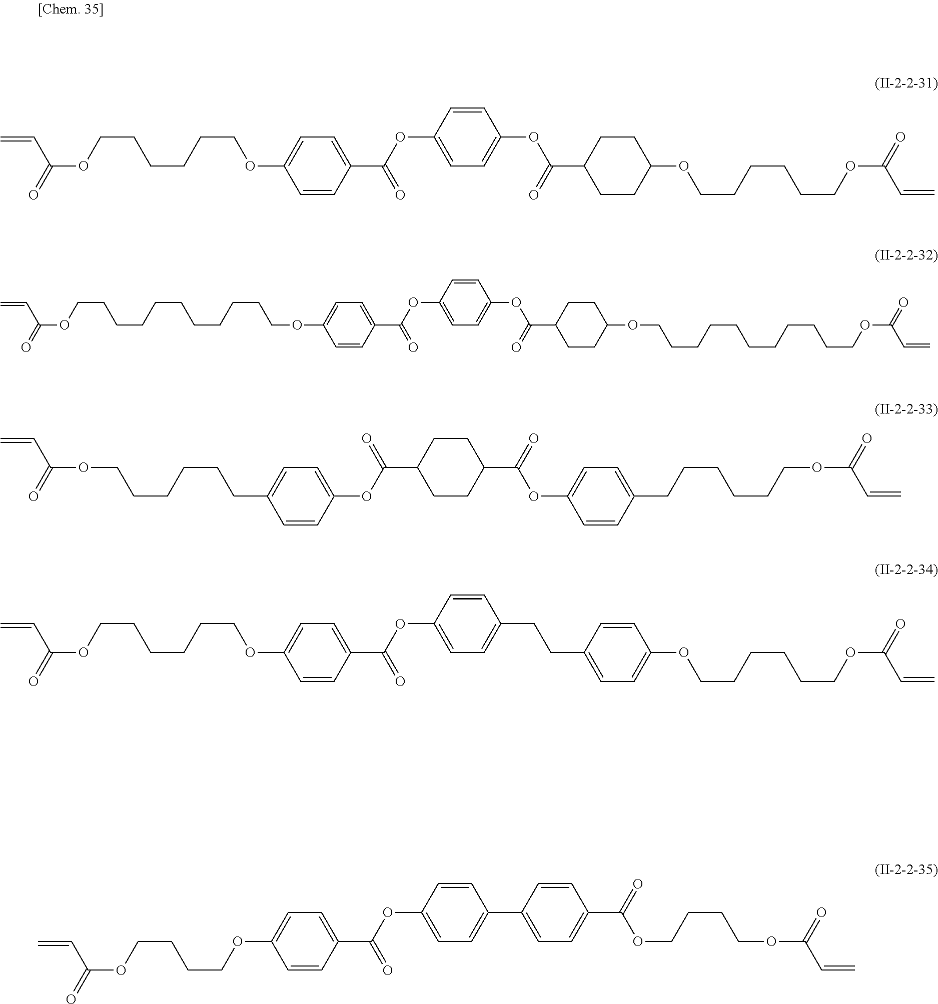

As a polymerizable liquid crystal compound having two polymerizable functional groups, one or two or more species may be used, preferably one to five species, more preferably two to five species.

The total content of the bifunctional polymerizable liquid crystal compound intramolecularly having two polymerizable functional groups and represented by the general formula (II-2), the general formula (II-2-1) to the general formula (II-2-4), the general formula (II-2-1-1) to the general formula (II-2-1-21), or the general formula (II-2-2-1) to the general formula (II-2-2-35), relative to the total amount of polymerizable liquid crystal compound used for a polarized luminescent film, is preferably 10 to 100 mass %, more preferably 15 to 85 mass %, particularly preferably 20 to 80 mass %. When the hardness of the coating film is a priority, the lower limit is preferably set to 30 mass % or more, more preferably set to 50 mass % or more; when the alignment of the film is a priority, the upper limit is preferably set to 85 mass % or less, more preferably set to 80 mass % or less.

(Polyfunctional Polymerizable Liquid Crystal Compound)

As a polyfunctional polymerizable liquid crystal compound having three or more polymerizable functional groups, a compound having three polymerizable functional groups is preferably used. Among the compounds represented by the general formula (II), examples of a polyfunctional polymerizable liquid crystal compound intramolecularly having three or four polymerizable functional groups include compounds represented by the following general formula (II-3-1) to general formula (II-3-2).

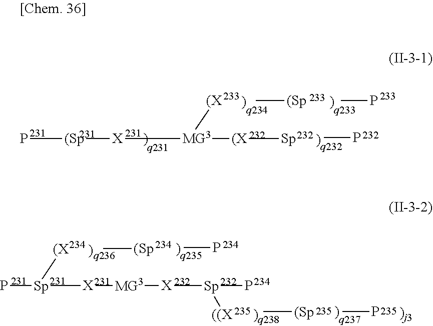

In the general formula (II-3-1) to general formula (II-3-2), P²³¹, X²³¹, q231, X²³², q232, P²³², P²³³, X²³³, q233, q234, q233, X²³⁴, q236, q235, P²³⁴, X²³⁵, q238, q237, and P²³⁵ respectively represent the same as those defined as P²¹, X²¹, q21, X²², q22, P²², P²³, X²³, q24, q23, X²³, q24, q23, P²³, X²³, q24, q23, and P²³ in the general formula (II), the general formula (II-a), and the general formula (II-c),

in the general formula (II-3-1) to the general formula (II-3-2), Sp²³¹, Sp²³², Sp²³³, Sp²³⁴, and Sp²³⁵ each independently represent an alkylene group having 1 to 18 carbon atoms (in the alkylene group, hydrogen atoms may be substituted with at least one halogen atom or CN group; in the group, a single CH₂ group or two or more non-adjacent CH₂ groups may each be independently substituted with —O—, —COO—, —OCO—, or —OCO—O—),

in the general formula (II-3-2), j3 represents 0 or 1,

in the general formula (II-3-1) to the general formula (II-3-2), MG³ represents a mesogenic group, the mesogenic group is represented by a general formula (II-3-b),

[Chem. 37]

—(B11-Z11)ᵣ₁₁-B21-Z21-B31- (II-3-b)

(in the general formula (II-3-b), B11, B21, and B31 each independently represent a 1,4-phenylene group, a 1,4-cyclohexylene group, a 1,4-cyclohexenyl group, a tetrahydropyran-2,5-diyl group, a 1,3-dioxane-2,5-diyl group, a tetrahydrothiopyran-2,5-diyl group, a 1,4-bicyclo(2,2,2)octylene group, a decahydronaphthalene-2,6-diyl group, a pyridine-2,5-diyl group, a pyrimidine-2,5-diyl group, a pyrazine-2,5-diyl group, a thiophene-2,5-diyl group-, a 1,2,3,4-tetrahydronaphthalene-2,6-diyl group, a 2,6-naphthylene group, a phenanthrene-2,7-diyl group, a 9,10-dihydrophenanthrene-2,7-diyl group, a 1,2,3,4,4a,9,10a-octahydrophenanthrene-2,7-diyl group, a 1,4-naphthylene group, a benzo[1,2-b:4,5-b′]dithiophene-2,6-diyl group, a benzo[1,2-b:4,5-b′]diselenophene-2,6-diyl group, a [1]benzothieno[3,2-b]thiophene-2,7-diyl group, a [1]benzoselenopheno[3,2-b]selenophene-2,7-diyl group, or a fluorene-2,7-diyl group; and may have, as a substituent, at least one F, Cl, CF₃, OCF₃, CN group, alkyl group having 1 to 8 carbon atoms (in the alkyl group, hydrogen atoms may be substituted with at least one phenyl group; in the group, a single CH₂ group or two or more non-adjacent CH₂ groups may each be independently substituted with —O—, —COO—, —COO—, or —OCO—O—), alkoxy group having 1 to 8 carbon atoms, alkanoyl group having 1 to 8 carbon atoms, alkanoyloxy group having 1 to 8 carbon atoms, alkoxycarbonyl group having 1 to 8 carbon atoms, alkenyl group having 2 to 8 carbon atoms, alkenyloxy group having 2 to 8 carbon atoms, and/or alkenoyl group having 2 to 8 carbon atoms,

in the general formula (II-3-b), Z11 and Z21 each independently represent —COO—, —COO—, —CH₂CH₂—, —OCH₂—, —CH₂O—, —CH═CH—, —C≡C—, —CH═CHCOO—, —OCOCH═CH—, —CH₂CH₂COO—, —CH₂CH₂OCO—, —COOCH₂CH₂—, —OCOCH₂CH₂—, —C═N—, —N═C—, —CONH—, —NHCO—, —C(CF₃)₂—, an alkyl group that has 2 to 10 carbon atoms and that may have a halogen atom, or a single bond; r11 represents 0, 1, 2, or 3; when a plurality of B11's and Z11's are present, B11's may be the same or different and Z11's may be the same or different); when Z11 or Z21 represents a single bond, among B11, B21, and B31 above, two adjacent ring structures may form, through their substituents bonded together, a cyclic group, and in the general formula (II-3-1) to the general formula (II-3-2), from the viewpoint of improving polymerizability, P²³¹, P²³², P²³³, P²³⁴, and P²³⁵ each independently represent the above-described formula (P-2-1), (P-2-2), (P-2-7), (P-2-12), or (P-2-13), more preferably the formula (P-2-1) or (P-2-2).

In the general formula (II-3-1) to the general formula (II-3-2), from the viewpoint of improving smectic alignment, Sp²³¹, Sp²³², Sp²³³, Sp²³⁴ and Sp²³⁵ each independently represent preferably an alkylene group having 3 to 14 carbon atoms; in the alkylene group, a single CH₂ group or two or more non-adjacent CH₂ groups may each be independently substituted with —O—, —COO—, or —OCO—. More preferably, Sp²³¹, Sp²³², Sp²³³, Sp²³⁴, and Sp²³⁵ each independently represent an alkylene group having 3 to 12 carbon atoms; in the alkylene group, a single CH₂ group or two or more non-adjacent CH₂ groups may be substituted with —O—.

In the general formula (II-3-1) to the general formula (II-3-2), X²³¹, X²³², X²³³, X²³⁴, and X²³⁵ each independently represent preferably —O—, —OCH₂—, —CH₂O—, —CO—, —COO—, —OCO—, —O—CO—O—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —C≡C—, or a single bond, more preferably —O—, —COO—, —COO—, or a single bond (provided that P²³¹-Sp²³¹, Sp²³¹-X²³¹, P²³²-Sp²³², Sp²³²-X²³², P²³³-Sp²³³, Sp²³³-X²³³, P²³⁴-Sp²³⁴, Sp²³⁴-X²³⁴, P²³⁵-Sp²³⁵, and Sp²³⁵-X²³⁵ do not include —O—O—, —O—NH—, —S—S—, or —O—S— groups).

In the general formula (II-3-b), preferably B11, B21, and B31 each independently represent a 1,4-phenylene group, a 1,4-cyclohexylene group, or a 2,6-naphthylene group that may have the above-described substituent; preferably Z11 and Z21 each independently represent —COO—, —COO—, —CH₂CH₂—, —OCH₂—, —CH₂O—, —CH═CH—, —C≡C—, —C═N—, —N═C—, —COO—CH₂CH₂—, —OCO—CH₂CH₂—, —CH₂CH₂—COO—, —CH₂CH₂—OCO—, or a single bond; and r11 preferably represents 0 or 1.

In the general formula (II-3-1), for MG³, the group represented by the —(X²³³)_{q234}—(Sp²³³)_{q233}-P²³³ group and having a polymerizable group is provided as a substituent substituting B11, B21, and/or B31 in MG³.

In the general formula (II-3-2), for the Sp group, the —(X²³⁴)_{q236}—(Sp²³⁴)_{q235}-P²³⁴ group and the group represented by the present —(X²³⁴)_{q236}—(Sp²³⁴)_{q235}-P²³⁴ group and having a polymerizable group are provided by substituting hydrogen atoms in the alkylene group in the Sp group.

Examples of compounds represented by the general formula (II-3-1) to the general formula (II-3-2) include compounds represented by the following general formulas (II-3-3-1) to (II-3-3-10), but are not limited to the following general formulas.

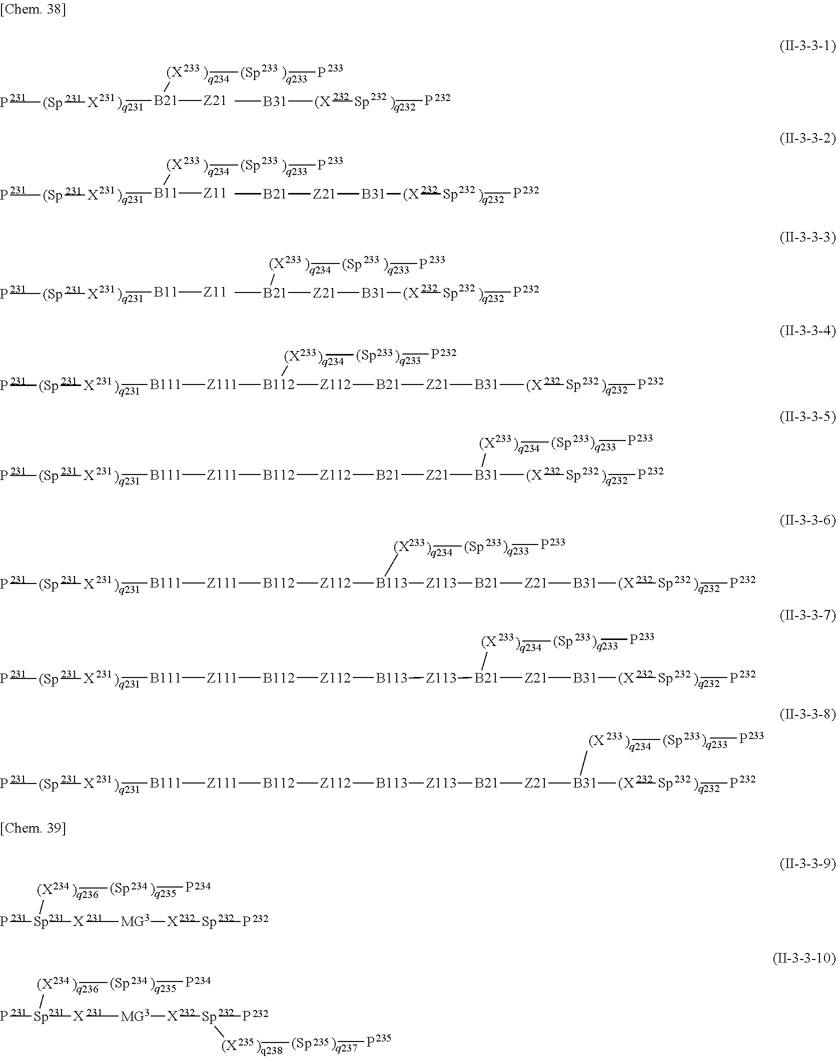

In the general formulas (II-3-3-1) to (II-3-3-10), P²³¹ to P²³⁵, Sp²³¹ to Sp²³⁵, X²³¹ to X²³⁵, q231 to q238, and MG³ represent the same as those defined in the general formula (II-3-1) to the general formula (II-3-2).

In the general formulas (II-3-3-1) to (II-3-3-10), B111, B112, B113, B21, and B31 represent the same as those defined as B11, B21, and B31 in the general formula (II-3-b); preferred groups are also the same as those defined for B11 to B31; B111, B112, B113, B21, and B31 may be the same or different.

In the general formulas (II-3-3-1) to (II-3-3-10), Z111, Z112, Z113, and Z21 represent the same as those defined as Z11 and Z21 in the general formula (II-3-b); preferred groups are also the same as those defined for Z11 to Z21; 2111, 2112, 2113, and Z21 may be the same or different.

Examples of compounds represented by the general formulas (II-3-3-1) to (II-3-3-10) include compounds represented by the following formula (II-3-3-3-1) to formula (II-3-3-6), but are not limited to these.

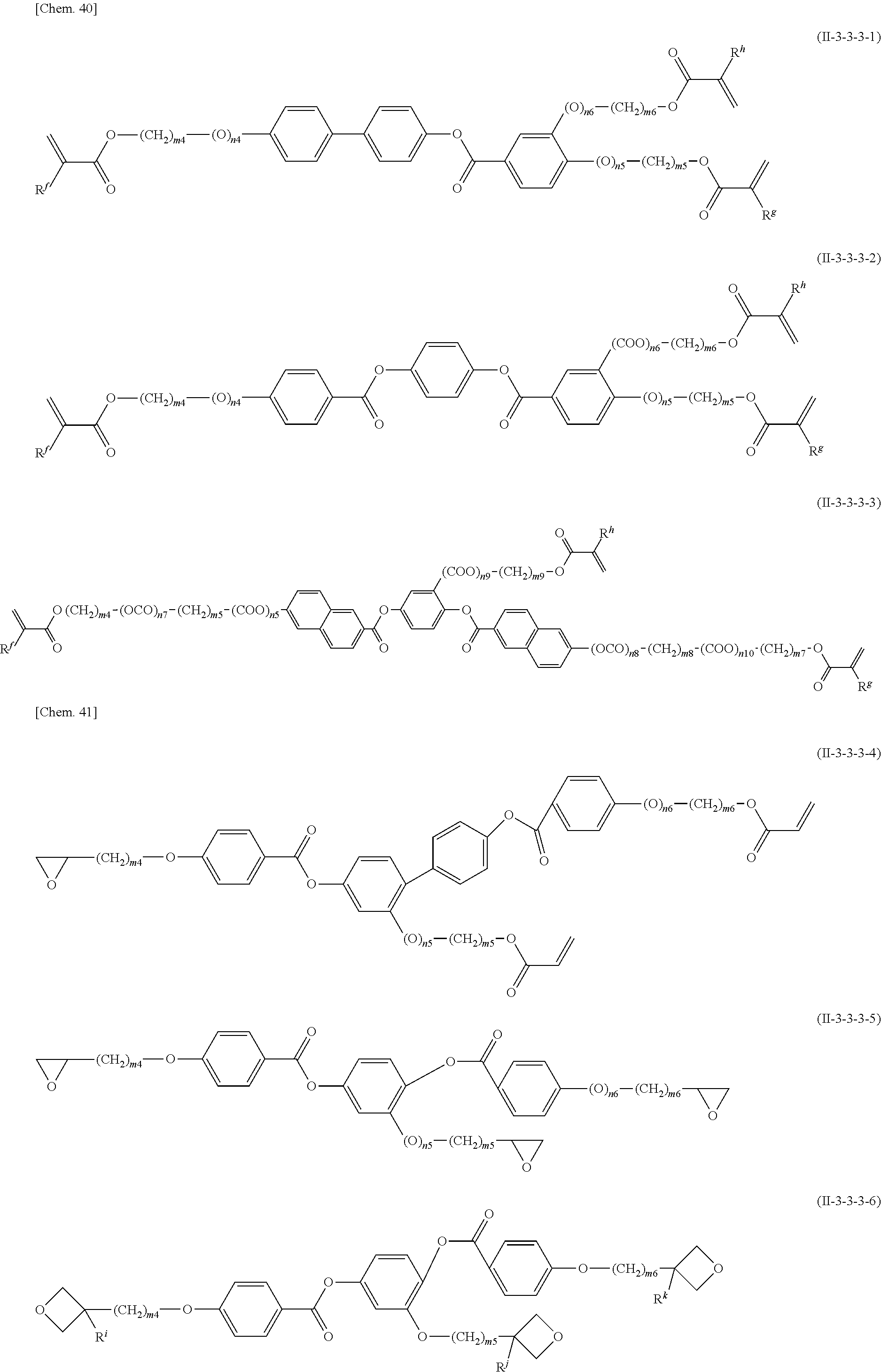

In the formulas, R^{f}, R^{g}, and R^{h} each independently represent a hydrogen atom or a methyl group; Rⁱ, R^{j}, and R^{k} each independently represent a hydrogen atom, a halogen atom, an alkyl group having 1 to 6 carbon atoms, an alkoxy group having 1 to 6 carbon atoms, or a cyano group; when these groups are alkyl groups having 1 to 6 carbon atoms or alkoxy groups having 1 to 6 carbon atoms, the groups may all be unsubstituted, or may be substituted with one or two or more halogen atoms; the cyclic groups may have, as a substituent, at least one F, Cl, CF₃, OCF₃, CN group, alkyl group having 1 to 8 carbon atoms, alkoxy group having 1 to 8 carbon atoms, alkanoyl group having 1 to 8 carbon atoms, alkanoyloxy group having 1 to 8 carbon atoms, alkoxycarbonyl group having 1 to 8 carbon atoms, alkenyl group having 2 to 8 carbon atoms, alkenyloxy group having 2 to 8 carbon atoms, alkenoyl group having 2 to 8 carbon atoms, or alkenoyloxy group having 2 to 8 carbon atoms.

m4 to m9 each independently represent an integer of 0 to 18; n4 to n9 each independently represent 0 or 1.

As a polyfunctional polymerizable liquid crystal compound having three or more polymerizable functional groups, one species or two or more species may be used.

The total content of the polyfunctional polymerizable liquid crystal compound intramolecularly having three or more polymerizable functional groups relative to the total amount of polymerizable liquid crystal compound used for the polarized-luminescent-film-formable polymerizable composition, is preferably 0 to 80 mass %, more preferably 0 to 60 mass %, particularly preferably 0 to 40 mass %. When the rigidity of the film to be obtained is a priority, the lower limit is preferably set to 10 mass % or more, more preferably set to 20 mass % or more, particularly preferably set to 30 mass % or more. On the other hand, when low shrinkage during curing in the film to be obtained is a priority, the upper limit is preferably set to 50 mass % or less, more preferably set to 35 mass % or less, particularly preferably set to 20 mass % or less.

(Combined Use of Plurality of Polymerizable Liquid Crystal Compounds)

In the polarized-luminescent-film-formable polymerizable composition according to the present invention, a plurality of species of the polymerizable liquid crystal compounds are preferably used in combination. Preferred is a combined use of the at least one monofunctional polymerizable liquid crystal compound, and at least one bifunctional polymerizable liquid crystal compound and/or polyfunctional polymerizable liquid crystal compound because this provides improved curability of the film to be obtained; more preferred is a combined use of at least one monofunctional polymerizable liquid crystal compound, and at least one bifunctional polymerizable liquid crystal compound. In particular, when a polarized-luminescent-film-formable polymerizable composition according to the present invention is used in order to form a film having further improved curability, as a bifunctional polymerizable liquid crystal compound, a compound is preferably selected from (II-2-2) to (II-2-4) above that have three or more ring structures to prepare a mixture of polymerizable liquid crystal compounds.

The total amount of the monofunctional polymerizable liquid crystal compound and the bifunctional polymerizable liquid crystal compound relative to the total amount of the polymerizable liquid crystal compounds used for the polarized-luminescent-film-formable polymerizable composition, is preferably 70 mass % to 100 mass %, particularly preferably 80 mass % to 100 mass %.

(Another Liquid Crystal Compound)

To a polarized-luminescent-film-formable polymerizable composition according to the present invention, a compound not having polymerizable groups but containing a mesogenic group may be added. Examples of the compound include compounds used for ordinary liquid crystal devices, such as STN (super twisted nematic) liquid crystal, TN (twisted nematic) liquid crystal, or TFT (thin-film transistor) liquid crystal.

Specifically, preferred examples of the compound not having polymerizable functional groups but containing a mesogenic group include a compound represented by the following general formula (5).

[Chem. 42]

R⁵¹-MG3-R⁵² (5)

A mesogenic group or mesogenic support group represented by MG3 may be a compound represented by a general formula (5-b),

[Chem. 43]

—Z0^{d}-(A1^{d}—Z1^{d})ₙₑ-A2^{d}—Z2^{d}-A3^{d}—Z3^{d}— (5-b)

(where A1^{d}, A2^{d}, and A3^{d} each independently represent a 1,4-phenylene group, a 1,4-cyclohexylene group, a 1,4-cyclohexenyl group, a tetrahydropyran-2,5-diyl group, a 1,3-dioxane-2,5-diyl group, a tetrahydrothiopyran-2,5-diyl group, a 1,4-bicyclo(2,2,2)octylene group, a decahydronaphthalene-2,6-diyl group, a pyridine-2,5-diyl group, a pyrimidine-2,5-diyl group, a pyrazine-2,5-diyl group, a thiophene-2,5-diyl group-, a 1,2,3,4-tetrahydronaphthalene-2,6-diyl group, a 2,6-naphthylene group, a phenanthrene-2,7-diyl group, a 9,10-dihydrophenanthrene-2,7-diyl group, a 1,2,3,4,4a,9,10a-octahydrophenanthrene-2,7-diyl group, a 1,4-naphthylene group, a benzo[1,2-b:4,5-b′]dithiophene-2,6-diyl group, a benzo[1,2-b:4,5-b′]diselenophene-2,6-diyl group, a [1]benzothieno[3,2-b]thiophene-2,7-diyl group, a [1]benzoselenopheno[3,2-b]selenophene-2,7-diyl group, or a fluorene-2,7-diyl group; and may have, as a substituent, at least one F, Cl, CF₃, OCF₃, CN group, C₁₋₈ alkyl group, alkoxy group, alkanoyl group, or alkanoyloxy group, or C₂₋₈ alkenyl group, alkenyloxy group, alkenoyl group, or alkenoyloxy group,

Z0^{d}, Z1^{d}, Z2^{d}, and Z3^{d} each independently represent —COO—, —OCO—, —CH₂CH₂—, —OCH₂—, —CH₂O—, —CH═CH—, —C≡C—, —CH═CHCOO—, —OCOCH═CH—, —CH₂CH₂COO—, —CH₂CH₂OCO—, —COOCH₂CH₂—, —OCOCH₂CH₂—, —CONH—, —NHCO—, an alkylene group that has 2 to 10 carbon atoms and that may have a halogen atom, or a single bond,

n^{e} represents 0, 1, or 2,

R⁵¹ and R⁵² each independently represent a hydrogen atom, a halogen atom, a cyano group, or an alkyl group having 1 to 18 carbon atoms; the alkyl group may be substituted with at least one halogen atom or CN; in the group, a single CH₂ group or two or more non-adjacent CH₂ groups may each be independently substituted with —O—, —S—, —NH—, —N(CH₃)—, —CO—, —COO—, —COO—, —OCOO—, —SCO—, —COS—, or —C≡C— as long as oxygen atoms are not directly bonded to each other).

Specific examples are as follows, but are not limited to these.

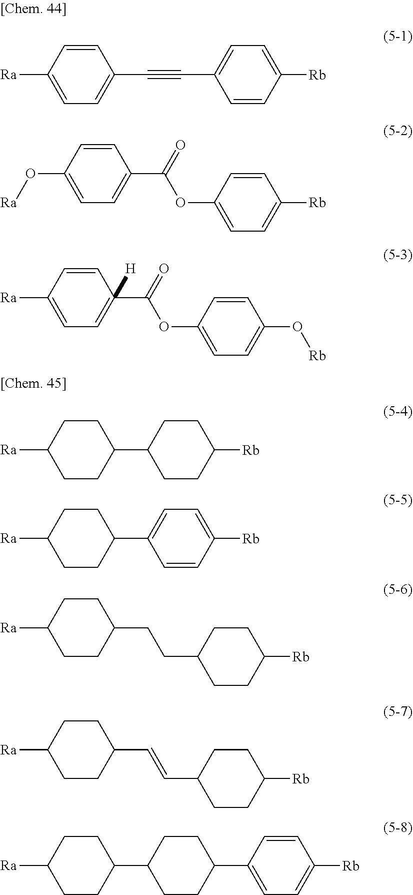

Ra and Rb each independently represent a hydrogen atom, an alkyl group having 1 to 6 carbon atoms, an alkoxy group having 1 to 6 carbon atoms, an alkenyl group having 1 to 6 carbon atoms, or a cyano group; when these groups are alkyl groups having 1 to 6 carbon atoms or alkoxy groups having 1 to 6 carbon atoms, the groups may all be unsubstituted, or may be substituted with one or two or more halogen atoms.

The total content of the compound having a mesogenic group relative to 100 parts by mass of the total content of the polymerizable liquid crystal compound used for the polarized-luminescent-film-formable polymerizable composition is preferably 0 parts by mass or more and 20 parts by mass or less, when used, preferably 1 part by mass or more, preferably 2 parts by mass or more, preferably 5 parts by mass or more, preferably 15 parts by mass or less, preferably 10 parts by mass or less.

(Luminescent Nanocrystals)

Luminescent nanocrystals according to the present invention may include luminescent nanocrystals and, as needed, a surface-modifying compound (ligand) modifying the surfaces of the luminescent nanocrystals. In this Specification, the term “nanocrystals” means particles preferably having at least one length of 100 nm or less. The rod-like luminescent nanocrystals according to the present invention preferably have a short-axis length and a long-axis length that are both 100 nm or less. The shape of the nanocrystals may be any geometric shape, and may be symmetric or asymmetric. Specific examples of the shape of the nanocrystals include elongated shapes, rod-like shapes, circular shapes (spherical shapes), elliptical shapes, pyramidal shapes, disc-like shapes, dendritic shapes, network shapes, and any irregular shapes. In rod-like luminescent nanocrystals according to the present invention, the short-axis average length and the long-axis average length of the luminescent nanocrystals are preferably different from each other, and the nanocrystals are preferably quantum rods.

The luminescent nanocrystals preferably have a core including at least one first semiconductor material, and a shell covering the core, and including a second semiconductor material that is the same as in or different from the core.

Thus, such a luminescent nanocrystal is constituted by at least the core including the first semiconductor material, and the shell including the second semiconductor material; the first semiconductor material and the second semiconductor material may be the same or different. The core and/or the shell may include, in addition to the first semiconductor and/or the second semiconductor, a third semiconductor material. The phrase “covering the core” means covering at least a portion of the core.

The luminescent nanocrystal preferably has a core including at least one first semiconductor material, a first shell covering the core and including the second semiconductor material that is the same as in or different from the core, and, as needed, a second shell covering the first shell and including a third semiconductor material that is the same as in or different from the first shell.

Thus, luminescent nanocrystals according to the present invention preferably have at least one of three structures: a structure having a core including the first semiconductor material and a shell covering the core and including the second semiconductor material that is the same as in the core, in other words, a structure constituted by one or two or more semiconductor materials (that is, a structure constituted by a core alone (also referred to as the core structure)); for example, a structure having a core including the first semiconductor material, and a shell covering the core and including the second semiconductor material different from the core, namely, a core/shell structure; and a structure having a core including the first semiconductor material, the first shell covering the core and including the second semiconductor material different from the core, and the second shell covering the first shell and including the third semiconductor material different from the first shell, namely a core/shell/shell structure.

As described above, luminescent nanocrystals according to the present invention preferably include the three structures: the core structure, the core/shell structure, and the core/shell/shell structure; in this case, the cores may be formed of mixed crystals including two or more semiconductor materials (for example, CdSe+CdS, or CIS+ZnS). Similarly, the shells may be formed of mixed crystals including two or more semiconductor materials.

In luminescent nanocrystals according to the present invention, molecules having affinity for the luminescent nanocrystals may be in contact with the luminescent nanocrystals.

These molecules having affinity are low-molecular-weight compounds and high-molecular-weight compounds having functional groups having affinity for the luminescent nanocrystals. The functional groups having affinity are not particularly limited, but are preferably groups including at least one element selected from the group consisting of nitrogen, oxygen, sulfur, and phosphorus. Examples include organic sulfur groups, organic phosphoric acid groups, pyrrolidone groups, pyridine groups, amino groups, amide groups, isocyanate groups, carbonyl groups, and hydroxy groups.

A semiconductor material according to the present invention is preferably one or two or more selected from the group consisting of group II-VI semiconductors, group III-V semiconductors, group semiconductors, group IV semiconductors, and group I-II-IV-VI semiconductors. Preferred examples of the first semiconductor material, the first semiconductor material, and the third semiconductor material are the same as the above-described semiconductor materials.

Specifically, a semiconductor material according to the present invention may be at least one selected from the group consisting of CdS, CdSe, CdTe, ZnS, ZnSe, ZnTe, ZnO, HgS, HgSe, HgTe, CdSeS, CdSeTe, CdSTe, ZnSeS, ZnSeTe, ZnSTe, HgSeS, HgSeTe, HgSTe, CdZnS, CdZnSe, CdZnSe, CdHgS, CdHgSe, CdHgSe, HgZnS, HgZnSe, CdHgZnTe, CdZnSeS, CdZnSeTe, CdZnSTe, CdHgSeS, CdHgSeTe, CdHgSTe, HgZnSeS, HgZnSeTe, HgZnSTe; GaN, GaP, GaAs, GaSb, AlN, Alp, AlAs, AlSb, InN, InP, InAs, InSb, GaNP, GaNAs, GaNSb, GaPAs, GaPSb, AlNP, AlNAs, AlNSb, AlPAs, AlPSb, InNP, InNAs, InNSb, InPAs, InPSb, GaAlNP, GaAlNAs, GaAlNSb, GaAlPAs, GaAlPSb, GaInNP, GaInNAs, GaInNSb, GaInPAs, GaInPSb, InAlNP, InAlNAs, InAlNSb, InAlPAs, InAlPSb; SnS, SnSe, SnTe, PbS, PbSe, PbTe, SnSeS, SnSeTe, SnSTe, PbSeS, PbSeTe, PbSTe, SnPbS, SnPbSe, SnPbSe, SnPbSSe, SnPbSeTe, SnPbSTe; Si, Ge, SiC, SiGe, AgInSe2, CuGaSe2, CuInS2, CuGaS2, CuInSe2, AgInS2, AgGaSe2, AgGaS2, C, Si, and Ge, and these compound semiconductors may be used alone or in combination of two or more thereof; more preferred is at least one selected from the group consisting of CdS, CdSe, CdTe, ZnS, ZnSe, ZnTe, ZnO, HgS, HgSe, HgTe, InP, InAs, InSb, GaP, GaAs, GaSb, AgInS₂, AgInSe₂, AgInTe₂, AgGaS₂, AgGaSe₂, AgGaTe₂, CuInS₂, CuInSe₂, CuInTe₂, CuGaS₂, CuGaSe₂, CuGaTe₂, Si, C, Ge, and Cu₂ZnSnS₄, and these compound semiconductors may be used alone or in combination of two or more thereof.

Luminescent nanocrystals according to the present invention preferably include at least one nanocrystal species selected from the group consisting of red luminescent nanocrystals that emit red light, green luminescent nanocrystals that emit green light, blue luminescent nanocrystals that emit blue light, and yellow luminescent nanocrystals that emit yellow light. In general, the color of light emitted from luminescent nanocrystals depends on particle size according to a solution of a potential well model Schrödinger wave equation, and also depends on the energy gap of the luminescent nanocrystals. Thus, luminescent nanocrystals to be used and their particle size are changed to thereby select the color of light to be emitted.

In the present invention, red luminescent nanocrystals that emit red light provide a fluorescent spectrum in which the upper limit of the wavelength peak is preferably 665 nm, 663 nm, 660 nm, 658 nm, 655 nm, 653 nm, 651 nm, 650 nm, 647 nm, 645 nm, 643 nm, 640 nm, 637 nm, 635 nm, 632 nm, or 630 nm, and the lower limit of the wavelength peak is preferably 628 nm, 625 nm, 623 nm, 620 nm, 615 nm, 610 nm, 607 nm, or 605 nm.

In the present invention, green luminescent nanocrystals that emit green light provide a fluorescent spectrum in which the upper limit of the wavelength peak is preferably 560 nm, 557 nm, 555 nm, 550 nm, 547 nm, 545 nm, 543 nm, 540 nm, 537 nm, 535 nm, 532 nm, or 530 nm, and the lower limit of the wavelength peak is preferably 528 nm, 525 nm, 523 nm, 520 nm, 515 nm, 510 nm, 507 nm, 505 nm, 503 nm, or 500 nm.

In the present invention, blue luminescent nanocrystals that emit blue light provide a fluorescent spectrum in which the upper limit of the wavelength peak is preferably 480 nm, 477 nm, 475 nm, 470 nm, 467 nm, 465 nm, 463 nm, 460 nm, 457 nm, 455 nm, 452 nm, or 450 nm, and the lower limit of the wavelength peak is preferably 450 nm, 445 nm, 440 nm, 435 nm, 430 nm, 428 nm, 425 nm, 422 nm, or 420 nm.

In the present invention, a semiconductor material used for red luminescent nanocrystals that emit red light desirably has a luminescence peak wavelength within a range of 635 nm±30 nm. Similarly, a semiconductor material used for green luminescent nanocrystals that emit green light desirably has a luminescence peak wavelength within a range of 530 nm±30 nm; and a semiconductor material used for blue luminescent nanocrystals that emit blue light desirably has a luminescence peak wavelength within a range of 450 nm±30 nm.

In luminescent nanocrystals according to the present invention, the lower limit of the fluorescence quantum yield is preferably, in sequence, 40% or more, 30% or more, 20% or more, or 10% or more.

In the fluorescent spectrum of luminescent nanocrystals according to the present invention, the upper limit of the half width is preferably, in sequence, 60 nm or less, 55 nm or less, 50 nm or less, or 45 nm or less.

In red luminescent nanocrystals according to the present invention, the upper limit of particle size (primary particles) is preferably, in sequence, 50 nm or less, 40 nm or less, 30 nm or less, or 20 nm or less.

In red luminescent nanocrystals according to the present invention, the upper limit of the peak wavelength is 665 nm and the lower limit is 605 nm; a compound and its particle size are selected so as to provide the peak wavelength. Similarly, in green luminescent nanocrystals, the upper limit of the peak wavelength is 560 nm and the lower limit is 500 nm; in blue luminescent nanocrystals, the upper limit of the peak wavelength is 420 nm and the lower limit is 480 nm; compounds and their particle sizes are selected so as to provide the peak wavelengths.

A liquid crystal display device according to the present invention includes at least one pixel. The colors constituting this pixel are obtained by adjacent three pixels, and the pixels individually include nanocrystals that emit red light (such as CdSe luminescent nanocrystals, CdSe rod-like luminescent nanocrystals, rod-like luminescent nanocrystals having a core/shell structure in which the shell portion is formed of CdS and the inner core portion is formed of CdSe, rod-like luminescent nanocrystals having a core/shell structure in which the shell portion is formed of CdS and the inner core portion is formed of ZnSe, luminescent nanocrystals having a core/shell structure in which the shell portion is formed of CdS and the inner core portion is formed of CdSe, luminescent nanocrystals having a core/shell structure in which the shell portion is formed of CdS and the inner core portion is formed of ZnSe, luminescent nanocrystals of mixed crystals of CdSe and ZnS, rod-like luminescent nanocrystals of mixed crystals of CdSe and ZnS, InP luminescent nanocrystals, InP luminescent nanocrystals, InP rod-like luminescent nanocrystals, luminescent nanocrystals of mixed crystals of CdSe and CdS, rod-like luminescent nanocrystals of mixed crystals of CdSe and CdS, luminescent nanocrystals of mixed crystals of ZnSe and CdS, or rod-like luminescent nanocrystals of mixed crystals of ZnSe and CdS), other nanocrystals that emit green light (CdSe luminescent nanocrystals, CdSe rod-like luminescent nanocrystals, luminescent nanocrystals of mixed crystals of CdSe and ZnS, or rod-like luminescent nanocrystals of mixed crystals of CdSe and ZnS), and other nanocrystals that emit blue light (ZnSe luminescent nanocrystals, ZnSe rod-like luminescent nanocrystals, ZnS luminescent nanocrystals, ZnS rod-like luminescent nanocrystals, luminescent nanocrystals having a core/shell structure in which the shell portion is formed of ZnSe and the inner core portion is formed of ZnS, rod-like luminescent nanocrystals having a core/shell structure in which the shell portion is formed of ZnSe and the inner core portion is formed of ZnS, CdS luminescent nanocrystals, or CdS rod-like luminescent nanocrystals). Another color (such as luminescent nanocrystals that emit yellow light) may also be employed.

When luminescent nanocrystals according to the present invention are, what is called, rod-like, such rods preferably have a long-axis-direction length (average length) of 15 to 120 nm, preferably 20 to 80 nm, more preferably 25 to 70 nm.

When the rod-like luminescent nanocrystals have a long-axis-direction length of 20 nm or more, the rod-like luminescent nanocrystals have anisotropy and hence effectively provide polarized luminescence characteristics. When the long-axis-direction length is 120 nm or less, the orderly dispersibility of the surface-modifying compound is probably not degraded.

The rod-like luminescent nanocrystals preferably have a short-axis-direction length (average length) of 1 to 11 nm, more preferably 2 to 8 nm, still more preferably 3 to 7 nm.

Rod-like luminescent nanocrystals according to the present invention have an elongated shape that extends in a specific direction. Examples of the shape include cylindrical shapes, polygonal columnar shapes, polygonal pyramidal shapes, and conical shapes.

Rod-like luminescent nanocrystals according to the present invention preferably have an aspect ratio (long-axis-direction average length of rod-like luminescent nanocrystals/short-axis-direction average length of rod-like luminescent nanocrystals) of 3 to 30, more preferably 4 to 20, still more preferably 5 to 10.

The material constituting the rod-like luminescent nanocrystals is not particularly limited, and the above-described materials for luminescent nanocrystals can be suitably used.

In this Specification, the average particle size (primary particles) of luminescent nanocrystals can be measured by TEM observation. In general, examples of the methods of measuring the average particle size of nanocrystals include a light scattering method, a sedimentation particle size measurement method using a solvent, and a method of directly observing particles with an electron microscope and actually measuring average particle size. Since luminescent nanocrystals tend to deteriorate due to, for example, water, in the present invention, preferred is a method in which randomly selected plural crystals are directly observed with a transmission electron microscope (TEM) or a scanning electron microscope (SEM), particle sizes are calculated from ratios of long diameter and short diameter in a projected two-dimensional image, and the particle sizes are averaged. For this reason, in the present invention, this method is used to calculate average particle size. Primary particles of luminescent nanocrystals are constituent single crystals having sizes of several nanometers to several tens of nanometers or constituent crystallites close to these single crystals. The size and shape of primary particles of luminescent nanocrystals probably depend on, for example, the chemical composition, structure, production method, or production conditions of the primary particles.

Incidentally, in this Specification, in the method of measuring the length of the long-axis and the length of the short-axis of a rod-like luminescent nanocrystal, during the TEM observation, the longest line segment among the line segments crossing the rod-like luminescent nanocrystal, while the short-axis is the shortest line segment among the line segments being orthogonal to the long-axis and crossing the rod-like luminescent nanocrystal. Thus, the length of the long-axis of a rod-like luminescent nanocrystal is preferably the long-axis-direction average length of rod-like luminescent nanocrystals, and the length of the short-axis of a rod-like luminescent nanocrystal is preferably the short-axis-direction average length of the rod-like luminescent nanocrystals.

A polarized luminescent multilayered body according to the present invention preferably includes a polarized luminescent film, and a gas barrier layer. This enables a reduction in deterioration of luminescent nanocrystals, for example.

(Gas Barrier Layer)

Such a gas barrier layer in the present invention is preferably a film in which, on at least one of surfaces of a polymer film, at least one multilayered film constituted by an organic layer and an inorganic layer is disposed in the order of the film, the organic layer, and the inorganic layer. In addition, on the inorganic layer, an alignment layer that aligns the polarized-luminescent-film-formable polymerizable composition may be disposed.

(Organic Layer)

Such an organic layer in the present invention is not particularly limited as long as it has surface smoothness. The organic layer is obtained by, for example, preparing a composition including a curable compound having a polymerizable group, applying the composition, and then irradiating the applied composition with an active energy ray. The polymerizable group is not particularly limited, but is preferably a (meth)acrylate group, a vinyl group, or an epoxy group, more preferably a (meth)acrylate group, still more preferably an acrylate group. In a polymerizable monomer having two or more polymerizable groups, the polymerizable groups may be the same or different.

From the viewpoint of postcuring transparency, adhesion, and mechanical strength of the cured film, preferred examples include (meth)acrylate compounds such as monofunctional, bifunctional, or tri- or higher functional (meth)acrylate monomers, and polymers and prepolymers of the monomers; more preferred are bifunctional or tri- or higher functional (meth)acrylate compounds.

Specific examples of the bifunctional (meth)acrylate compounds include neopentyl glycol di(meth)acrylate, 1,9-nonanediol di(meth)acrylate, dipropylene glycol di(meth)acrylate, tripropylene glycol di(meth)acrylate, tetraethylene glycol di(meth)acrylate, neopentyl glycol hydroxypivalate di(meth)acrylate, polyethylene glycol di(meth)acrylate, and dicyclopentanyl di(meth)acrylate.

Specific examples of the tri- or higher functional (meth)acrylate compounds include ECH-modified glycerol tri(meth)acrylate, EO-modified glycerol tri(meth)acrylate, PO-modified glycerol tri(meth)acrylate, pentaerythritol triacrylate, pentaerythritol tetraacrylate, EO-modified phosphate triacrylate, trimethylolpropane tri(meth)acrylate, caprolactone-modified trimethylolpropane tri(meth)acrylate, EO-modified trimethylolpropane tri(meth)acrylate, PO-modified trimethylolpropane tri(meth)acrylate, tris(acryloxyethyl) isocyanurate, dipentaerythritol hexa(meth)acrylate, dipentaerythritol penta(meth)acrylate, caprolactone-modified dipentaerythritol hexa(meth)acrylate, dipentaerythritolhydroxy penta(meth)acrylate, alkyl-modified dipentaerythritol penta(meth)acrylate, dipentaerythritol poly(meth)acrylate, alkyl-modified dipentaerythritol tri(meth)acrylate, ditrimethylolpropane tetra(meth)acrylate, pentaerythritolethoxy tetra(meth)acrylate, and pentaerythritol tetra(meth)acrylate.

Of these, particularly preferred for the present invention are EO-modified glycerol tri(meth)acrylate, PO-modified glycerol tri(meth)acrylate, trimethylolpropane tri(meth)acrylate, EO-modified trimethylolpropane tri(meth)acrylate, PO-modified trimethylolpropane tri(meth)acrylate, dipentaerythritol hexa(meth)acrylate, dipentaerythritol penta(meth)acrylate, pentaerythritolethoxy tetra(meth)acrylate, and pentaerythritol tetra(meth)acrylate.

The amount of tri- or higher functional (meth)acrylate monomer used relative to 100 parts by mass of the total amount of the curable compound included in the organic layer coating solution is preferably 5 parts by mass or more from the viewpoint of the coating film strength of the cured optical functional layer, and is preferably 95 parts by mass or less from the viewpoint of suppression of gelation of the coating solution.

(Inorganic Layer)

In the present invention, in order to provide a gas barrier function, an inorganic layer is formed on a substrate used for a polarized luminescent film. The inorganic layer is preferably formed of an oxide, nitride, or oxynitride of at least one metal selected from the group consisting of Al, Si, Zn, Sn, Ti, Cr, Ni, and In. More preferably, the inorganic layer is formed of an oxide or double oxide of Al, Si, Zn, Sn, Ti, Cr, Ni, and In. The inorganic layer may be formed on only one of the surfaces of the substrate, or both of the surfaces of the substrate.

The Si content of the double oxide is not particularly limited, but is preferably 20 parts by mass to 80 parts by mass, more preferably 30 parts by mass to 70 parts by mass. When the Si content is within such a range, a barrier film having higher transparency and a good gas barrier function can be provided.

In the double oxide, the weight ratio of Zn to the total amount of Zn and Sn (Zn/Zn+Sn) is preferably 0.3 to 0.99, more preferably 0.5 to 0.9. When the weight ratio is within such a range, a further improved gas barrier function can be provided.

The film thickness of the inorganic layer is not particularly limited, but is preferably 30 nm to 3000 nm, more preferably 50 nm to 1000 nm. When the film thickness is within such a range, a further improved gas barrier function can be provided.

The refractive index of the inorganic layer is not particularly limited, but is desirably 1.9 or less, more desirably 1.8 or less. Since polyethylene naphthalate and polyethylene terephthalate used for substrates have refractive indexes of about 1.6 to about 1.75, when the inorganic layer is formed to have a refractive index of 1.9 or less, reflection of light at the interface between the substrate and the inorganic layer can be further suppressed. In other words, the transparency of the barrier layer is further improved.

(Alignment Material)

In a polarized-luminescent-film-formable polymerizable composition according to the present invention, an alignment material formed on a substrate causes alignment of a polymerizable liquid crystal composition in the polarized-luminescent-film-formable polymerizable composition, to thereby achieve alignment of rod-like luminescent nanocrystals.

The alignment material to be used can be selected from publicly known and commonly used materials as long as it achieves alignment of a polarized-luminescent-film-formable polymerizable composition according to the present invention.

Specific examples of the alignment material include photoisomerization or photodimerization compounds such as polyimide, polyamide, BCB (benzocyclobutene polymer), polyvinyl alcohol, polycarbonate, polystyrene, polyphenylene ether, polyarylate, polyethylene terephthalate, polyethersulfone, epoxy resins, epoxy acrylate resins, acrylic resins, coumarin compounds, chalcone compounds, cinnamate compounds, fulgide compounds, anthraquinone compounds, azo compounds, and arylethene compounds; preferred are materials that are aligned by irradiation with ultraviolet light or irradiation with visible light (photoalignment materials).

Examples of the photoalignment materials include polyimide having a cyclic cycloalkane, fully aromatic polyarylate, polyvinyl cinnamate and polyvinyl ester of para-methoxy cinnamic acid described in Japanese Unexamined Patent Application Publication No. 5-232473, cinnamate derivatives described in Japanese Unexamined Patent Application Publication Nos. 6-287453 and 6-289374, and maleimide derivatives described in Japanese Unexamined Patent Application Publication No. 2002-265541. Specifically, preferred are compounds represented by the following formula (12-1) to formula (12-7).

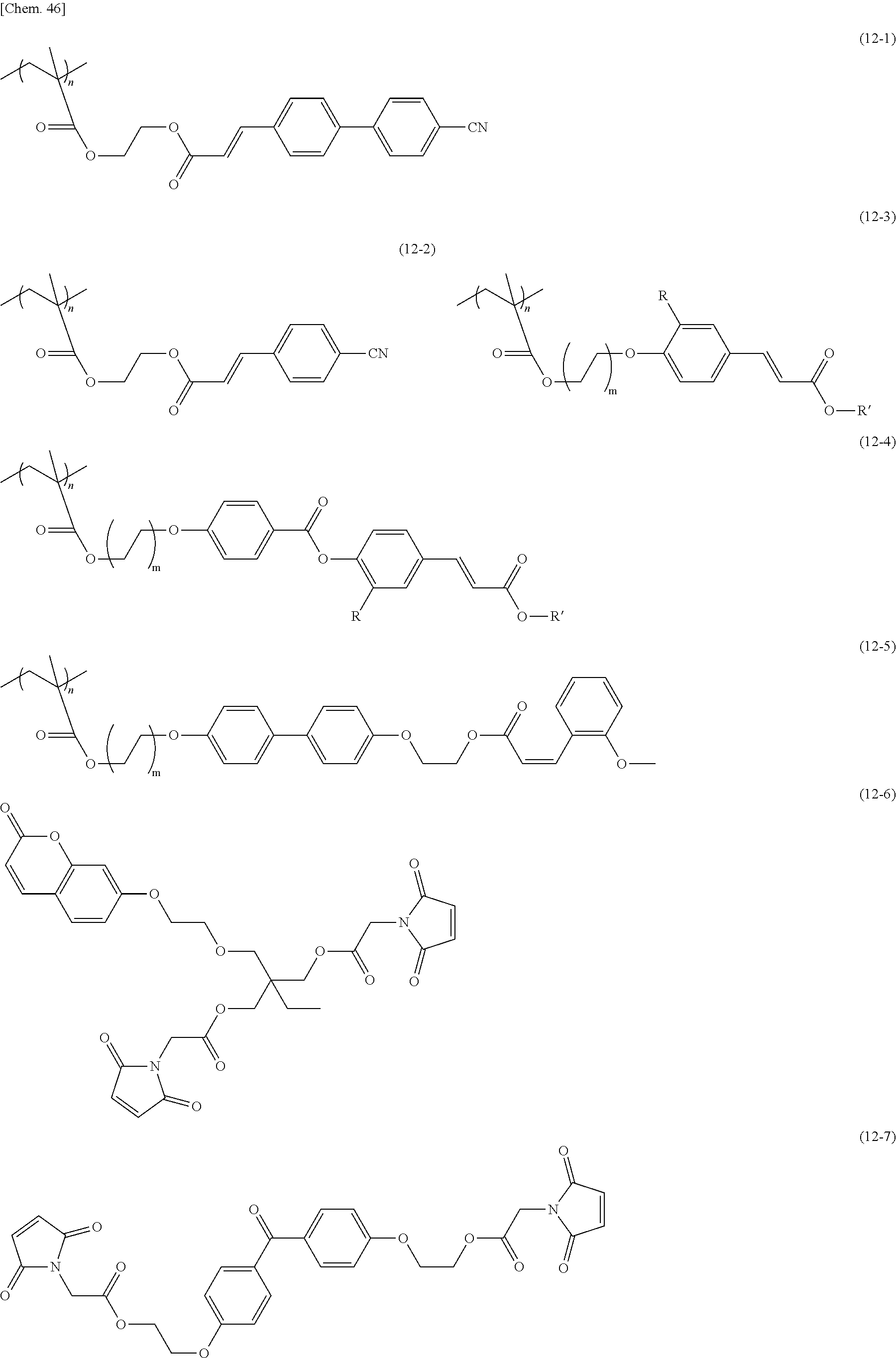

(In the formulas, R represents a hydrogen atom, a halogen atom, an alkyl group having 1 to 3 carbon atoms, an alkoxy group, or a nitro group; R′ represents a hydrogen atom or an alkyl group having 1 to 10 carbon atoms; the alkyl group may be linear or branched; in the alkyl group, any hydrogen atom may be substituted with a fluorine atom; in the alkyl group, a single —CH₂— or two or more non-adjacent —CH₂— may each be independently substituted with —O—, —S—, —CO—, —COO—, —COO—, —CO—S—, —S—CO—, —O—CO—O—, —CO—NH—, —NH—CO—, or —C≡C—, and the end CH₃ may be substituted with CF₃, CCl₃, a cyano group, a nitro group, an isocyano group, or a thioisocyano group. n represents 4 to 100000, m represents an integer of 1 to 10).

A polarized-luminescent-film-formable polymerizable composition according to the present invention preferably includes a polymerizable liquid crystal compound and rod-like luminescent nanocrystals, and may include, as needed, additives such as a chiral compound, an organic solvent, a polymerization inhibitor, a polymerization initiator, an antioxidant, or a sensitizer described below.

(Chiral Compound)

A polarized-luminescent-film-formable polymerizable composition according to the present invention may contain, in addition to the polymerizable compound represented by the general formula (II), a polymerizable chiral compound that may or may not exhibit liquid crystallinity.

The polymerizable chiral compound used in the present invention preferably has at least one polymerizable functional group. Examples of such compounds include: as described in, Japanese Unexamined Patent Application Publication Nos. 11-193287 and 2001-158788, Japanese Unexamined Patent Application Publication (Translation of PCT Application) No. 2006-52669, Japanese Unexamined Patent Application Publication Nos. 2007-269639, 2007-269640, and 2009-84178, polymerizable chiral compounds that contain a chiral saccharide such as isosorbide, isomannite, or glucosid, and that has a rigid region of a 1,4-phenylene group or a 1,4-cyclohexylene group, and a polymerizable functional group such as a vinyl group, an acryloyl group, a (meth)acryloyl group, or a maleimide group; as described in Japanese Unexamined Patent Application Publication No. 8-239666, polymerizable chiral compounds composed of terpenoid derivatives; as described in, for example, NATURE VOL35 pages 467 to 469 (published Nov. 30, 1995) and NATURE VOL392 pages 476 to 479 (published Apr. 2, 1998), polymerizable chiral compounds composed of a mesogenic group and a spacer having a chiral region; and, as described in Japanese Unexamined Patent Application Publication (Translation of PCT Application) No. 2004-504285 and Japanese Unexamined Patent Application Publication No. 2007-248945, polymerizable chiral compounds including a binaphthyl group. In particular, chiral compounds having high helical twisting power (HTP) are preferred for a sealing material composition for a display device according to the present invention.

The amount of such a polymerizable chiral compound added needs to be appropriately adjusted in accordance with the helical twisting power of the compound; however, the content relative to the polymerizable liquid crystal composition is preferably 0 to 25 mass %, more preferably 0 to 20 mass %, particularly preferably 0 to 15 mass %.

Examples of the general formula of the polymerizable chiral compound include general formulas (3-1) to (3-4), but are not limited to the following general formulas.

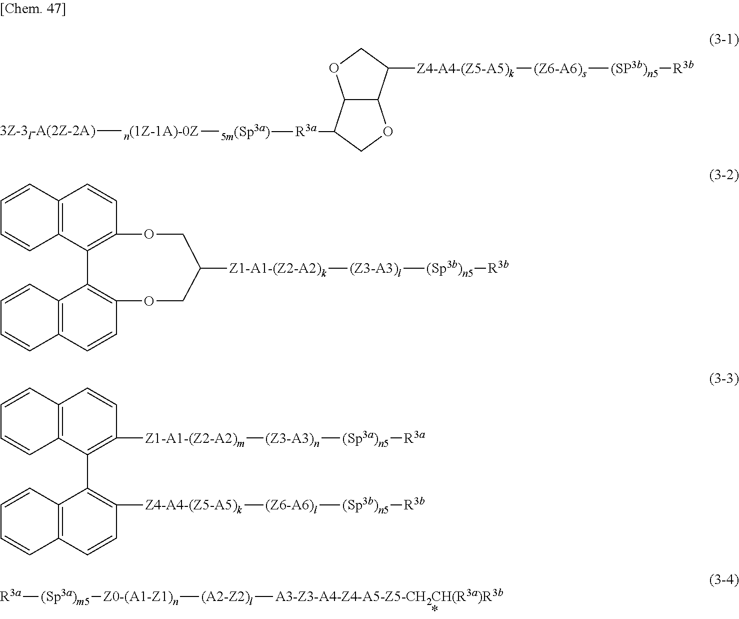

In the formulas, Sp^{3a} and Sp^{3b} each independently represent an alkylene group having 0 to 18 carbon atoms; the alkylene group may be substituted with at least one halogen atom, CN group, or alkyl group having 1 to 8 carbon atoms and a polymerizable functional group; in the group, a single CH₂ group or two or more non-adjacent CH₂ groups may each be independently substituted with, as long as oxygen atoms are not directly bonded to each other, —O—, —S—, —NH—, —N(CH₃)—, —CO—, —COO—, —COO—, —OCOO—, —SCO—, —COS—, or —C≡C—,

A1, A2, A3, A4, and A5 each independently represent a 1,4-phenylene group, a 1,4-cyclohexylene group, a 1,4-cyclohexenyl group, a tetrahydropyran-2,5-diyl group, a 1,3-dioxane-2,5-diyl group, a tetrahydrothiopyran-2,5-diyl group, a 1,4-bicyclo(2,2,2)octylene group, a decahydronaphthalene-2,6-diyl group, a pyridine-2,5-diyl group, a pyrimidine-2,5-diyl group, a pyrazine-2,5-diyl group, a thiophene-2,5-diyl group-, a 1,2,3,4-tetrahydronaphthalene-2,6-diyl group, a 2,6-naphthylene group, a phenanthrene-2,7-diyl group, a 9,10-dihydrophenanthrene-2,7-diyl group, a 1,2,3,4,4a,9,10a-octahydrophenanthrene-2,7-diyl group, a 1,4-naphthylene group, a benzo[1,2-b:4,5-b′]dithiophene-2,6-diyl group, a benzo[1,2-b:4,5-b′]diselenophene-2,6-diyl group, a [1]benzothieno[3,2-b]thiophene-2,7-diyl group, a [1]benzoselenopheno[3,2-b]selenophene-2,7-diyl group, or a fluorene-2,7-diyl group; n, 1, and k each independently represent 0 or 1 and satisfy 0≤n+1+k≤3,

Z0, Z1, Z2, Z3, Z4, Z5, and Z6 each independently represent —COO—, —COO—, —CH₂CH₂—, —OCH₂—, —CH₂O—, —CH═CH—, —C≡C—, —CH═CHCOO—, —OCOCH═CH—, —CH₂CH₂COO—, —CH₂CH₂OCO—, —COOCH₂CH₂—, —OCOCH₂CH₂—, —CONH—, —NHCO—, an alkyl group that has 2 to 10 carbon atoms and that may have a halogen atom, or a single bond,

n5 and m5 each independently represent 0 or 1,

R^{3a} and R^{3b} represent a hydrogen atom, a halogen atom, a cyano group, or an alkyl group having 1 to 18 carbon atoms; the alkyl group may be substituted with at least one halogen atom or CN; in the group, a single CH₂ group or two or more non-adjacent CH₂ groups may each be independently substituted with, as long as oxygen atoms are not directly bonded to each other, —O—, —S—, —NH—, —N(CH₃)—, —CO—, —COO—, —OCO—, —OCOO—, —SCO—, —COS—, or —C≡C—, alternatively, R^{3a} and R^{3b} are represented by a general formula (3-a),

[Chem. 48]

-P^{3a} (3-a)

(in the formula, P^{3a} represents a polymerizable functional group, Sp^{3a} means the same as Sp¹).

P^{3a} preferably represents a substituent selected from polymerizable groups represented by the following formula (P-1) to formula (P-20).

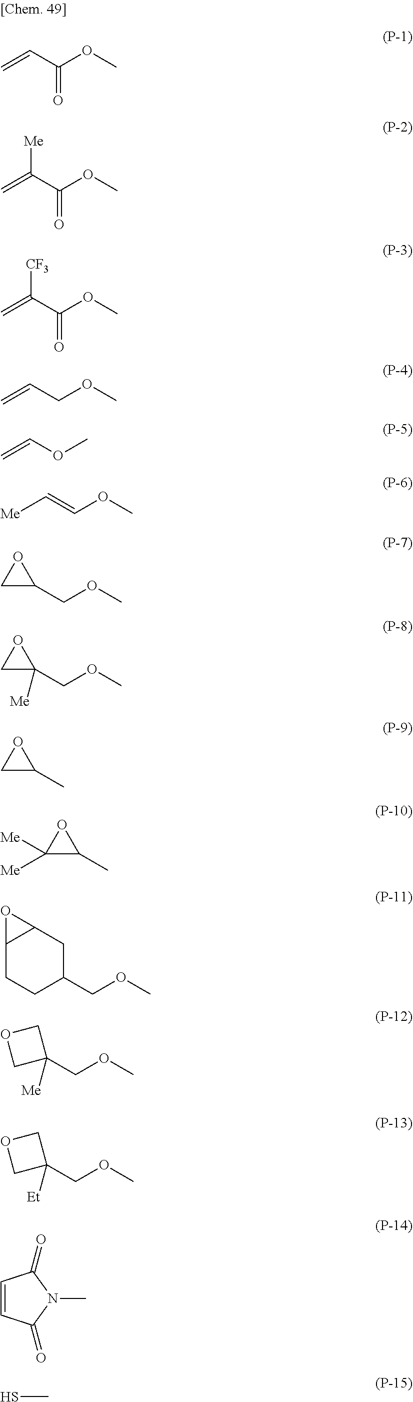

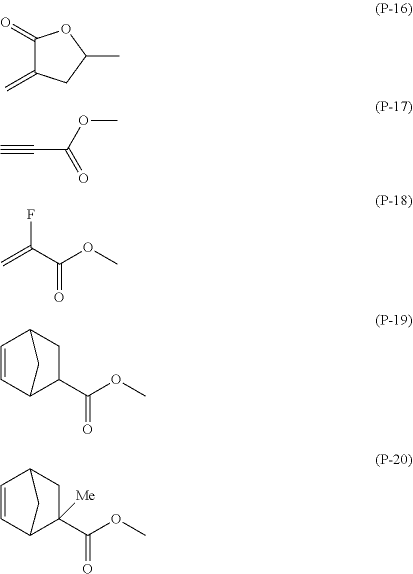

Among these polymerizable functional groups, from the viewpoint of improving polymerizability, preferred are the formula (P-1), and the formulas (P-2), (P-7), (P-12), and (P-13), more preferred are the formulas (P-1), (P-7), and (P-12).

Specific examples of the polymerizable chiral compound include compounds represented by the following general formulas (3-5) to (3-26), but are not limited to the following compounds.

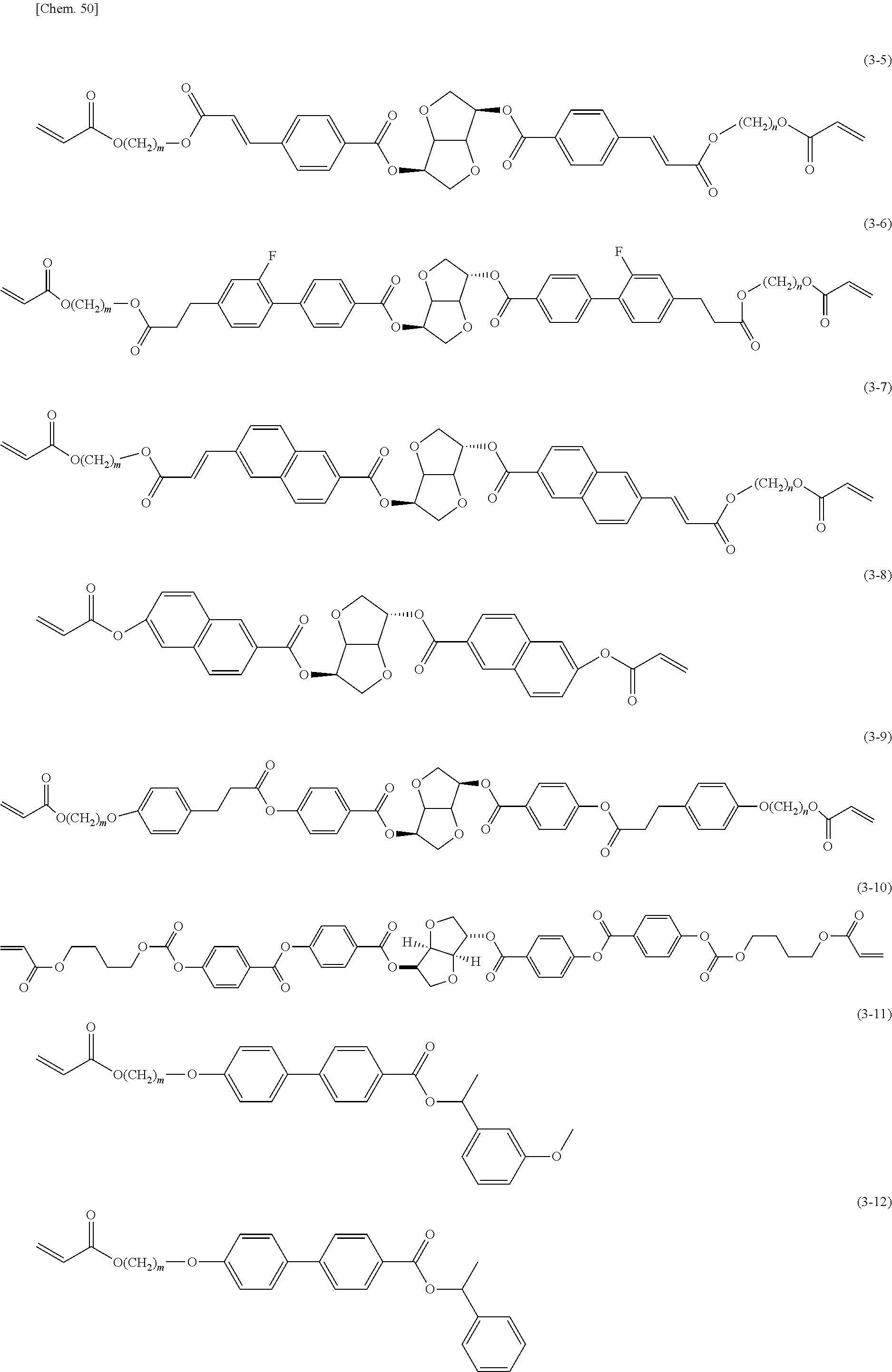

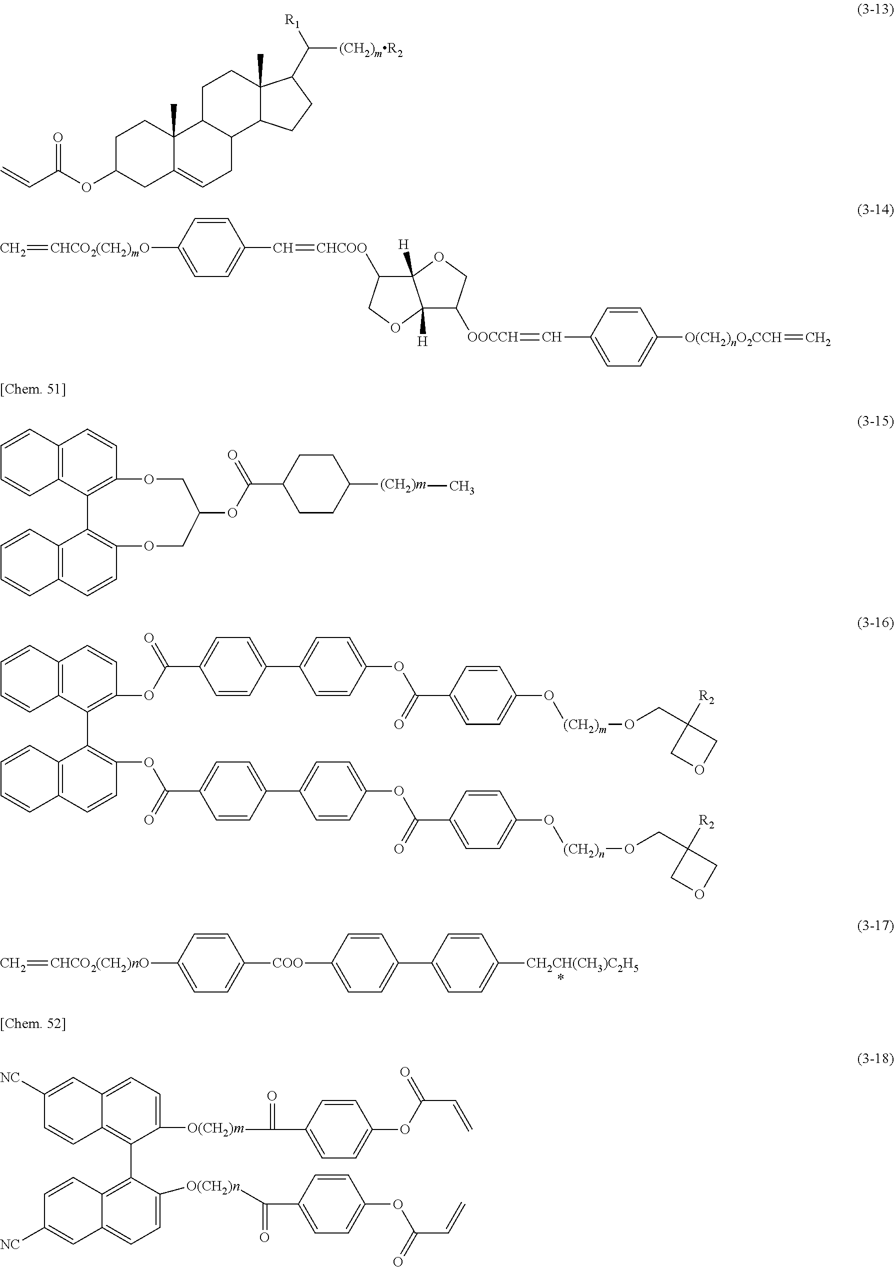

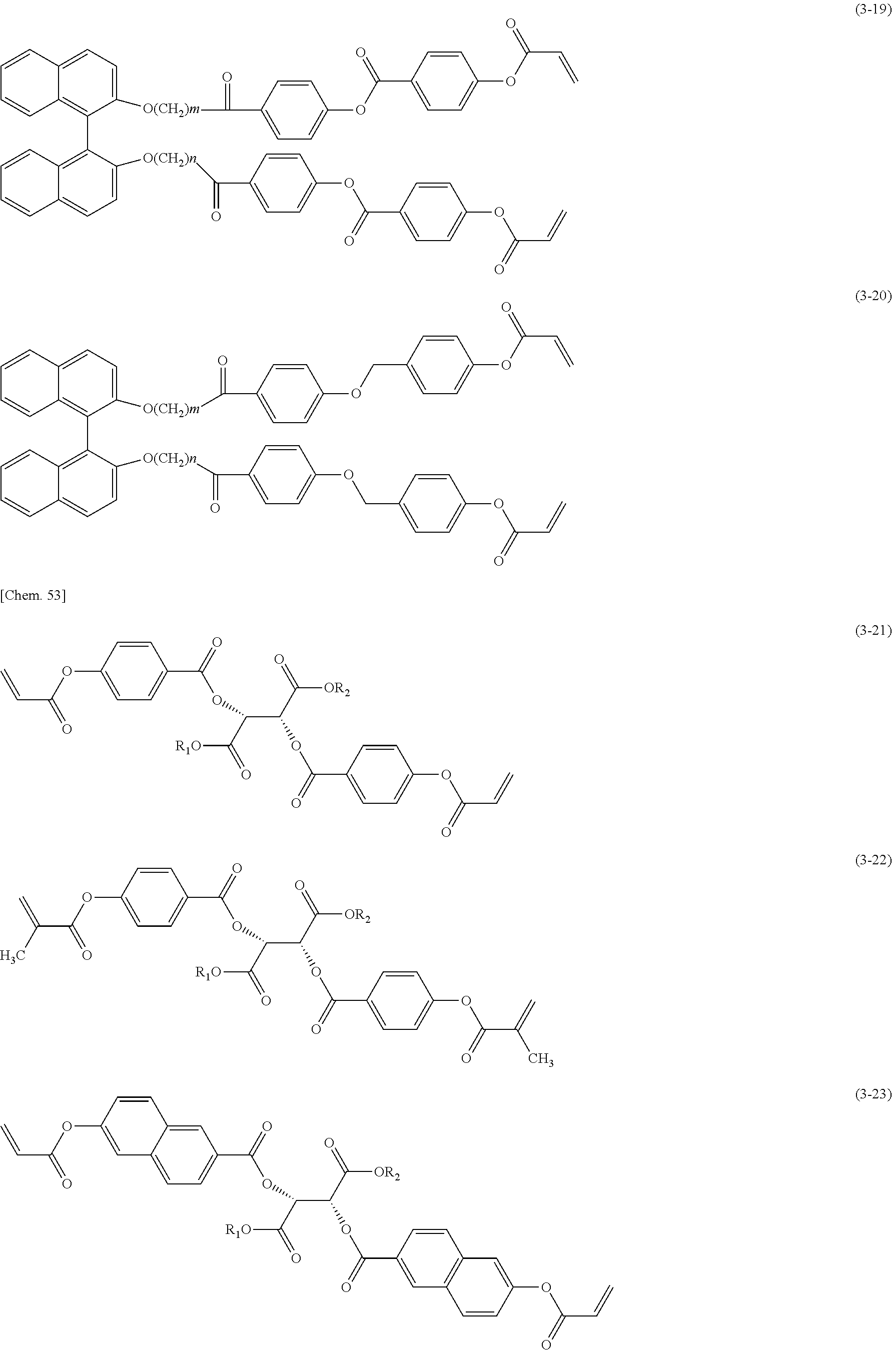

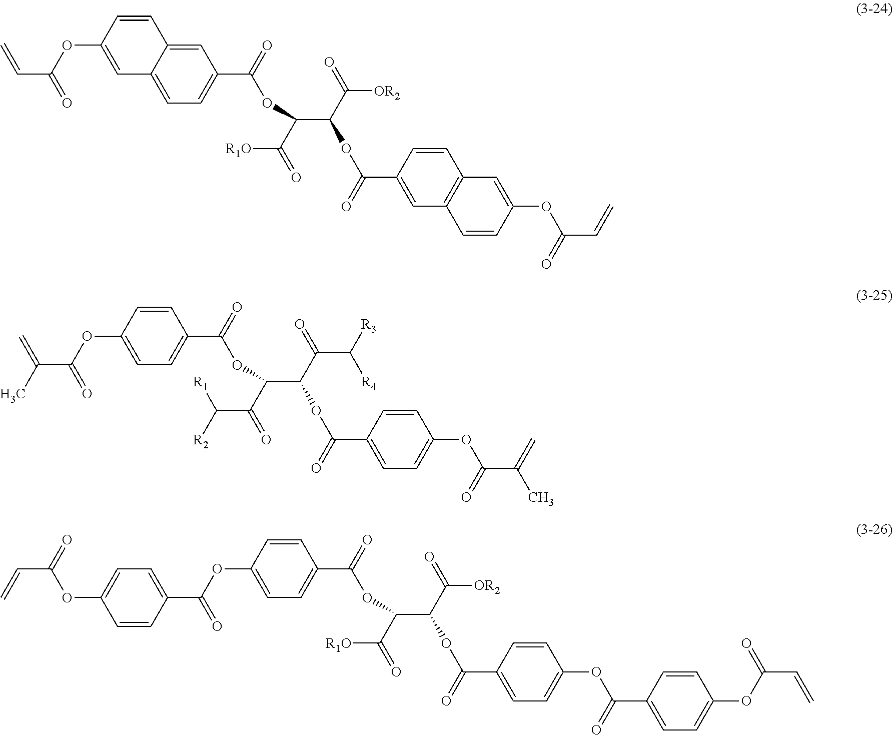

In the general formulas (3-5) to (3-26), m, n, k, and 1 each independently represent an integer of 1 to 18, R₁ to R₄ each independently represent a hydrogen atom, an alkyl group having 1 to 6 carbon atoms, an alkoxy group having 1 to 6 carbon atoms, a carboxy group, or a cyano group. When these groups are alkyl groups having 1 to 6 carbon atoms or alkoxy groups having 1 to 6 carbon atoms, the groups may all be unsubstituted, or may be substituted with one or two or more halogen atoms.

(Polymerizable Discotic Compound)

A polarized-luminescent-film-formable polymerizable composition according to the present invention may include, as a polymerizable liquid crystal compound, a polymerizable discotic liquid crystal compound exhibiting liquid crystallinity. A polarized-luminescent-film-formable polymerizable composition according to the present invention may contain non-liquid-crystalline polymerizable discotic compound.

Such a polymerizable discotic compound used for the present invention preferably has at least one polymerizable functional group. Examples of the compound include polymerizable compounds described in Japanese Unexamined Patent Application Publication Nos. 7-281028, 7-287120, 7-333431, and 8-27284.

Examples of the polymerizable liquid crystal compound that is a polymerizable discotic liquid crystal compound exhibiting liquid crystallinity include a compound represented by the following general formula (III).

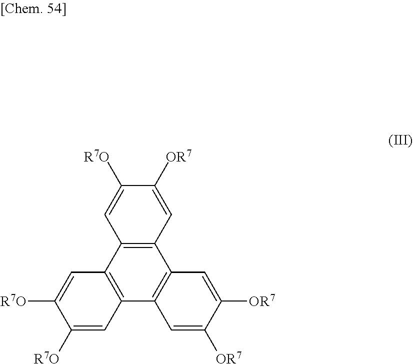

(In the formula, R⁷'s each independently represent a substituent represented by a general formula (III-a).

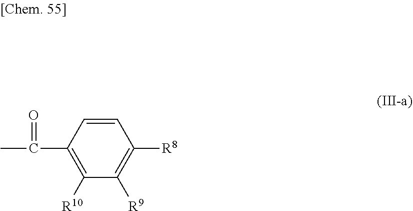

(In the formula, R⁹ and R¹⁰ each independently represent a hydrogen atom, a halogen atom, or a methyl group; R⁸ represents an alkoxy group having 1 to 20 carbon atoms; in the alkoxy group, a hydrogen atom may be substituted with a substituent represented by a general formula (III-b), a general formula (III-c), or a general formula (III-d); and at least one of R⁸'s in the general formula (III) is substituted with a substituent represented by the general formula (III-b), the general formula (III-c), or the general formula (III-d)).

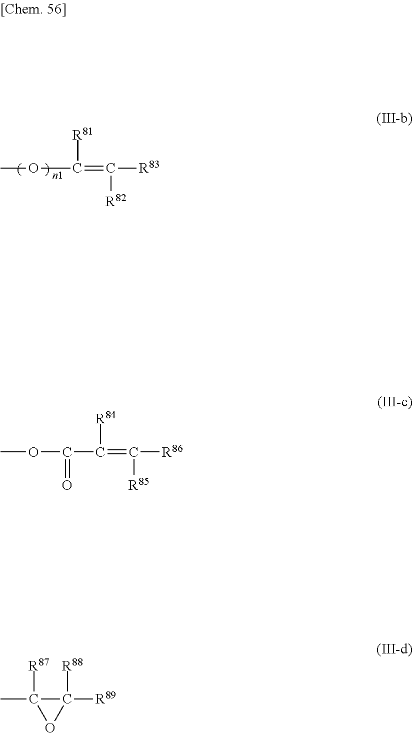

(In the formulas, R⁸¹, R⁸², R⁸³, R⁸⁴, R⁸⁵, R⁸⁶, R⁸⁷, R⁸⁸, and R⁸⁹ each independently represent a hydrogen atom, a halogen atom, or an alkyl group having 1 to 5 carbon atoms, and n1 represents 0 or 1.))

At least one of R⁸'s in the general formula (III) is substituted with a substituent represented by the general formula (III-b), the general formula (III-c), or the general formula (III-d). Preferably, all R⁸'s in the general formula (III) are each independently substituted with a substituent represented by the general formula (III-b), the general formula (III-c), or the general formula (III-d).

Specifically, the substituent represented by the general formula (III-a) is preferably a substituent represented by a general formula (III-e).

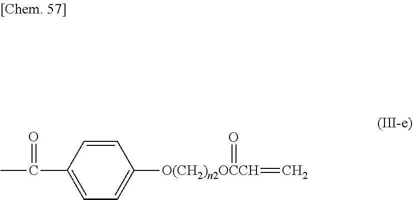

(In the formula, n2 represents an integer of 1 to 18.)

Preferred examples of the compound represented by the general formula (III) include compounds represented by the following general formula (III-1) or general formula (III-2).

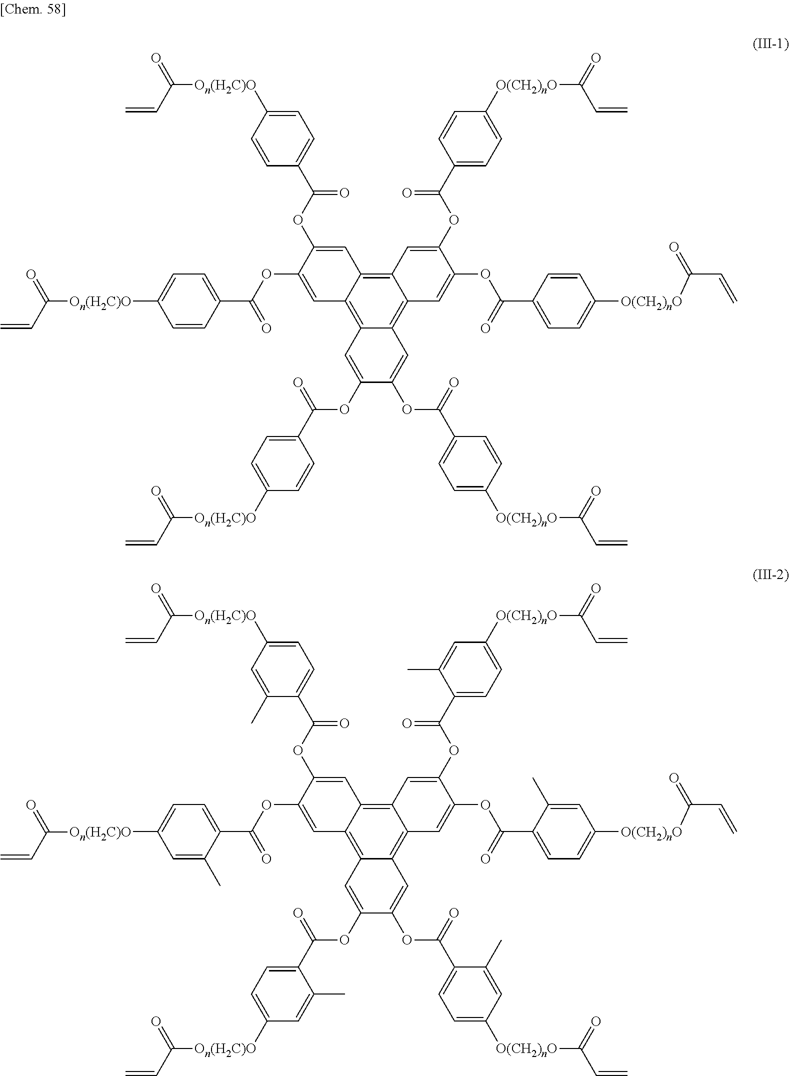

(In the general formula (III-1) and the general formula (III-2), n represents an integer of 1 to 18.)

As the polymerizable liquid crystal compound that is a polymerizable discotic liquid crystal compound exhibiting liquid crystallinity, one or two or more species may be used.

As the polymerizable liquid crystal compound, a polymerizable discotic liquid crystal compound alone may be used, or a polymerizable rod-like liquid crystal compound and a polymerizable discotic liquid crystal compound may be used in combination.

When, as the polymerizable liquid crystal compound, a polymerizable rod-like liquid crystal compound and a polymerizable discotic liquid crystal compound are used in combination, the total content of polymerizable discotic liquid crystal compound exhibiting liquid crystallinity relative to the total amount of polymerizable liquid crystal compounds used for the polarized-luminescent-film-formable polymerizable composition is preferably 5 to 95 mass %, more preferably 10 to 90 mass %, particularly preferably 20 to 80 mass %.

Other examples of general formulas representing polymerizable discotic compounds include general formulas (4-1) to (4-3), but are not limited to the following general formulas.

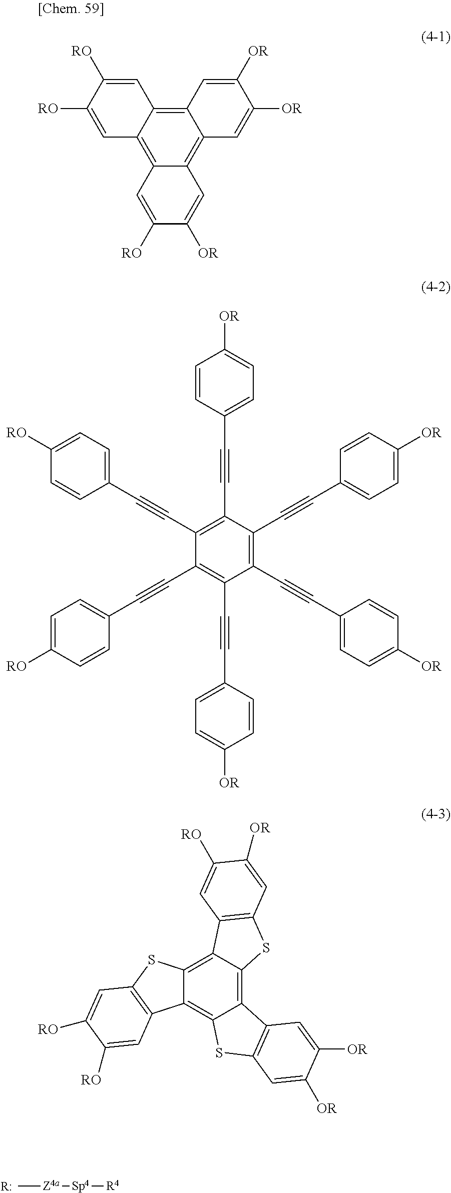

In the formulas, Sp⁴ represents an alkylene group having 0 to 18 carbon atoms; the alkylene group may be substituted with at least one halogen atom, CN group, or alkyl group having 1 to 8 carbon atoms and a polymerizable functional group; in the group, a single CH₂ group or two or more non-adjacent CH₂ groups may each be independently substituted with, as long as oxygen atoms are not directly bonded to each other, —O—, —S—, —NH—, —N(CH₃)—, —CO—, —COO—, —COO—, —OCOO—, —SCO—, —COS—, or —C≡C—,

Z^{4a} represents —CO—, —CH₂CH₂—, —CH₂O—, —CH═CH—, —CH═CHCOO—, —CH₂CH₂COO—, —CH₂CH₂OCO—, —COCH₂CH₂—, an alkyl group that has 2 to 10 carbon atoms and that may have a halogen atom, or a single bond,

R⁴ represents a hydrogen atom, a halogen atom, a cyano group, or an alkyl group having 1 to 18 carbon atoms; the alkyl group may be substituted with at least one halogen atom or CN; in the group, a single CH₂ group or two or more non-adjacent CH₂ groups may each be independently substituted with, as long as oxygen atoms are not directly bonded to each other, —O—, —S—, —NH—, —N(CH₃)—, —CO—, —COO—, —OCO—, —OCOO—, —SCO—, —COS—, or —C≡C—, or

R⁴ represents a general formula (4-a),

[Chem. 60]

-P^{4a} (4-a)

(in the formula, P^{4a} represents a polymerizable functional group, Sp^{3a} means the same as Sp¹.)

P^{4a} preferably represents a substituent selected from polymerizable groups represented by the following formula (P-1) to formula (P-20).

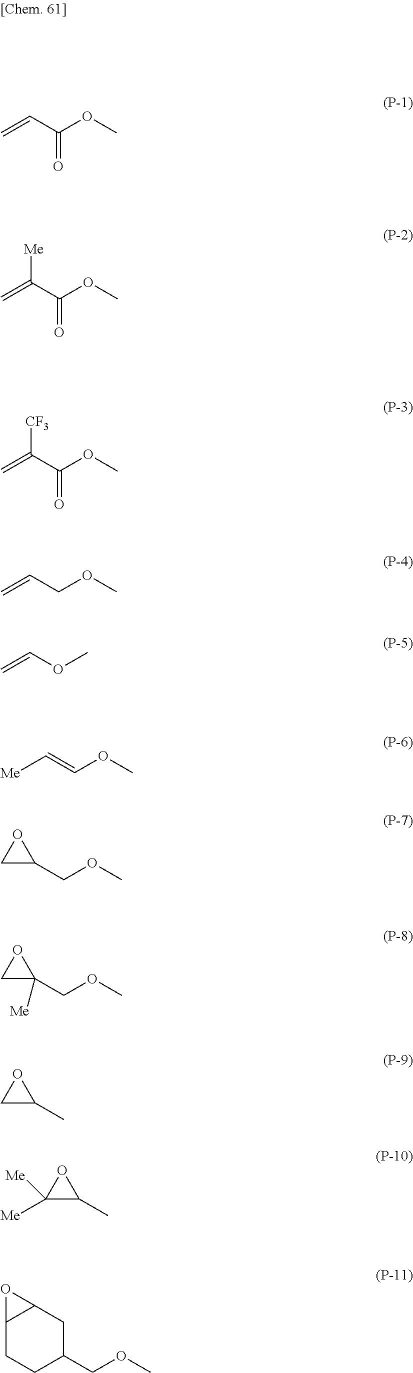

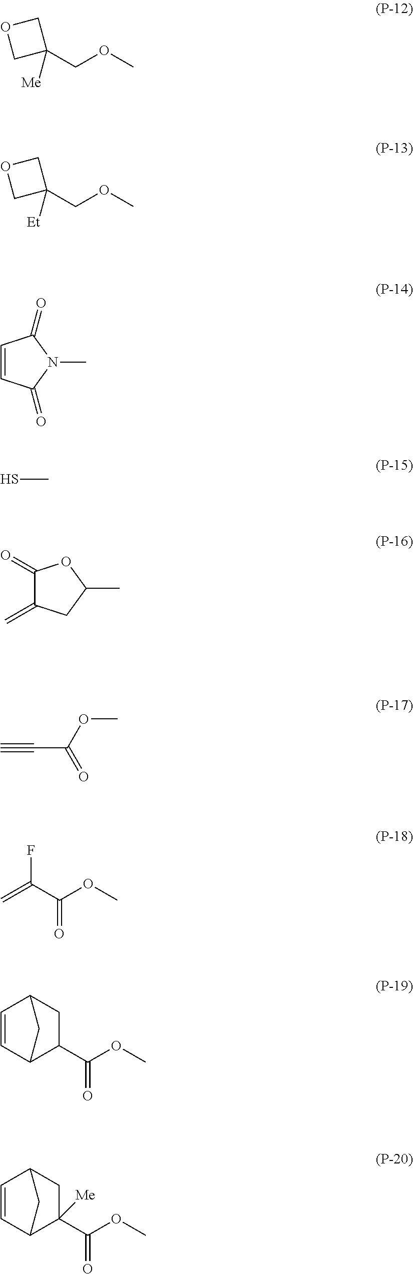

Among these polymerizable functional groups, from the viewpoint of improving polymerizability, preferred are the formula (P-1) and the formulas (P-2), (P-7), (P-12), and (P-13), more preferred are the formulas (P-1), (P-7), and (P-12).

Specific examples of the polymerizable discotic compound include compounds (4-4) to (4-6), but are not limited to the following compounds.

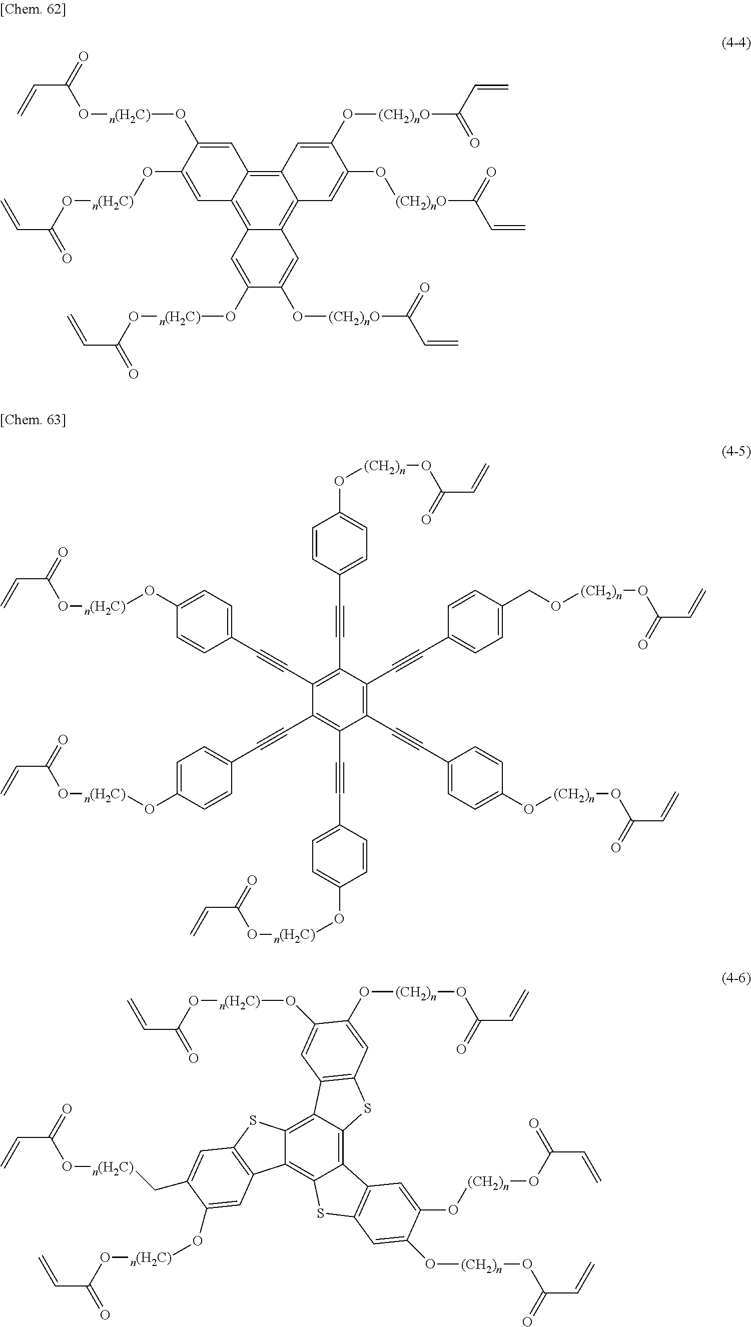

In the general formula (4-4) to the general formula (4-6), n represents an integer of 1 to 18.

(Organic Solvent)

To a polarized-luminescent-film-formable polymerizable composition according to the present invention, an organic solvent may be added. Such an organic solvent is not particularly limited, but is preferably an organic solvent in which the polymerizable liquid crystal compound exhibits high solubility, preferably an organic solvent in which drying is achieved at temperatures of 100° C. or less. Examples of the solvent include aromatic hydrocarbons such as toluene, xylene, cumene, and mesitylene; ester solvents such as methyl acetate, ethyl acetate, propyl acetate, and butyl acetate; ketone solvents such as methyl ethyl ketone, methyl isobutyl ketone, cyclohexanone, and cyclopentanone; ether solvents such as tetrahydrofuran, 1,2-dimethoxyethane, and anisole; amide solvents such as N,N-dimethylformamide and N-methyl-2-pyrrolidone; propylene glycol monomethyl ether acetate, diethylene glycol monomethyl ether acetate, y-butyrolactone, and chlorobenzene. These may be used alone or in combination of two or more thereof. At least one of the ketone solvents, the ether solvents, the ester solvents, and aromatic hydrocarbon solvents is preferably used from the viewpoint of solution stability.

A polarized-luminescent-film-formable polymerizable composition according to the present invention may be combined with an organic solvent to provide a solution, and the solution may be applied to a substrate. The ratio of the organic solvent used for the polarized-luminescent-film-formable polymerizable composition is not particularly limited as long as the coating state is not seriously degraded; the total organic solvent content of the polarized-luminescent-film-formable polymerizable composition is preferably 0 to 90 mass %, more preferably 0 to 85 mass %, particularly preferably 0 to 80 mass %.

When an organic solvent is used during preparation of a polarized-luminescent-film-formable polymerizable composition according to the present invention, rod-like luminescent nanocrystals used for the present invention may be dispersed in the organic solvent to provide a dispersion liquid, and then the polymerizable liquid crystal compound and the like used for the present invention may be dissolved in the dispersion liquid to provide a composition. Alternatively, when an organic solvent is used during preparation of a polarized-luminescent-film-formable polymerizable composition according to the present invention, the polymerizable liquid crystal compound used for the present invention may be dissolved to provide a polymerizable liquid crystal composition, and then rod-like luminescent nanocrystals used for the present invention may be dispersed in the polymerizable liquid crystal composition to provide a composition. Alternatively, when an organic solvent is used during preparation of a polarized-luminescent-film-formable polymerizable composition according to the present invention, rod-like luminescent nanocrystals used for the present invention may be dispersed to provide a dispersion liquid; a polymerizable liquid crystal compound used for the present invention may be dissolved to provide a polymerizable liquid crystal composition; and the dispersion liquid and the polymerizable liquid crystal composition may be mixed together to provide a polarized-luminescent-film-formable polymerizable composition.

When the polymerizable liquid crystal compound is dissolved in an organic solvent, stirring under heating is preferably performed in order to achieve uniform dissolution. The heating temperature during stirring under heating may be appropriately adjusted from the viewpoint of solubility of the composition used in the organic solvent; the heating temperature is preferably, from the viewpoint of productivity, 15° C. to 110° C., more preferably 15° C. to 105° C., still more preferably 15° C. to 100° C., particularly preferably 20° C. to 90° C.

When, in an organic solvent, rod-like luminescent nanocrystals and/or a polymerizable liquid crystal compound is dispersed or dissolved, stirring and mixing with a dispersion-mixer can be performed. Specific examples of the dispersion-mixer include dispersing devices having a stirring impeller such as a disper, a propeller, or a turbine blade, paint shakers, planetary stirring devices, shaking devices, shakers, and rotary evaporators. Other examples include ultrasonic irradiation devices. In particular, in the case of preparing a dispersion liquid in which rod-like luminescent nanocrystals are dispersed in an organic solvent, a disper is preferably used; in the case of preparing a solution in which a polymerizable liquid crystal compound is dissolved in an organic solvent, a dispersing device having a stirring impeller, a planetary stirring device, or a shaking device is preferably used.

The number of rotations for stirring during addition of the solvent is preferably appropriately adjusted depending on the stirring device used; in order to provide a uniform solution of the polarized-luminescent-film-formable polymerizable composition, the number of rotations for stirring is preferably set to 10 rpm to 1000 rpm, more preferably set to 50 rpm to 800 rpm, particularly preferably set to 100 rpm to 600 rpm.

A polarized-luminescent-film-formable polymerizable composition according to the present invention may contain, as other components, the above-described chiral compound and components described below. The chiral compound and components described below can be contained in the composition by being appropriately used during dispersion or dissolution of the organic solvent and the rod-like luminescent nanocrystals and/or polymerizable liquid crystal compound.

### (Polymerization Inhibitor)

To a polarized-luminescent-film-formable polymerizable composition according to the present invention, a polymerization inhibitor is preferably added. Examples of the polymerization inhibitor include phenol-based compounds, quinone-based compounds, amine-based compounds, thioether-based compounds, and nitroso compounds.

Examples of the phenol-based compounds include p-methoxyphenol, cresol, t-butylcatechol, 3,5-di-t-butyl-4-hydroxytoluene, 2,2′-methylenebis(4-methyl-6-t-butylphenol), 2,2′-methylenebis(4-ethyl-6-t-butylphenol), 4,4′-thiobis(3-methyl-6-t-butylphenol), 4-methoxy-1-naphthol, and 4,4′-dialkoxy-2,2′-bi-1-naphthol.

Examples of the quinone-based compounds include hydroquinone, methylhydroquinone (MEHQ), tert-butylhydroquinone, p-benzoquinone, methyl-p-benzoquinone, tert-butyl-p-benzoquinone, 2,5-diphenylbenzoquinone, 2-hydroxy-1,4-naphthoquinone, 1,4-naphthoquinone, 2,3-dichloro-1,4-naphthoquinone, anthraquinone, and diphenoquinone.

Examples of the amine-based compounds include p-phenylenediamine, 4-aminodiphenylamine, N,N′-diphenyl-p-phenylenediamine, N-i-propyl-N′-phenyl-p-phenylenediamine, N-(1,3-dimethylbutyl)-N′-phenyl-p-phenylenediamine, N,N′-di-2-naphthyl-p-phenylenediamine, diphenylamine, N-phenyl-β-naphthylamine, 4,4′-dicumyl-diphenylamine, and 4,4′-dioctyl-diphenylamine.

Examples of the thioether-based compounds include phenothiazine, and distearyl thiodipropionate.

Examples of the nitroso-based compounds include N-nitrosodiphenylamine, N-nitrosophenylnaphthylamine, N-nitrosodinaphthylamine, p-nitrosophenol, nitrosobenzene, p-nitrosodiphenylamine, α-nitroso-β-naphthol, and the like, N,N-dimethyl p-nitrosoaniline, p-nitrosodiphenylamine, p-nitrosodimethylamine, p-nitroso-N,N-diethylamine, N-nitrosoethanolamine, N-nitrosodi-n-butylamine, N-nitroso-N-n-butyl-4-butanolamine, N-nitroso-diisopropanolamine, N-nitroso-N-ethyl-4-butanolamine, 5-nitroso-8-hydroxyquinoline, N-nitrosomorpholine, N-nitroso-N-phenylhydroxylamine ammonium salt, nitrosobenzene, 2,4,6-tri-tert-butylnitrosobenzene, N-nitroso-N-methyl-p-toluene sulfonamide, N-nitroso-N-ethylurethane, N-nitroso-N-n-propylurethane, 1-nitroso-2-naphthol, 2-nitroso-1-naphthol, sodium 1-nitroso-2-naphthol-3,6-sulfonate, sodium 2-nitroso-1-naphthol-4-sulfonate, 2-nitroso-5-methylaminophenolhydrochloric acid salt, and 2-nitroso-5-methylaminophenolhydrochloric acid salt.

The amount of polymerization inhibitor added relative to 100 parts by mass of the total amount of polymerizable liquid crystal compound contained in the polarized-luminescent-film-formable polymerizable composition is preferably 0.01 to 1.0 part by mass, more preferably 0.05 to 0.5 parts by mass.

(Antioxidant)

In order to improve the stability of a polarized-luminescent-film-formable polymerizable composition according to the present invention, an antioxidant or the like is preferably added. Examples of such a compound include hydroquinone derivatives, nitrosamine-based polymerization inhibitors, and hindered phenol-based antioxidants. More specifically, examples include tert-butylhydroquinone, methylhydroquinone; products from Wako Pure Chemical Industries, Ltd. that are “Q-1300” and “Q-1301”; and products from BASF that are “IRGANOX 1010”, “IRGANOX 1035”, “IRGANOX 1076”, “IRGANOX 1098”, “IRGANOX 1135”, “IRGANOX 1330”, “IRGANOX 1425”, “IRGANOX 1520”, “IRGANOX 1726”, “IRGANOX 245”, “IRGANOX 259”, “IRGANOX 3114”, “IRGANOX 3790”, “IRGANOX 5057”, and “IRGANOX 565”.

The amount of antioxidant added relative to 100 parts by mass of the total amount of polymerizable liquid crystal compound contained in the polarized-luminescent-film-formable polymerizable composition is preferably 0.01 to 2.0 parts by mass, more preferably 0.05 to 1.0 part by mass.

(Photopolymerization Initiator)

A polarized-luminescent-film-formable polymerizable composition according to the present invention preferably contains a photopolymerization initiator, preferably contains at least one photopolymerization initiator. Specific examples include products from BASF Japan Ltd. that are “IRGACURE 651”, “IRGACURE 184”, “IRGACURE 907”, “IRGACURE 127”, “IRGACURE 369”, “IRGACURE 379”, “IRGACURE 819”, “IRGACURE 2959”, “IRGACURE 1800”, “IRGACURE 250”, “IRGACURE 754”, “IRGACURE 784”, “IRGACURE OXE01”, “IRGACURE OXE02”, “Lucirin TPO”, “DAROCUR 1173”, and “DAROCUR MBF”; products from LAMBSON Limited that are “ESACURE 1001M”, “ESACURE KIP150”, “SpeedCure BEM”, “SpeedCure BMS”, “SpeedCure MBP”, “SpeedCure PBZ”, “SpeedCure ITX”, “SpeedCure DETX”, “SpeedCure EBD”, “SpeedCure MBB”, and “SpeedCure BP”; a product from Nippon Kayaku Co., Ltd. that is “KAYACURE DMBI”; a product from Nihon SiberHegner K.K. (DKSH Japan K.K. at present) that is “TAZ-A”; and products from ADEKA CORPORATION that are “ADEKA OPTOMER SP-152”, “ADEKA OPTOMER SP-170”, “ADEKA OPTOMER N-1414”, “ADEKA OPTOMER N-1606”, “ADEKA OPTOMER N-1717”, and “ADEKA OPTOMER N-1919”.

The amount of photopolymerization initiator relative to 100 parts by mass of the total amount of polymerizable liquid crystal compound contained in the polarized-luminescent-film-formable polymerizable composition is preferably 0.1 to 10 parts by mass, particularly preferably 0.5 to 10 parts by mass. Such initiators may be used alone or in combination of two or more thereof. In addition, a sensitizer may be added, for example.

(Thermal Polymerization Initiator)

In a polarized-luminescent-film-formable polymerizable composition according to the present invention, in addition to the photopolymerization initiator, a thermal polymerization initiator may be used. Specific examples include products from Wako Pure Chemical Industries, Ltd. that are “V-40” and “VF-096”; and products from Nippon Oil & Fats Co., Ltd. (NOF CORPORATION at present) that are “PERHEXYL D” and “PERHEXYL I”.

The amount of thermal polymerization initiator used relative to 100 parts by mass of the total amount of polymerizable liquid crystal compound contained in the polarized-luminescent-film-formable polymerizable composition is preferably 0.1 to 10 parts by mass, particularly preferably 0.5 to 5 parts by mass. Such initiators may be used alone or in combination of two or more thereof.

(Photosensitizer)

In a polarized-luminescent-film-formable polymerizable composition according to the present invention, in addition to the photopolymerization initiator, a photosensitizer may be used. Specific examples include a product from DKSH Japan K.K. that is “LUNACURE 2-ITX”, a product from Nippon Kayaku Co., Ltd. that is “KAYACURE DETX-S”, a product from LAMBSON Limited that is “SpeedCure CPTX”, and a product from Kawasaki Kasei Chemicals Ltd. that is “ANTHRACURE UVS-581”.

The amount of photosensitizer used relative to 100 parts by mass of the total amount of polymerizable liquid crystal compound contained in the polarized-luminescent-film-formable polymerizable composition is preferably 0.1 to 10 parts by mass, particularly preferably 0.5 to 5 parts by mass. Such photosensitizers may be used alone or in combination of two or more thereof.

(Silane Coupling Agent)

For the purpose of imparting adhesion to a substrate, a polarized-luminescent-film-formable polymerizable composition according to the present invention may further contain at least one silane coupling agent as long as advantages of the present invention are not degraded. Examples of the silane coupling agent that may be contained include vinyl-group-containing alkoxysilanes, epoxy-group-containing alkoxysilanes, styryl-group-containing alkoxysilanes, methacryloyl-group-containing alkoxysilanes, acryloyl-group-containing alkoxysilanes, amino-group-containing alkoxysilanes, isocyanurate-group-containing alkoxysilanes, mercapto-group-containing alkoxysilanes, and isocyanate-group-containing alkoxysilanes; particularly preferred are vinyl-group-containing alkoxysilanes, epoxy-group-containing alkoxysilanes, methacryloyl-group-containing alkoxysilanes, acryloyl-group-containing alkoxysilanes, amino-group-containing alkoxysilanes, and mercapto-group-containing alkoxysilanes.

Specific examples include products from Shin-Etsu Chemical Co., Ltd. that are “KBM-1003”, “KBE-1003”, “KBM-303”, “KBM-402”, “KBM-403”, “KBE-402”, “KBE-403”, “KBM-1403”, “KBM-502”, “KBM-503”, “KBE-502”, “KBE-503”, “KBM-5103”, “KBM-602”, “KBM-603”, “KBM-903”, “KBE-903”, “KBM-573”, “KBM-9659”, “KBM-802”, “KBM-803”, and “KBE-9007”.

The amount of silane coupling agent used relative to 100 parts by mass of the total amount of polymerizable liquid crystal compound contained in the polarized-luminescent-film-formable polymerizable composition is preferably 0.01 to 5 parts by mass, particularly preferably 0.01 to 2 parts by mass. Such agents may be used alone or in combination of two or more thereof.

(Dispersing Agent)

For the purpose of improving the dispersion stability of rod-like luminescent nanocrystals, a polarized-luminescent-film-formable polymerizable composition according to the present invention may further contain at least one dispersing agent as long as advantages of the present invention are not degraded. Preferred examples of the dispersing agent that may be contained include hydroxy-group-containing carboxylic acid esters, salts of long-chain polyaminoamides and high-molecular-weight acid esters, salts of high-molecular-weight polycarboxylic acids, salts of long-chain polyaminoamides and polar acid esters, high-molecular-weight unsaturated acid esters, high-molecular-weight copolymers, modified polyurethanes, modified polyacrylates, polyetherester anionic surfactants, naphthalenesulfonic acid-formalin condensation salts, aromatic sulfonic acid-formalin condensation salts, polyoxyethylene alkylphosphoric acid esters, polyoxyethylene nonylphenyl ether, and stearylamine acetate.

Specific examples include products from BYK Chemie GmbH that are “Anti-Terra-U (polyaminoamide phosphate)”, “Anti-Terra-203/204 (high-molecular-weight polycarboxylic acid salt)”, “Disperbyk-101 (salt of long-chain polyaminoamide and polar acid ester), 107 (hydroxy-group-containing carboxylic acid ester), 110, 111 (copolymers including acid groups), 130 (polyamide), 161, 162, 163, 164, 165, 166, 170, 180, and 182 (high-molecular-weight copolymers)”, “Bykumen (high-molecular-weight unsaturated acid ester)”, “BYK-P104 or P105 (high-molecular-weight unsaturated polycarboxylic acid)”, “P104S or 240S (mixture of high-molecular-weight unsaturated polycarboxylic acid and polysiloxane)”, and “Lactimon (mixture of partial amide of long-chain amine and unsaturated polycarboxylic acid and polysiloxane)”.

Other examples include products from Efka CHEMICALS that are “Efka 44, 46, 47, 48, 49, 54, 63, 64, 65, 66, 71, 701, 764, or 766”, “Efka polymer 100 (modified polyacrylate), 150 (aliphatic modified polymer), 400, 401, 402, 403, 450, 451, 452, 453 (modified polyacrylates), and 745 (copper phthalocyanine)”; products from Kyoeisha Chemical Co., Ltd. that are “FLOWLEN TG-710 (urethane oligomer)”, “FLOWNON SH-290, or SP-1000”, “POLYFLOW No. 50E, or No. 300 (acrylic copolymers)”, and products from Kusumoto Chemicals, Ltd. that are “DISPARLON KS-860, 873SN, 874 (high-molecular-weight dispersing agents), #2150 (aliphatic polycarboxylic acid), and #7004 (polyetherester)”.

Other examples include products from Kao Corporation that are “DEMOL RN, N (sodium naphthalene sulfonate formalin condensate), MS, C, SN—B (sodium aromatic sulfonate formalin condensate), or EP”, “HOMOGENOL L-18 (polycarboxylic acid polymer)”, “EMULGEN 920, 930, 931, 935, 950, or 985 (polyoxyethylenenonylphenyl ether)”, “ACETAMIN 24 (cocoalkyl amine acetate), or 86 (stearylamine acetate)”; products from Lubrizol Corporation that are “Solsperse 5000 (phthalocyanine ammonium salt-based), 13940 (polyester amine-based), 17000 (aliphatic amine-based), or 24000”; products from Nikko Chemicals Co., Ltd. that are “NIKKOL T106 (polyoxyethylenesorbitan monooleate), MYS-IEX (polyoxyethylene monostearate), or Hexagline 4-0 (hexaglyceryl tetraoleate)”; and products from Ajinomoto Fine-Techno Co., Inc. that are “AJISPER PB821, or PB822 (basic dispersing agent)”.

The amount is preferably 0 to 50 wt %, more preferably 0 to 40 wt %; when the amount is more than 50 wt, the ink coating films may have degraded resistance.

The amount of dispersing agent used relative to 100 parts by mass of the total amount of polymerizable liquid crystal compound contained in the polarized-luminescent-film-formable polymerizable composition is preferably 0.1 to 10 parts by mass, particularly preferably 0.5 to 5 parts by mass. Such agents may be used alone or in combination of two or more thereof.

(Surfactant)

A polarized-luminescent-film-formable polymerizable composition according to the present invention may further contain at least one surfactant for the purpose of reducing variations in the film thickness of an optically anisotropic body to be formed, as long as advantages of the present invention are not degraded. Examples of the surfactant that may be contained include alkyl carboxylates, alkyl phosphates, alkyl sulfonates, fluoroalkyl carboxylates, fluoroalkyl phosphates, fluoroalkyl sulfonates, polyoxyethylene derivatives, fluoroalkyl ethylene oxide derivatives, polyethylene glycol derivatives, alkyl ammonium salts, and fluoroalkyl ammonium salts; particularly preferred are fluorine-containing surfactants.

Specific examples include “MEGAFACE F-251”, “MEGAFACE F-444”, “MEGAFACE F-477”, “MEGAFACE F-510”, “MEGAFACE F-552”, “MEGAFACE F-553”, “MEGAFACE F-554”, “MEGAFACE F-555”, “MEGAFACE F-556”, “MEGAFACE F-557”, “MEGAFACE F-558”, “MEGAFACE F-559”, “MEGAFACE F-560”, “MEGAFACE F-561”, “MEGAFACE F-562”, “MEGAFACE F-563”, “MEGAFACE F-565”, “MEGAFACE F-567”, “MEGAFACE F-568”, “MEGAFACE F-569”, “MEGAFACE F-570”, “MEGAFACE F-571”, “MEGAFACE R-40”, “MEGAFACE R-41”, “MEGAFACE R-43”, “MEGAFACE R-94”, “MEGAFACE RS-72-K”, “MEGAFACE RS-75”, “MEGAFACE RS-76-E”, and “MEGAFACE RS-90” (all manufactured by DIC Corporation), “FTERGENT 100”, “FTERGENT 100C”, “FTERGENT 110”, “FTERGENT 150”, “FTERGENT 150CH”, “FTERGENT A”, “FTERGENT 100A-K”, “FTERGENT 501”, “FTERGENT 300”, “FTERGENT 310”, “FTERGENT 320”, “FTERGENT 400SW”, “FTX-400P”, “FTERGENT 251”, “FTERGENT 215M”, “FTERGENT 212MH”, “FTERGENT 250”, “FTERGENT 222F”, “FTERGENT 212D”, “FTX-218”, “FTX-209F”, “FTX-213F”, “FTX-233F”, “FTERGENT 245F”, “FTX-208G”, “FTX-240G”, “FTX-206D”, “FTX-220D”, “FTX-230D”, “FTX-240D”, “FTX-207S”, “FTX-211S”, “FTX-2205”, “FTX-2305”, “FTX-750FM”, “FTX-730FM”, “FTX-730FL”, “FTX-710FS”, “FTX-710 FM”, “FTX-710FL”, “FTX-750LL”, “FTX-730LS”, “FTX-730LM”, “FTX-730LL”, and “FTX-710LL” (all manufactured by NEOS COMPANY LIMITED),

“BYK-300”, “BYK-302”, “BYK-306”, “BYK-307”, “BYK-310”, “BYK-315”, “BYK-320”, “BYK-322”, “BYK-323”, “BYK-325”, “BYK-330”, “BYK-331”, “BYK-333”, “BYK-337”, “BYK-340”, “BYK-344”, “BYK-3440”, “BYK-370”, “BYK-375”, “BYK-377”, “BYK-350”, “BYK-352”, “BYK-354”, “BYK-355”, “BYK-356”, “BYK-358N”, “BYK-361N”, “BYK-357”, “BYK-390”, “BYK-392”, “BYK-UV3500”, “BYK-UV3510”, “BYK-UV3570”, and “BYK-Silclean3700” (all manufactured by BYK Japan KK),

“TEGO Rad 2100”, “TEGO Rad 2200N”, “TEGO Rad 2250”, “TEGO Rad 2300”, “TEGO Rad 2500”, “TEGO Rad 2600”, and “TEGO Rad 2700” (all manufactured by TEGO), and

“N215”, “N535”, “N605K”, and “N935” (all manufactured by Solvay Solexis, Inc.).

The amount of surfactant added relative to 100 parts by mass of the total amount of polymerizable liquid crystal compound contained in the polarized-luminescent-film-formable polymerizable composition is preferably 0.01 to 2 parts by mass, more preferably 0.05 to 0.5 parts by mass.

When the surfactant is used, in the case of using a polarized-luminescent-film-formable polymerizable composition according to the present invention to form a film, a reduction in the tilt angle of the air interface is effectively achieved.

For a polarized-luminescent-film-formable polymerizable composition according to the present invention, there is a compound that has an effect of effectively reducing the tilt angle of the air interface of the film to be formed as long as advantages of the present invention are not degraded, and that has a repeating unit represented by the following general formula (7) and has a weight-average molecular weight of 100 or more.

[Chem. 64]

CR¹¹R¹²—CR¹³R¹⁴ (7)

In the formula, R¹¹, R¹², R¹³, and R¹⁴ each independently represent a hydrogen atom, a halogen atom, or a hydrocarbon group having 1 to 20 carbon atoms; in the hydrocarbon group, hydrogen atoms may be substituted with at least one halogen atom.

Preferred examples of the compound represented by the general formula (7) include polyethylene, polypropylene, polyisobutylene, paraffin, liquid paraffin, chlorinated polypropylene, chlorinated paraffin, and chlorinated liquid paraffin.

The amount of the compound represented by the general formula (7) and added relative to 100 parts by mass of the total amount of polymerizable liquid crystal compound contained in the polarized-luminescent-film-formable polymerizable composition is preferably 0.01 to 1 part by mass, more preferably 0.05 to 0.5 parts by mass.

(Other Additives)

In order to further adjust physical properties, depending on the purpose, additives such as a non-liquid-crystalline polymerizable compound or a thixotropic agent can be added as long as they do not inhibit horizontal alignment of the polarized-luminescent-film-formable polymerizable composition.

(Method for Producing Polarized-Luminescent-Film-Formable Polymerizable Composition)

A polarized-luminescent-film-formable polymerizable composition according to the present invention can be produced by mixing together at least one species of rod-like luminescent nanocrystals, and two or more species of polymerizable liquid crystal compounds. Specifically, stirring or ultrasonic irradiation turns the polymerizable liquid crystal compounds into a liquid crystal state and disperses the rod-like luminescent nanocrystals to thereby provide a polarized-luminescent-film-formable polymerizable composition. Incidentally, the stirring may be performed with, for example, a planetary stirring device, a shaking device, a laboratory mixer, a stirring propeller, a shaker, or a rotary evaporator. When the polarized-luminescent-film-formable polymerizable composition is produced by the above-described stirring method or ultrasonic irradiation method, the temperature during production may increase, and heating from the outside is optionally performed: heating may or may not be performed. The temperature during production is preferably set to 15° C. or more and 70° C. or less, more preferably set to 20° C. or more and 50° C. or less, particularly preferably set to 25° C. or more and 45° C. or less.

During production of a polarized-luminescent-film-formable polymerizable composition according to the present invention, when an organic solvent is used, rod-like luminescent nanocrystals used for the present invention may be dispersed in the organic solvent to provide a dispersion liquid, and then polymerizable liquid crystal compounds and the like used for the present invention may be dissolved to provide the composition. Alternatively, during production of a polarized-luminescent-film-formable polymerizable composition according to the present invention, when an organic solvent is used, polymerizable liquid crystal compounds used for the present invention may be dissolved to provide a polymerizable liquid crystal composition, and then rod-like luminescent nanocrystals used for the present invention may be dispersed to provide the composition. Alternatively, during production of a polarized-luminescent-film-formable polymerizable composition according to the present invention, when an organic solvent is used, rod-like luminescent nanocrystals used for the present invention may be dispersed to provide a dispersion liquid, and polymerizable liquid crystal compounds used for the present invention may be dissolved to provide a polymerizable liquid crystal composition; and the dispersion liquid and the polymerizable liquid crystal composition may be mixed together to provide the polarized-luminescent-film-formable polymerizable composition. During production of a polarized-luminescent-film-formable polymerizable composition, when an organic solvent is used, heating from the outside during the production is optionally performed: heating may or may not be performed. The temperature during production is preferably set to 15° C. or more and 70° C. or less, more preferably set to 20° C. or more and 50° C. or less, particularly preferably set to 25° C. or more and 45° C. or less.

(Display Device)

A polarized-luminescent-film-formable polymerizable composition according to the present invention is used for a polarized luminescent film of a display device. Examples of the display device include liquid crystal display devices using liquid crystal materials, and organic luminescent display devices using organic light-emitting diodes.

(Substrate)

A polarized-luminescent-film-formable polymerizable composition according to the present invention is used for a polarized luminescent film of a display device; the substrate used for the display device is a substrate ordinarily used for liquid crystal devices, displays, optical components, or optical films; the substrate is not particularly limited as long as it is a material that has heat resistance enough to resist heating optionally performed during drying after application of a polarized-luminescent-film-formable polymerizable composition according to the present invention. Examples of the substrate include glass substrates, metal substrates, ceramic substrates, and organic materials such as plastic substrates. When the substrate is an organic material, examples include cellulose derivatives, polyolefin, polyester, polycarbonate, polyacrylates (acrylic resins), polyarylate, polyethersulfone, polyimide, polyphenylene sulfide, polyphenylene ether, nylon, and polystyrene. Of these, preferred are plastic substrates formed of, for example, polyester, polystyrene, polyacrylate, polyolefin, a cellulose derivative, polyarylate, or polycarbonate; more preferred are substrates formed of, for example, polyacrylate, polyolefin, or a cellulose derivative; particularly preferred is use of COP (cycloolefin polymer) as the polyolefin, use of TAC (triacetylcellulose) as the cellulose derivative, and use of PMMA (polymethyl methacrylate) as the polyacrylate. The substrate may have the shape of a flat plate, or may have a curved surface. Such a substrate may have, as needed, an electrode layer, an antireflective function, or a reflective function.

In order to improve the coatability or adhesion of a polarized-luminescent-film-formable polymerizable composition according to the present invention, such a substrate may be surface-treated. Examples of the surface treatment include ozone treatment, plasma treatment, corona treatment, and silane coupling treatment. In order to adjust light transmittance or reflectivity, on the surface of the substrate, an organic thin film, an inorganic oxide thin film, or a metal thin film may be formed by vapor deposition, for example. In order to provide optical added value, the substrate may be a pickup lens, a rod lens, an optical disc, a retardation film, a light diffusion film, or a color filter, for example. Of these, preferred are those providing higher added value, which are a pickup lens, a retardation film, a light diffusion film, and a color filter.

(Alignment Treatment of Substrate)

The substrate is usually subjected to alignment treatment or may be equipped with an alignment film, so that, during application and drying of a polarized-luminescent-film-formable polymerizable composition according to the present invention, the polarized-luminescent-film-formable polymerizable composition is aligned. Examples of the alignment treatment include stretching treatment, rubbing treatment, polarized ultraviolet-visible light irradiation treatment, and ion beam treatment. When the alignment film is used, the alignment film is selected from publicly known and commonly used alignment films. Examples include alignment films formed of a compound such as polyimide, polysiloxane, polyamide, polyvinyl alcohol, polycarbonate, polystyrene, polyphenylene ether, polyarylate, polyethyleneterephthalate, polyethersulfone, epoxy resin, epoxy acrylate resin, acrylic resin, a coumarin compound, a chalcone compound, a cinnamate compound, a fulgide compound, an anthraquinone compound, an azo compound, or an arylethene compound. A compound subjected to rubbing as alignment treatment is preferably a compound in which a heating step performed during the alignment treatment or after the alignment treatment promotes crystallization of the material. A compound subjected to alignment treatment other than rubbing is preferably a photoalignment material.

In the present invention, such a substrate and a film having been subjected to alignment treatment, such as an alignment film, will be collectively sometimes referred to as a substrate material.

(Application of Polarized-Luminescent-Film-Formable Polymerizable Composition)

Examples of the method of applying a polarized-luminescent-film-formable polymerizable composition according to the present invention to a substrate or a substrate material include publicly known and commonly used methods such as an applicator method, a bar coating method, a spin coating method, a roll coating method, a direct gravure coating method, a reverse gravure coating method, a flexographic coating method, an inkjet method, a die coating method, a CAP coating method, a dip coating method, a slit coating method, and an ejection method using a dispenser. In the case of using an organic solvent, after application of the polarized-luminescent-film-formable polymerizable composition to a substrate material, the organic solvent may be driven off as needed by evaporation, for example.

(Polymerization Step)

A polarized-luminescent-film-formable polymerizable composition according to the present invention is polymerized: in the case of using an organic solvent, after the organic solvent is driven off, irradiation with light such as ultraviolet light or heating is generally performed in a state in which the liquid crystal compound in the polarized-luminescent-film-formable polymerizable composition is aligned horizontally with respect to the substrate material. When the polymerization is performed by irradiation with light, specifically, preferred is irradiation with ultraviolet light of 390 nm or less, most preferred is irradiation with light of wavelengths of 250 to 370 nm. However, when ultraviolet light of 390 nm or less causes, for example, decomposition of the sealing material composition for a display device, ultraviolet light of 390 nm or more may be preferably used to perform the polymerization treatment. This light is preferably diffused light and is not polarized light.

(Polymerization Method)

Examples of the method of polymerizing a polarized-luminescent-film-formable polymerizable composition according to the present invention include a method of irradiation with an active energy ray and a thermal polymerization method. Preferred is the method of irradiation with an active energy ray because heating is not necessary and the reaction proceeds at room temperature; in particular, preferred is a method of irradiation of light such as ultraviolet light because of the simple operation.

The temperature during the irradiation is a temperature at which a polarized-luminescent-film-formable polymerizable composition according to the present invention maintains the liquid crystal phase; in order to avoid induction of thermal polymerization of the polarized-luminescent-film-formable polymerizable composition, the temperature is preferably set at 40° C. or less whenever possible. Incidentally, a liquid crystal composition exhibits a liquid crystal phase usually in the temperature increase process, within the range of C (solid phase)-N(nematic) transition temperature (hereafter, abbreviated as C—N transition temperature) to the N—I transition temperature. On the other hand, in the temperature decrease process, a thermodynamically non-equilibrium state is provided, and hence solidification may not occur even at or below the C—N transition temperature and the liquid crystal state may be maintained. This state is referred to as a supercooling state. In the present invention, a liquid crystal composition in the supercooling state is also regarded as being included in the state of maintaining the liquid crystal phase. Specifically, irradiation with ultraviolet light at 390 nm or less is preferred; most preferred is irradiation with light at wavelengths of 250 to 370 nm. However, when ultraviolet light at 390 nm or less causes, for example, decomposition of the polarized-luminescent-film-formable polymerizable composition, the polymerization treatment may be preferably performed with ultraviolet light at 390 nm or more. This light is preferably diffused light and is not polarized light. The intensity of irradiation with ultraviolet light is preferably in the range of 0.05 kW/m² to 10 kW/m², particularly preferably in the range of 0.2 kW/m² to 2 kW/m². When the intensity of ultraviolet light is less than 0.05 kW/m², completion of polymerization takes a very long time. On the other hand, an intensity of more than 2 kW/m² tends to cause photodegradation of liquid crystal molecules in the polarized-luminescent-film-formable polymerizable composition, or may cause generation of a large polymerization heat and an increase in the temperature during polymerization, which may cause a change in the alignment order parameter of the polymerizable liquid crystal, resulting in deviation in the retardation of the polymerized film.

Irradiation with ultraviolet light may be performed through a mask to polymerize only a specified region; subsequently, the alignment state of the unpolymerized region may be changed by application of an electric field, a magnetic field, or temperature, for example; and subsequently the unpolymerized region may be polymerized, to thereby obtain an optically anisotropic body having a plurality of regions having different alignment directions.

### (Polarized Luminescent Film)

As described above, a polarized-luminescent-film-formable polymerizable composition according to the present invention can be suitably used for a polarized luminescent film of a liquid crystal display device, specifically, can be suitably used for the display device of a liquid crystal display. The amount of applying the polarized-luminescent-film-formable polymerizable composition is not limited; in general, the polarized luminescent film is preferably formed so as to have a thickness of 2 μm to 10 μm, more preferably 3 μm to 9 μm, particularly preferably 4 μm to 8 μm.

### EXAMPLES

Hereinafter, the present invention will be described with reference to synthesis examples, Examples, and Comparative Examples; however, the present invention is not limited to these at all. Incidentally, “part” and “%” are based on mass unless otherwise specified.

(Preparation of Polymerizable Liquid Crystal Composition (U-1))

A compound (15 parts) represented by a formula (A-1), 42.5 parts of a compound represented by a formula (B-6), 42.5 parts of a compound represented by a formula (B-7), and 0.1 parts of p-methoxyphenol (MEHQ) were added to 132 parts of toluene, subsequently heated at 70° C., and stirred to achieve dissolution. After the dissolution was confirmed, at 25° C., 4 parts of IRGACURE 907 (Irg. 907, manufactured by BASF Japan Ltd.), 1 part of ANTHRACURE UVS-581 (UVS-581, manufactured by Kawasaki Kasei Chemicals Ltd.), and 0.2 parts of MEGAFACE F-554 (F-554, manufactured by DIC Corporation) were added and further stirred to obtain a polymerizable liquid crystal composition (U-1).

### (Preparation of Polymerizable Liquid Crystal Compositions (U-2) to (U-12))

Polymerizable liquid crystal compositions (U-2) to (U-12) were obtained as in the preparation of the polymerizable liquid crystal composition (U-1) according to the present invention under the same conditions as in the preparation of the polymerizable liquid crystal composition (U-1) except that, in Table 1, the ratios of compounds represented by the formula (A-1) to a formula (A-6), compounds represented by a formula (B-1) to a formula (B-12), a compound represented by a formula (D-1), a compound represented by a formula (E-1), and a compound represented by a formula (F-1) were changed to ratios described in Table 1 and Table 2.

In Table 1 and Table 2, specific components of polymerizable liquid crystal compositions (U-1) to (U-12) according to the present invention are described.

TABLE 1

| Polymerizable | | | | | | | | |
|---|---|---|---|---|---|---|---|---|
| liquid crystal | | | | | | | | |
| composition | (U-1) | (U-2) | (U-3) | (U-4) | (U-5) | (U-6) | (U-7) | (U-8) |
| (A-1) | 15 | 20 | 30 | | | | | |
| (A-2) | | | | 65 | | | | |
| (A-3) | | | | | 10 | 20 | | |
| (A-4) | | | | | | 30 | | |
| (B-1) | | | | | 30 | | | |
| (B-2) | | | | 20 | 10 | | | |
| (B-3) | | | 20 | | | | | |
| (B-4) | | 15 | 25 | | | | | |
| (B-5) | | 15 | | | | | | |
| (B-6) | 42.5 | | | | | | | |
| (B-7) | 42.5 | 50 | 25 | 15 | | | | |
| (B-8) | | | | | 50 | 50 | | |
| (B-9) | | | | | | | 100 | |
| (B-10) | | | | | | | | 100 |
| (D-1) | 0.1 | 0.1 | 0.1 | 0.1 | 0.1 | 0.1 | 0.1 | 0.1 |
| (E-1) | 4 | 4 | 4 | 4 | 4 | 4 | 4 | 4 |
| (E-2) | 1 | 1 | 1 | 1 | 1 | 1 | 1 | 1 |
| (F-1) | 0.2 | 0.2 | 0.2 | 0.2 | 0.2 | 0.2 | 0.2 | 0.2 |
| Toluene | 132 | 132 | 132 | 132 | 132 | 132 | 132 | 132 |

TABLE 2

| Polymerizable liquid | | | | |
|---|---|---|---|---|
| crystal composition | (U-9) | (U-10) | (U-11) | (U-12) |
| (A-1) | | | | |
| (A-3) | | | 28 | |
| (A-5) | | 25 | | |
| (A-6) | | | 28 | |
| (B-1) | | | 34 | |
| (B-2) | | | 10 | |
| (B-6) | | | | |
| (B-7) | | | | |
| (B-10) | 100 | | | |
| (B-11) | | 75 | | |
| (B-12) | | | | 100 |
| (D-1) | 0.1 | 0.1 | 0.1 | 0.1 |
| (E-1) | 4 | 4 | 4 | 4 |
| (E-2) | 1 | 1 | 1 | 1 |
| (F-1) | 0.2 | 0.2 | 0.2 | 0.2 |
| Toluene | 132 | 132 | 132 | 132 |

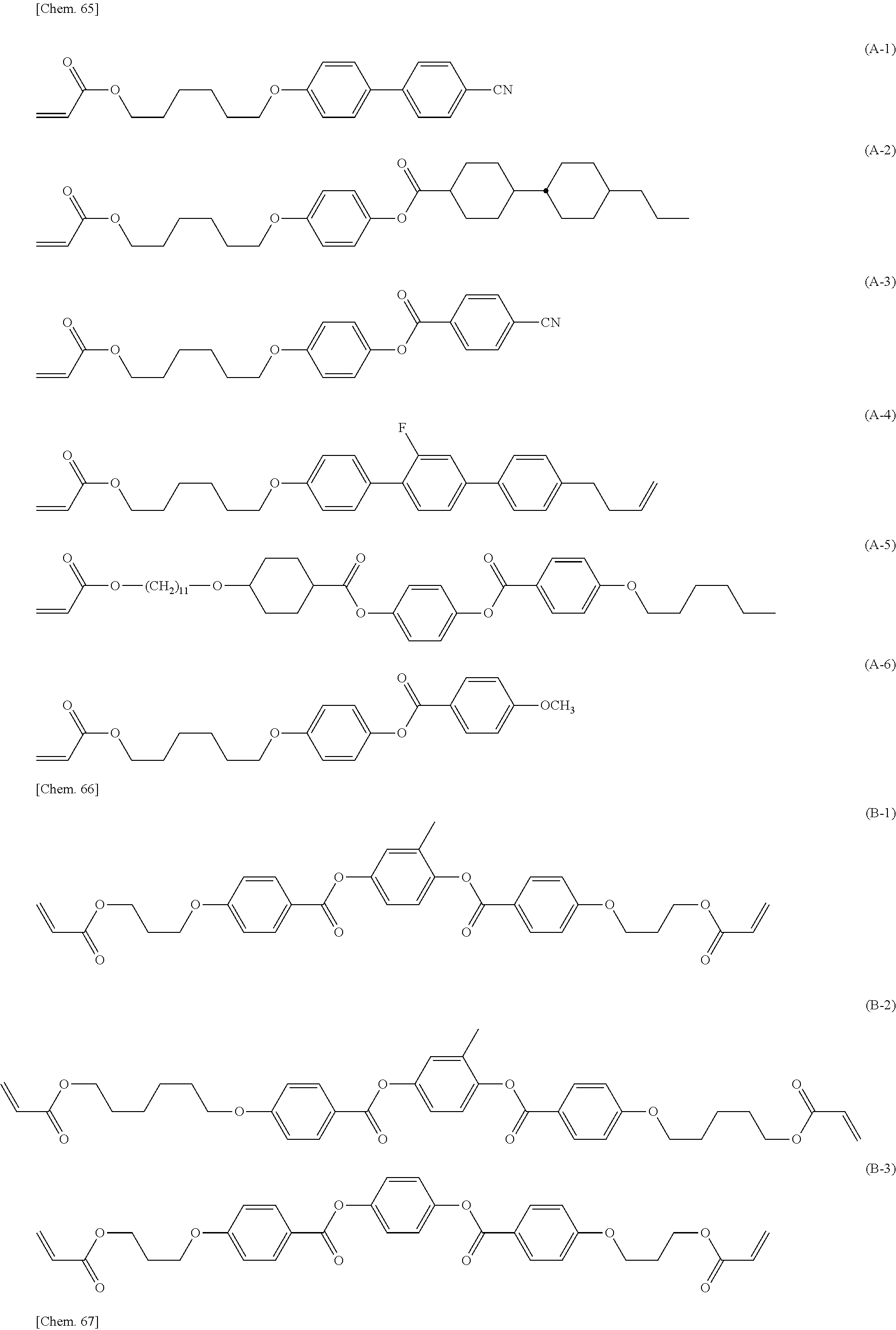

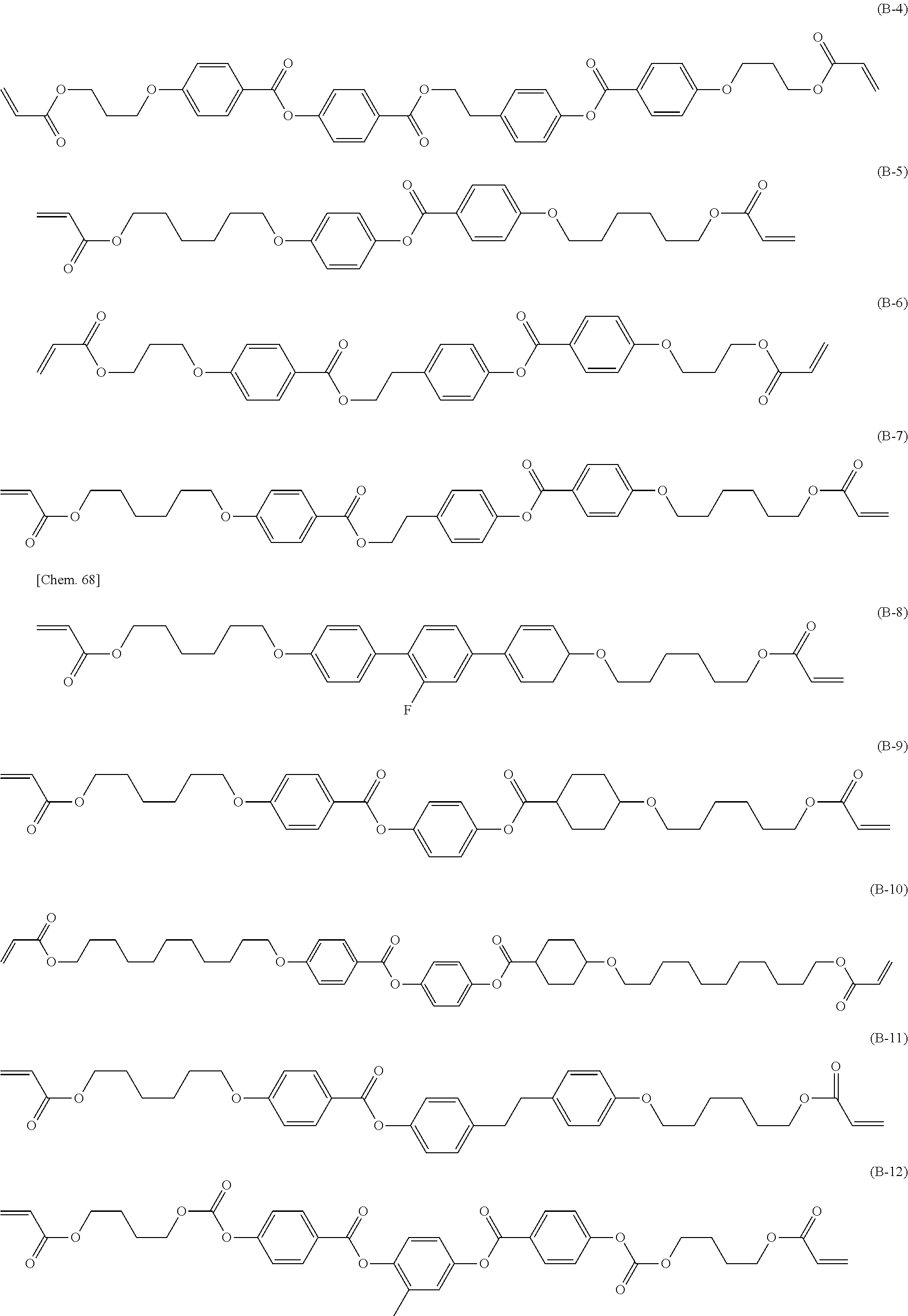

Para-methoxyphenol (manufactured by Wako Pure Chemical Industries, Ltd.) (E-1)

IRGACURE 907 (manufactured by BASF Japan Ltd.) (F-1)

Lucirin TPO (manufactured by BASF Japan Ltd.) (F-2)

MEGAFACE F-554 (manufactured by DIC Corporation) (G-1)

(Preparation of Polarized-Luminescent-Film-Formable Polymerizable Composition (1))

To 100 parts of the polymerizable liquid crystal composition (U-1), 41.6 parts of a luminescent-nanorod-1 toluene dispersion (C-1), 41.6 parts of a luminescent-nanorod-2 toluene dispersion (C-2) were added and stirred, to obtain a polarized-luminescent-film-formable polymerizable composition (1) (in which the luminescent nanorods were uniformly dispersed).

(Preparation of Polarized-Luminescent-Film-Formable Polymerizable Compositions (2) to (9))

Polarized-luminescent-film-formable polymerizable compositions (2) to (9) were obtained under the same conditions as in the preparation of the polarized-luminescent-film-formable polymerizable composition (1) except that the polymerizable liquid crystal composition (U-1) was changed to the polymerizable liquid crystal compositions (U-2) to (U-9).

(Preparation of Polarized-Luminescent-Film-Formable Polymerizable Composition (10))

A polarized-luminescent-film-formable polymerizable composition (10) was obtained under the same conditions as in the preparation of the polarized-luminescent-film-formable polymerizable composition (1) except that the polymerizable liquid crystal composition (U-1) was changed to the polymerizable liquid crystal composition (U-10), and the luminescent-nanorod-2 toluene dispersion (C-2) was changed to a luminescent-nanorod-3 toluene dispersion (C-3).

(Preparation of Comparative Polarized-Luminescent-Film-Formable Polymerizable Composition (C-1))

A polarized-luminescent-film-formable polymerizable composition (C-1) was obtained under the same conditions as in the preparation of the polarized-luminescent-film-formable polymerizable composition (1) except that the polymerizable liquid crystal composition (U-1) was changed to the polymerizable liquid crystal composition (U-11).

(Preparation of Comparative Polarized-Luminescent-Film-Formable Polymerizable Composition (C-2))

A comparative polarized-luminescent-film-formable polymerizable composition (C-2) was obtained under the same conditions as in the preparation of the polarized-luminescent-film-formable polymerizable composition (1) except that the polymerizable liquid crystal composition (U-1) was changed to the polymerizable liquid crystal composition (U-12), and the luminescent-nanorod-2 toluene dispersion (C-2) was changed to a luminescent-nanorod-3 toluene dispersion (C-3).

(Preparation of Comparative Polarized-Luminescent-Film-Formable Polymerizable Composition (C-3))

A comparative polarized-luminescent-film-formable polymerizable composition (C-3) was obtained under the same conditions as in the preparation of the polarized-luminescent-film-formable polymerizable composition (1) except that the luminescent-nanorod-1 toluene dispersion (C-1) was changed to a luminescent-nanorod-4 toluene dispersion (C-4), and the luminescent-nanorod-2 toluene dispersion (C-2) was changed to a luminescent-nanorod-5 toluene dispersion (C-5).

(Preparation of Comparative Polarized-Luminescent-Film-Formable Polymerizable Composition (C-4))

A comparative polarized-luminescent-film-formable polymerizable composition (C-4) was obtained under the same conditions as in the preparation of the polarized-luminescent-film-formable polymerizable composition (1) except that the luminescent-nanorod-1 toluene dispersion (C-1) and the luminescent-nanorod-2 toluene dispersion (C-2) were changed to a luminescent-nanorod-6 toluene dispersion (C-6).

In the “luminescent-nanorod-1 toluene dispersion (C-1)”, the luminescent nanorods 1 have a luminescence central wavelength of 520 nm, a half width of 25 nm, a core/shell configuration in which the core is formed of CdSe and the shell is formed of CdS, a long-axis of 25 nm, a short-axis of 3 nm, an aspect ratio (=long-axis/short-axis) of 8.3, and a concentration of 1 mass % relative to the total amount of (C-1).

In the “luminescent-nanorod-2 toluene dispersion (C-2)”, the luminescent nanorods 2 have a luminescence central wavelength of 630 nm, a half width of 30 nm, a core/shell configuration in which the core is formed of CdSe and the shell is formed of CdS, a long-axis of 36 nm, a short-axis of 7 nm, an aspect ratio (=long-axis/short-axis) of 5.1, and a concentration of 1 mass % relative to the total amount of (C-2).

In the “luminescent-nanorod-3 toluene dispersion (C-3)”, the luminescent nanorods 3 have a luminescence central wavelength of 620 nm, a half width of 47 nm, a core/shell configuration in which the core is formed of InP and the shell is formed of ZnS, a long-axis of 38 nm, a short-axis of 8 nm, an aspect ratio (=long-axis/short-axis) of 4.6, and a concentration of 1 mass % relative to the total amount of (C-3).

In the “luminescent-nanorod-4 toluene dispersion (C-4)”, the luminescent nanorods 4 have a luminescence central wavelength of 530 nm, a half width of 25 nm, a core/shell configuration in which the core is formed of CdSe and the shell is formed of ZnS, a long-axis of 3.3 nm, a short-axis of 3 nm, an aspect ratio (=long-axis/short-axis) of 1.1, and a concentration of 1 mass % relative to the total amount of (C-4).

In the “luminescent-nanorod-5 toluene dispersion (C-5)”, the luminescent nanorods 5 have a luminescence central wavelength of 640 nm, a half width of 30 nm, a core/shell configuration in which the core is formed of CdSe and the shell is formed of ZnS, a long-axis of 6.3 nm, a short-axis of 4 nm, an aspect ratio (=long-axis/short-axis) of 1.6, and a concentration of 1 mass % relative to the total amount of (C-5).

In the “luminescent-nanorod-6 toluene dispersion (C-6)”, the luminescent nanorods 6 are rod-like luminescent nanocrystals formed of ZnS, having a luminescence central wavelength of 500 nm, a half width of 80 nm, a long-axis of 4.0 nm, a short-axis of 1.2 nm, an aspect ratio (=long-axis/short-axis) of 3.3, and a concentration of 1 mass % relative to the total amount of (C-6).

(Phase Transition Temperature of Polarized-Luminescent-Film-Formable Polymerizable Composition)

The polarized-luminescent-film-formable polymerizable composition (1) was applied onto, with a spin coater, a glass substrate, and the solvent was driven off at 80° C., to form a coating film of the polarized-luminescent-film-formable polymerizable composition (1) on the glass substrate. This film was heated on a hot stage to 80° C., and phase transition during temperature decrease was observed with a polarizing microscope: a phase transition to a nematic phase occurred at 65° C.; during a further decrease in the temperature, a phase transition to a smectic phase occurred at 30° C.

The polarized-luminescent-film-formable polymerizable composition (2) was observed and measured for phase transition temperature as in the polarized-luminescent-film-formable polymerizable composition (1); the polarized-luminescent-film-formable polymerizable compositions (3) to (10) were heated to 140° C. and observed and measured for phase transition temperature as in (1); as a result, a phase transition to a smectic phase was observed.

The comparative polarized-luminescent-film-formable polymerizable compositions (C1) and (C2) were observed and measured for phase transition temperature as in (3); as a result, a phase transition to a nematic phase alone was observed. The comparative polarized-luminescent-film-formable polymerizable compositions (C3) and (C4) were observed and measured for phase transition temperature as in (1). As a result, a phase transition to a smectic phase was observed.

The phase transition temperatures of the polarized-luminescent-film-formable polymerizable compositions (1) to (10) and the comparative polarized-luminescent-film-formable polymerizable compositions (C1) to (C4) are described in the following Table 3.

TABLE 3

| | Phase transition temperature |
|---|---|
| Polymerizable | (numerical values represent |
| composition | temperatures ° C.) |
| (1) | S_{A} 30 N 65 I |
| (2) | S_{A} 54 N 73 I |
| (3) | S_{A} 57 N 95 I |
| (4) | S_{B} 32 S_{A} 92 N 143 I |
| (5) | S_{B} 84 S_{A} 95 N 124 I |
| (6) | S_{B} 65 S_{A} 101 N 106 I |
| (7) | S_{B} 69 S_{A} 99 N 109 I |
| (8) | S_{B} 60 S_{A} 103 N 121 I |
| (9) | S_{B} 92 S_{A} 106 N 108 I |
| (10) | S_{B} 69 S_{A} 99 N 109 I |
| (C1) | N 74 I |
| (C2) | N 123 I |
| (C3) | S_{A} 30 N 65 I |
| (C4) | S_{A} 30 N 65 I |

In Table, S_{B} represents smectic B, S_{A} represents smectic A, N represents nematic, N_{d} represents discotic nematic, and I represents isotropic.

### Example 1

(Measurement of Order Parameter of Polymerizable Liquid Crystal Composition (U-1))

To the polymerizable liquid crystal composition (U-1) prepared above, a dichroic pigment was added. A glass substrate having a horizontal-alignment film was used to form a coating film in which the polymerizable liquid crystal composition (U-1) was horizontally aligned. The obtained coating film was measured, with a spectrophotometer “U-4100” (manufactured by Hitachi, Ltd.), for an absorption coefficient “A∥” for incident linearly polarized light parallel to the alignment vector of polymerizable liquid crystal compound molecules, and an absorption coefficient “A⊥” for incident linearly polarized light perpendicular to the alignment vector of polymerizable liquid crystal compound molecules. The order parameter was calculated using the following mathematical formula (1), and was found to be 0.58.

$$\begin{matrix}[ Math . 3 ] & \\ S = \frac{A \vert \vert - A ⊥}{A \vert \vert + 2 A ⊥} & Mathematical formula ( 1 )\end{matrix}$$

### Examples 2 to 10 and Comparative Examples 1 and 2

(Measurement of Order Parameters of Polymerizable Liquid Crystal Compositions (U-2) to (U-12))

The order parameters of the polymerizable liquid crystal compositions (U-2) to (U-12) were measured as in Example 1 except that the polymerizable liquid crystal composition (U-1) was changed to the polymerizable liquid crystal compositions (U-2) to (U-12).

The results are described in the following Table 4.

TABLE 4

| | Polymerizable liquid | Order |
|---|---|---|
| | crystal composition | parameter S |
| Example 1 | (U-1) | 0.58 |
| Example 2 | (U-2) | 0.62 |
| Example 3 | (U-3) | 0.62 |
| Example 4 | (U-4) | 0.68 |
| Example 5 | (U-5) | 0.70 |
| Example 6 | (U-6) | 0.67 |
| Example 7 | (U-7) | 0.69 |
| Example 8 | (U-8) | 0.67 |
| Example 9 | (U-9) | 0.66 |
| Example 10 | (U-10) | 0.69 |
| Comparative Example 1 | (U-11) | 0.53 |
| Comparative Example 2 | (U-12) | 0.52 |

### Example 11

(Production of Sealing Film 1)

LUMICURE DTA-400S (manufactured by DIC Corporation) (60 parts), 40 parts of ARONIX M-309 (manufactured by TOAGOSEI CO., LTD.), and 5 parts of IRGACURE 184 (manufactured by BASF Japan Ltd.) were dissolved in 595 parts of methyl ethyl ketone to obtain a vapor-deposition-organic-layer-formable polymerizable composition (BL-1). Onto a PET film having a thickness of 12 μm (water vapor permeation at 40° C. and 90% RH: 50 g/m²/day), the vapor-deposition-anchoring-organic-layer-formable polymerizable composition (BL-1) was applied with a wire bar; the solvent was driven off at 80° C.; subsequently, a conveyor-type high pressure mercury lamp was used to perform irradiation with UV at 500 mJ/cm2, to obtain an anchoring multilayered body 1 in which, on the PET, a 1-micron vapor-deposition-anchoring organic layer was disposed. The anchoring multilayered body 1 was attached to a substrate holder within the film formation chamber of a sputtering apparatus; furthermore, a ZnSn alloy target (weight ratio of Zn:Sn=95:5) was attached to the first cathode, and a Si target was attached to the second cathode. Subsequently, the film formation chamber was evacuated with a vacuum pump to a reduced pressure of 5.0×10⁻⁴ Pa. Subsequently, sputtering was performed under film formation conditions A described below, to form, on the anchoring multilayered body 1, as an inorganic film, a 150-nm-thick SiZnSnO film. Thus, a sealing film 1 was obtained.

[Film Formation Conditions A]

Argon gas flow rate: 50 sccm, oxygen gas flow rate: 50 sccm

Power source output: first cathode=500 W, second cathode=1500 W

The water vapor permeation of the obtained sealing film 1 was measured with a differential pressure water vapor permeation analysis system (GTR-300XASC, manufactured by GTR TEC Corporation) in accordance with the JIS K 7126 A method (differential pressure method) at a temperature of 40° C. and a humidity of 90%, and was found to be 1.0×10⁻³ g/m²/day.

(Production of Polarized Luminescent Multilayered Body 1)

A photoalignment material (5 parts) represented by a formula (PA-1) below was dissolved in 95 parts of toluene. The resultant solution was filtered through a 0.45 μm membrane filter, to obtain a photoalignment solution (PA). Subsequently, the photoalignment solution (PA) was applied to the inorganic film surface of the sealing film 1 by a bar coating method, dried at 80° C. for 2 minutes, and then irradiated with linearly polarized light of 313 nm at an intensity of 50 mW/cm² for 10 seconds to obtain a photoalignment film. The obtained photoalignment film had a thickness of 0.5 micron. Onto the obtained photoalignment film, the polarized-luminescent-film-formable polymerizable composition (1) was applied by a bar coating method, and dried at 60° C. for 2 minutes. The obtained coating film was cooled to room temperature, and then irradiated, with a high pressure mercury lamp, with ultraviolet light at an intensity of 30 mW/cm² for 30 seconds to obtain a polarized luminescent film 1. The obtained polarized luminescent film 1 was laminated with a sealing film 1 such that its inorganic layer surface was in contact with the polarized luminescent film 1. Thus, a polarized luminescent multilayered body 1 of Example 1 was obtained in which the polarized luminescent film 1 was sandwiched between the sealing films 1.

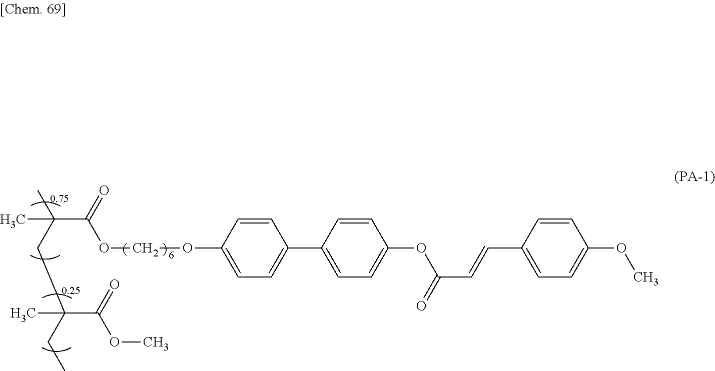

(Evaluation of Initial Polarized Luminescence Properties)

The initial polarized luminescence properties of the polarized luminescent multilayered body were measured by the following method and evaluated.

The polarized luminescent multilayered body 11 produced in Example 11 was irradiated with a blue LED (Light-Emitting Diode); from green light and red light provided by conversion using the polarized luminescent multilayered body, blue light was removed with a filter; subsequently, a polarizer was used and a CCD (Charge Coupled Device) was used to measure and evaluate the intensities of luminescence in the alignment direction and luminescence in a direction orthogonal to the alignment direction. As a result, a polarized luminescence ratio (intensity of luminescence in the alignment direction/intensity of luminescence in a direction orthogonal to the alignment direction)=8.

### Examples 12 to 20 and Comparative Examples 3 to 6

Polarized luminescent multilayered bodies 11 to 20 in Examples 12 to 20 and comparative polarized luminescent multilayered bodies 3 to 6 in Comparative Examples 3 to 6 were obtained under the same conditions as in Example 1 except that the polarized-luminescent-film-formable polymerizable composition (1) was changed to the polarized-luminescent-film-formable polymerizable compositions (2) to (10) and the comparative polarized-luminescent-film-formable polymerizable compositions (C1) to (C4), and the solvent drying temperature was changed to temperatures described in Table 4.

The obtained polarized luminescent multilayered bodies 12 to 20 and the comparative polarized luminescent multilayered bodies 3 to 6 were evaluated for initial polarized luminescence properties as in Example 11.

(Evaluation of Polarized Luminescence Properties after Durability Test)

The polarized luminescent multilayered bodies produced in Examples 11 to 20 and Comparative Examples 3 to 6 were subjected to a durability test under temperature-humidity conditions of 85° C. and 85% RH for 100 hours, and then evaluated, under the same conditions as in the above-described (Evaluation of initial polarized luminescence properties), for polarized luminescence properties after the durability test.

The results are described in the following Table 5.

TABLE 5

| | | | | Evaluation |
|---|---|---|---|---|
| | Polarized- | | Evaluation | of polarized |
| | luminescent- | Solvent | of initial | luminescence |
| | film-formable | drying | polarized | properties |
| | polymerizable | temperature | luminescence | after dura- |
| | composition | ° C. | properties | bility test |
| Example 11 | (11) | 60 | 8 | 7 |
| Example 12 | (12) | 65 | 8 | 7 |
| Example 13 | (13) | 80 | 7.5 | 7 |
| Example 14 | (14) | 100 | 9 | 8 |
| Example 15 | (15) | 100 | 10 | 8.5 |
| Example 16 | (16) | 100 | 9.5 | 9 |
| Example 17 | (17) | 100 | 10 | 9 |
| Example 18 | (18) | 100 | 9.5 | 9 |
| Example 19 | (19) | 100 | 8.5 | 7.5 |
| Example 20 | (20) | 100 | 10 | 9 |
| Comparative | (C1) | 65 | 5 | 2 |
| Example 3 | | | | |
| Comparative | (C2) | 100 | 6 | 2 |
| Example 4 | | | | |
| Comparative | (C3) | 60 | 1.5 | 1 |
| Example 5 | | | | |
| Comparative | (C4) | 60 | 2 | 1 |
| Example 6 | | | | |

The above-described results have demonstrated that the polarized luminescent films containing the cured products of the polymerizable liquid crystal compositions and polarized luminescent nanorods according to the present invention have good polarized luminescence characteristics. Therefore, when such a film is used on the backlight side of a liquid crystal panel, polarized luminescence is expected, which provides a structure in which the polarizing plate on one of the surfaces is no longer necessary.

1. A polarized luminescent film comprising a cured product of a polymerizable liquid crystal compound and a rod-like luminescent nanocrystal that absorbs and converts ultraviolet or visible light to emit light of at least one color of red (R), green (G), and blue (B),
wherein an alignment order parameter S of the cured product of the polymerizable liquid crystal compound is represented by a mathematical formula (1) below and is 0.55 or more,
$$\begin{matrix}[ Math . 1 ] & \\ S = \frac{A \vert \vert - A ⊥}{A \vert \vert + 2 A ⊥} & Mathematical formula ( 1 )\end{matrix}$$
(in the mathematical formula (1), A∥ represents, in the cured product, an absorption coefficient in a direction parallel to an alignment vector of polymerizable liquid crystal compound molecules, and A⊥ represents, in the cured product, an absorption coefficient in a direction perpendicular to the alignment vector of polymerizable liquid crystal compound molecules).

2. The polarized luminescent film according to claim 1, wherein the rod-like luminescent nanocrystal aligns along the alignment vector of polymerizable liquid crystal molecules in the cured product of the polymerizable liquid crystal compound.

3. The polarized luminescent film according to claim 1, wherein the polymerizable liquid crystal compound exhibits a smectic phase.

4. The polarized luminescent film according to claim 1, wherein the polymerizable liquid crystal compound is a compound represented by a general formula (II),
P²¹-(Sp²¹-X²¹)_{q21}-MG-R²¹ (II)
(where P²¹ represents a polymerizable functional group,
Sp²¹ represents an alkylene group having 1 to 18 carbon atoms (a hydrogen atom in the alkylene group may be substituted with at least one halogen atom, CN group, or group having a polymerizable functional group; a single CH₂ group or two or more non-adjacent CH₂ groups in the alkylene group may each be independently substituted with —O—, —COO—, —COO—, or —OCO—O—),
X²¹ represents —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF=CF—, or a single bond (provided that P²¹-Sp²¹ and Sp²¹-X²¹ do not include —O—O—, —O—NH—, —S—S—, or —O—S— bonds),
q21 represents 0 or 1,
MG represents a mesogenic group,
R²¹ represents a hydrogen atom, a halogen atom, a cyano group, or a linear or branched alkyl group having 1 to 12 carbon atoms; the alkyl group may be linear or branched; in the alkyl group, a single —CH₂— or two or more non-adjacent —CH₂— may each be independently substituted with —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF=CF—, or R²¹ is a group represented by a general formula (II-a),
—(X²²-Sp²²)_{q22}-P²² (II-a)
(where P²² represents a polymerizable functional group,
Sp²² represents the same as that defined in Sp²¹,
X²² represents the same as that defined in X²¹ (provided that P²²-Sp²² and Sp²²-X²² do not include —O—O—, —O—NH—, —S—S—, or —O—S— bonds), and q22 represents 0 or 1)).

5. The polarized luminescent film according to claim 4, wherein, in the general formula (II), MG is a compound represented by a general formula (II-b),
—(B1-Z1)ᵣ₁-B2-Z2-B3- (II-b)
(where B1, B2, and B3 each independently represent a 1,4-phenylene group, a 1,4-cyclohexylene group, a 1,4-cyclohexenyl group, a tetrahydropyran-2,5-diyl group, a 1,3-dioxane-2,5-diyl group, a tetrahydrothiopyran-2,5-diyl group, a 1,4-bicyclo(2,2,2)octylene group, a decahydronaphthalene-2,6-diyl group, a pyridine-2,5-diyl group, a pyrimidine-2,5-diyl group, a pyrazine-2,5-diyl group, a thiophene-2,5-diyl group-, a 1,2,3,4-tetrahydronaphthalene-2,6-diyl group, a 2,6-naphthylene group, a phenanthrene-2,7-diyl group, a 9,10-dihydrophenanthrene-2,7-diyl group, a 1,2,3,4,4a,9,10a-octahydrophenanthrene-2,7-diyl group, a 1,4-naphthylene group, a benzo[1,2-b:4,5-b]dithiophene-2,6-diyl group, a benzo[1,2-b:4,5-b]diselenophene-2,6-diyl group, a [1]benzothieno[3,2-b]thiophene-2,7-diyl group, a [1]benzoselenopheno[3,2-b]selenophene-2,7-diyl group, or a fluorene-2,7-diyl group; and may have, as a substituent, at least one F, Cl, CF₃, OCF₃, CN group, alkyl group having 1 to 8 carbon atoms (in the alkyl group, a hydrogen atom may be substituted with at least one phenyl group; and a single CH₂ group or two or more non-adjacent CH₂ groups in the group may each be independently substituted with —O—, —COO—, —COO—, or —OCO—O—), alkoxy group having 1 to 8 carbon atoms, alkanoyl group having 1 to 8 carbon atoms, alkanoyloxy group having 1 to 8 carbon atoms, alkoxycarbonyl group having 1 to 8 carbon atoms, alkenyl group having 2 to 8 carbon atoms, alkenyloxy group having 2 to 8 carbon atoms, and/or alkenoyl group having 2 to 8 carbon atoms, and/or general formula (II-c),
—(X²³)_{q24}-(Sp²³)_{q23}-P²³ (II-c)
(where P²³ represents a polymerizable functional group,
Sp²³ represents the same as that defined in Sp²¹ above,
X²³ represents —O—, —COO—, —OCH₂—, —CH₂O—, —CH₂CH₂OCO—, —COOCH₂CH₂—, —OCOCH₂CH₂—, or a single bond, q23 represents 0 or 1, q24 represents 0 or 1 (provided that P²³-Sp²³ and Sp²³-X²³ do not include —O—O—, —O—NH—, —S—S—, or —O—S— groups)),
Z1 and Z2 each independently represent —COO—, —CH₂CH₂—, —OCH₂—, —CH₂O—, —CH═CH—, —CH═CHCOO—, —OCOCH═CH—, —CH₂CH₂COO—, —CH₂CH₂OCO—, —COOCH₂CH₂—, —OCOCH₂CH₂—, —CONH—, —NHCO—, —C(CF₃)₂—, an alkyl group that has 2 to 10 carbon atoms and that may have a halogen atom, or a single bond; when Z1 or Z2 represents a single bond, among B1, B2, and B3 above, two adjacent ring structures may form, through their substituents bonded together, a cyclic group,
r1 represents 0, 1, 2, or 3; when a plurality of B1's and Z1's are present, B1's may be the same or different and Z1's may be the same or different).

6. The polarized luminescent film according to claim 5, wherein the compound represented by the general formula (II) is at least one compound selected from the group consisting of compounds represented by a general formula (II-2),
P²²¹-(Sp²²¹-X²²¹)_{q221}-MG²-(X²²²-Sp²²²)_{q222}-P²²² (II-2)
(where P²²¹, X²¹¹, q221, X²²², q222, and P²²² respectively represent the same as those defined in P²¹, X²¹, q21, X²², q22, and P²² in the general formula (II) and general formula (II-a),
Sp²²¹ and Sp²²² each independently represent an alkylene group having 1 to 18 carbon atoms (in the alkylene group, a hydrogen atom may be substituted with at least one halogen atom or CN group, and a single CH₂ group or two or more non-adjacent CH₂ groups in the group may each be independently substituted with —O—, —COO—, —COO—, or —OCO—O—), and
MG² represents a mesogenic group, and the mesogenic group is represented by a general formula (II-2-b),
—(B11-Z11)ᵣ₁₁-B21-Z21-B31- (II-2-b)
(where B11, B21, and B31 each independently represent a 1,4-phenylene group, a 1,4-cyclohexylene group, a 1,4-cyclohexenyl group, a tetrahydropyran-2,5-diyl group, a 1,3-dioxane-2,5-diyl group, a tetrahydrothiopyran-2,5-diyl group, a 1,4-bicyclo(2,2,2)octylene group, a decahydronaphthalene-2,6-diyl group, a pyridine-2,5-diyl group, a pyrimidine-2,5-diyl group, a pyrazine-2,5-diyl group, a thiophene-2,5-diyl group-, a 1,2,3,4-tetrahydronaphthalene-2,6-diyl group, a 2,6-naphthylene group, a phenanthrene-2,7-diyl group, a 9,10-dihydrophenanthrene-2,7-diyl group, a 1,2,3,4,4a,9,10a-octahydrophenanthrene-2,7-diyl group, a 1,4-naphthylene group, a benzo[1,2-b:4,5-b]dithiophene-2,6-diyl group, a benzo[1,2-b:4,5-b]diselenophene-2,6-diyl group, a [1]benzothieno[3,2-b]thiophene-2,7-diyl group, a [1]benzoselenopheno[3,2-b]selenophene-2,7-diyl group, or a fluorene-2,7-diyl group; and may have, as a substituent, at least one F, Cl, CF₃, OCF₃, CN group, alkyl group having 1 to 8 carbon atoms (in the alkyl group, a hydrogen atom may be substituted with at least one phenyl group, and a single CH₂ group or two or more non-adjacent CH₂ groups in the group may each be independently substituted with —O—, —COO—, —COO—, or —OCO—O—), alkoxy group having 1 to 8 carbon atoms, alkanoyl group having 1 to 8 carbon atoms, alkanoyloxy group having 1 to 8 carbon atoms, alkoxycarbonyl group having 1 to 8 carbon atoms, alkenyl group having 2 to 8 carbon atoms, alkenyloxy group having 2 to 8 carbon atoms, and/or alkenoyl group having 2 to 8 carbon atoms,
where Z11 and Z21 each independently represent —COO—, —COO—, —CH₂CH₂—, —OCH₂—, —CH₂O—, —CH═CH—, —CH═CHCOO—, —OCOCH═CH—, —CH₂CH₂COO—, —CH₂CH₂OCO—, —COOCH₂CH₂—, —OCOCH₂CH₂—, —C═N—, —N═C—, —CONH—, —NHCO—, —C(CF₃)₂—, an alkyl group that has 2 to 10 carbon atoms and that may have a halogen atom, or a single bond; r11 represents 0, 1, 2, or 3; when a plurality of B11's and Z11's are present, B11's may be the same or different and Z11's may be the same or different; when Z11 or Z21 represents a single bond, among B11, B21, and B31 above, two adjacent ring structures may form, through their substituents bonded together, a cyclic group)).

7. The polarized luminescent film according to claim 1, wherein the rod-like luminescent nanocrystal includes a core including at least one first semiconductor material, and a shell covering the core and including a second semiconductor material that is the same as in or different from the core.

8. The polarized luminescent film according to claim 7, wherein the first semiconductor material is one or two or more selected from the group consisting of group II-VI semiconductors, group III-V semiconductors, group semiconductors, group IV semiconductors, and group I-II-IV-VI semiconductors.

9. The polarized luminescent film according to claim 1, wherein the rod-like luminescent nanocrystal includes at least one component selected from the group consisting of CdS, CdSe, CdTe, ZnS, ZnSe, ZnSeS, ZnTe, ZnO, GaAs, GaP, GaAs, GaSb, HgS, HgSe, HgTe, InAs, InP, InSb, AlAs, AlP, AlSb, CuS, Cu₂S, Cu₂Se, CuInS, CuInS₂, CuInSe₂, Cu₂(ZnSn)S₄, and Cu₂(InGa)S₄.

10. The polarized luminescent film according to claim 1, wherein the rod-like luminescent nanocrystal has a long-axis-direction average length of 20 to 100 nm, and has an average aspect ratio falling in a range of 4 to 20 and represented by (long-axis-direction average length of the rod-like luminescent nanocrystal)/(short-axis-direction average length of the rod-like luminescent nanocrystal).

11. The polarized luminescent film according to claim 1, wherein the rod-like luminescent nanocrystal includes at least one species of a rod-like luminescent nanocrystal having a luminescence central wavelength in a wavelength band of 600 to 680 nm and having a half width of 60 nm or less, a rod-like luminescent nanocrystal having a luminescence central wavelength in a wavelength band of 500 to 600 nm and having a half width of 60 nm or less, and a rod-like luminescent nanocrystal having a luminescence central wavelength in a wavelength band of 430 to 480 nm and having a half width of 60 nm or less.

12. A polarized luminescent multilayered body according to claim 1, comprising a gas barrier layer on at least one of surfaces of the polarized luminescent film.

13. The polarized luminescent multilayered body according to claim 12, wherein the gas barrier layer is a multilayer including at least one organic layer and at least one inorganic layer.

14. The polarized luminescent multilayered body according to claim 12, wherein the inorganic layer is formed of oxide, nitride, and oxynitride of at least one metal selected from the group consisting of Al, Si, Zn, Sn, Ti, Cr, Ni, and In.

15. The polarized luminescent multilayered body according to claim 12, comprising an alignment film having been subjected to alignment treatment and disposed between the polarized luminescent film and the gas barrier layer.

16. A backlight unit at least comprising the polarized luminescent multilayered body according to claim 12, and a light-emitting diode configured to emit blue or ultraviolet light.

17. A liquid crystal display device at least comprising the backlight unit according to claim 16, and a liquid crystal cell.

18. A polymerizable liquid crystal composition comprising the rod-like luminescent nanocrystal and the polymerizable liquid crystal compound, and being provided for forming the cured product.
